(19) United States
(12) Patent Application Publication
(10) Pub. No.: US 2026/0105613 A1
(43) Pub. Date: Apr. 16, 2026

(54) METHOD FOR TRACKING TRAJECTORY OF OBJECT

(71) Applicant: FITOGETHER INC., Seoul (KR)

(72) Inventors: Jaechan LEE, Yongin-si (KR); Hyunsung KIM, Seoul (KR); Changjo KIM, Suwon-si (KR); Minchul JEONG, Ansan-si (KR); Dongwook CHUNG, Seoul (KR)

(73) Assignee: FITOGETHER INC., Seoul (KR)

(21) Appl. No.: 19/104,620

(22) PCT Filed: Feb. 28, 2023
(86) PCT No.: PCT/KR2023/002782

§ 371 Date: Feb. 18, 2025

(30) Foreign Application Priority Data
Aug. 19, 2022 (KR) 10-2022-0104305
Nov. 8, 2022 (KR) 10-2022-0148099

(51) Int. Cl. G06T 7/20; G01S 19/43; G06T 7/70

(52) U.S. Cl. CPC G06T 7/20; G01S 19/43; G06T 7/70; G06T 2207/30241

(57) ABSTRACT

There is provided a method for tracking a trajectory of an object during a target time interval, based on image based locational information and sensor based locational information. The method includes determining a confidence interval of the image based locational information, the confidence interval being at least a partial time interval in the target time interval, tracking the trajectory of the object during the confidence interval, based on the image based locational information, and tracking the trajectory of the object during a non-confidence interval which is an interval other than the confidence interval in the target time interval, based on the sensor based locational information.

### TECHNICAL FIELD

The present disclosure generally relates to positioning, and more specifically, though not exclusively, to a technique for more accurately tracking the trajectory of an object during a target time interval.

### BACKGROUND

Sports analyses have gradually become more important in response to an explosive growth of a sports industry market and developments in sports science. In this trend, Electronic Performance Tracking Systems (EPTS) for tracking sports players during games or training hours have been consecutively introduced, especially in major sports such as soccer. In the EPTS, locations or movements of the sports players are utilized as important basic data to provide various additional information. Therefore, various efforts have been continuously made to more easily acquire tracking information on the locations of sports players and to improve accuracy thereof.

In addition to a sports analysis field, there are increasing cases of tracking and utilizing locations and trajectories of objects for various purposes. For example, tracking a location of a vehicle is utilized to provide additional services or to collect vehicle-related statistics, and there are increasing interests in location monitoring services for child protection. In each of various technical fields, ensuring reliability and improving accuracy in the trajectories of the objects are recognized as important.

In this regard, methods for determining the locations of the objects, based on characteristics of signals measured by sensors corresponding to the objects, such as a Global positioning system (GPS), have been widely utilized. Recently, as video analysis technology has been developed, methods for calculating the locations of the objects from images including the objects imaged by cameras have also been utilized. However, each of an image based location determination method and a sensor based location determination method has a different limitation, and thus, various studies have been progressively carried out to improve the methods.

### DETAILED DESCRIPTIONS OF INVENTION

### Technical Object

Hereinafter, there is provided a summary of specific embodiments disclosed in the present disclosure. It should be understood that aspects presented in the following summary merely provide a brief summary of the specific embodiments and are not intended to limit the scope of the present disclosure. Accordingly, it should be understood in advance that the present disclosure may include various aspects not presented below.

The present disclosure and inventive concepts disclosed hereinafter provide methods, devices, and computer-readable storage media for tracking or utilizing a trajectory of an object.

One aspect of the present disclosure is to provide a method for tracking a trajectory of an object during a target time interval, based on image based locational information and sensor based locational information.

One aspect of the present disclosure is to provide a method for tracking a trajectory of an object by using the image based locational information in a confidence interval of the image based locational information and the sensor based locational information in remaining intervals.

One aspect of the present disclosure is to provide a method for identifying each individual object by matching trajectories of objects determined using the image based locational information with trajectories of objects determined using the sensor based locational information.

An aspect of the present disclosure is to provide a method for tracking a trajectory of an object, based on the sensor based locational information whose accuracy is improved by using the image based locational information.

An aspect of the present disclosure is to provide a method for tracking trajectories of objects by determining a group for at least some of the objects included in an image and by using the image based locational information and the sensor based locational information for the objects included in the group.

However, aspects to be achieved by the present disclosure are not limited thereto, and may be widened in various ways as long as the aspects do not deviate from the idea and the scope of the present disclosure.

### Technical Solution

Embodiments include methods, apparatuses, and computer-readable storage media for tracking or utilizing trajectories of objects.

According to one embodiment, there is provided an object tracking method for tracking a trajectory of an object during a target time interval, based on image based locational information and sensor based locational information. The method includes determining a confidence interval of the image based locational information, the confidence interval being at least a partial time interval in the target time interval, tracking the trajectory of the object during the confidence interval, based on the image based locational information, and tracking the trajectory of the object during a non-confidence interval which is an interval other than the confidence interval in the target time interval, based on the sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects.

According to another embodiment, there is provided an object tracking method for tracking a trajectory of an object during a target time interval, based on image based locational information and sensor based locational information. The method includes tracking a trajectory of each of the one or more objects during a reference time interval, based on the image based locational information, tracking a trajectory of each of the one or more objects during the reference time interval, based on the sensor based locational information, and matching each object from the image based locational information with each object from the sensor based locational information by performing minimum cost assignment between a plurality of trajectories according to the image based locational information and a plurality of trajectories according to the sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects.

According to another embodiment, there is provided an object tracking method for tracking a trajectory of an object during a target time interval, based on image based locational information and sensor based locational information. The method includes determining an error value existing in the sensor based locational information, based on the image based locational information and the sensor based locational information, acquiring a corrected sensor based locational information by removing the error value from the sensor based locational information, and tracking the trajectory of the object during the target time interval, based on the corrected sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects.

According to another embodiment, there is an object tracking method for tracking a trajectory of an object during a target time interval, based on image based locational information and sensor based locational information. The method includes determining a first object group including at least some of a plurality of objects existing in a captured image, and determining a confidence interval of the image based locational information, based on the image based locational information and the sensor based locational information which correspond to the first object group, the confidence interval being a partial time interval in the target time interval. The image based locational information includes information on a location of at least one object determined from the captured image obtained by imaging one or more objects, and the sensor based locational information includes information on a location or a displacement of at least one determined object, based on signals from sensors corresponding to each of the one or more objects.

The above-described exemplary embodiments and other exemplary embodiments will be described or clarified by the detailed description in which exemplary embodiments to be read in conjunction with the accompanying drawings will be described later.

### Effects of Invention

The disclosed technology may have the following advantageous effects. However, it does not mean that a specific embodiment has to include all of the following advantageous effects or has to include only the following advantageous effects. Therefore, the scope of the disclosed technology should not be construed as being limited by the specific embodiment.

According to an embodiment of the present disclosure, it is possible to provide an object trajectory determination method which minimizes influence of false detection caused by a special situation such as occlusion while achieving improved location accuracy by tracking a trajectory of an object during a target time interval, based on image based locational information and sensor based locational information.

According to an embodiment of the present disclosure, the confidence interval of the image based locational information may be determined by using the sensor based locational information. Therefore, locational information during a time interval in which no false detection occurs in the image based locational information may be selectively utilized.

According to an embodiment of the present disclosure, the trajectory of the object through the sensor based locational information and the trajectory of the object through the image based locational information may be matched with each other. Therefore, the object detected by the image based locational information may be identified by using identification information of the object corresponding to the sensor.

According to an embodiment of the present disclosure, accuracy of the sensor based locational information may be improved by removing a bias occurring in the sensor based locational information, through a comparison between the image based locational information and the sensor based locational information.

According to an embodiment of the present disclosure, a matching error between the image based locational information and the sensor based locational information may be minimized by matching only a group including specific objects in objects detected in the image based locational information with the sensor based locational information.

The above-described contents of the invention do not include an exhaustive list of all aspects of the present disclosure. It should be understood that the present disclosure includes not only the items summarized above, but also all methods, apparatuses, and systems which may be implemented from all proper combinations of various aspects disclosed in the detailed description and the appended claims below.

### BRIEF DESCRIPTION OF THE DRAWINGS

FIG. 1 shows an example of acquiring image based locational information.

FIG. 2 shows an example of acquiring sensor based locational information.

FIG. 3 shows an example of a state including a missing object.

FIG. 4 shows an example of a state including an incorrectly detected object.

FIG. 5 shows object matching between frames in a video including a plurality of objects.

FIG. 6 shows a comparison between a GPS method and an OTS method.

FIG. 7 shows an exemplary system which enables an object tracking method according to one embodiment of the present disclosure.

FIG. 8 is a block diagram of a sensor device which may be used to acquire sensor based locational information according to one embodiment of the present disclosure.

FIG. 9 is a block diagram of a server according to an embodiment of the present disclosure.

FIG. 10 schematically shows a procedure for acquiring image based locational information and sensor based locational information and for acquiring integrated tracking data according to one embodiment of the present disclosure.

FIG. 11 shows a video acquisition procedure in FIG. 10 in more detail.

FIG. 12 shows an object detection procedure in FIG. 10 in more detail.

FIG. 13 shows a location determination procedure in FIG. 10 in more detail.

FIG. 14 shows a location error according to key pixel determination criteria.

FIG. 15 shows a change in a determined location according to a change in the key pixel decision criteria.

FIG. 16 shows key pixel determination using pose estimation.

FIG. 17 shows key pixel determination according to area division.

FIG. 18 shows key pixel determination using an artificial neural network.

FIG. 19 is a schematic flowchart of an object tracking method using the image based locational information and the sensor based locational information according to one embodiment of the present disclosure.

FIG. 20 shows examples of a confidence frame and a confidence interval of the image based locational information.

FIG. 21 is a conceptual diagram of a procedure for tracking an object by using the image based locational information or the sensor based locational information, based on the presence or absence of the confidence interval.

FIG. 22 shows an example of a trajectory of an object determined according to the procedure in FIG. 21.

FIG. 23 shows an interpolation procedure using the sensor based locational information for a non-confidence interval between a plurality of confidence intervals.

FIG. 24 shows an example of a matching procedure between a plurality of image based trajectories and a plurality of sensor based trajectories.

FIG. 25 shows an example of object matching between an image and a sensor and an error removal procedure of the sensor based locational information according to one embodiment of the present disclosure.

FIG. 26 shows a result of error removal according to the procedure in FIG. 25 in more detail.

FIG. 27 shows an example of a grouping procedure for detected objects.

FIG. 28 is a schematic flowchart of a method for tracking a trajectory of an object by using the image based locational information or the sensor based locational information according to the confidence interval according to one embodiment of the present disclosure.

FIG. 29 is a detailed flowchart of a confidence interval determination step in FIG. 28.

FIG. 30 is a detailed flowchart of a confidence frame determination step in FIG. 29.

FIG. 31 is a detailed flowchart according to one aspect of a subsequent frame determination step in FIG. 29.

FIG. 32 is a detailed flowchart according to another aspect of the subsequent frame determination step in FIG. 29.

FIG. 33 is a schematic flowchart of a method for tracking a trajectory of an object, based on matching between a plurality of objects according to one embodiment of the present disclosure.

FIG. 34 is a detailed flowchart of a confidence interval determination step for the method in FIG. 33.

FIG. 35 schematically shows a procedure for removing error values to perform re-matching subsequently to object matching in FIG. 33.

FIG. 36 is a schematic flowchart of a method for tracking a trajectory of an object by using error value removal of the sensor based locational information according to one embodiment of the present disclosure.

FIG. 37 is a detailed flowchart of an error value determination step in FIG. 36.

FIG. 38 is a detailed flowchart of a confidence interval determination step for the method in FIG. 36.

FIG. 39 shows an example of a procedure for performing re-matching and updating the sensor based locational information subsequently to the error value removal of the sensor based locational information in FIG. 36.

FIG. 40 is a schematic flowchart of an object trajectory tracking method using object group determination according to one embodiment of the present disclosure.

FIG. 41 shows a procedure for determining an object trajectory, based on the presence or absence of the confidence interval subsequently to the object group determination in FIG. 40.

FIG. 42 shows a procedure for determining an object trajectory by using error value removal of the sensor based locational information subsequently to the object group determination in FIG. 40.

FIG. 43 is a detailed flowchart of the confidence interval determination step in FIG. 40.

FIG. 44 is a detailed flowchart of the confidence interval determination step in FIG. 43.

### EMBODIMENTS

The present disclosure may be corrected in various ways, and may adopt various embodiments. Therefore, specific embodiments will be described in detail while being shown in the drawings.

However, the present disclosure is not intended to limited to the specific embodiments, and it should be understood that the present disclosure includes all modifications, equivalents, or substitutes included in the concept and the technical scope of the present disclosure.

Although the terms of first, second, and the like may be used to describe various components, the components should not be limited by the terms. The terms are used only to distinguish one component from another component. For example, without departing from the scope of the present disclosure, a first component may be referred to as a second component, and similarly, the second component may be referred to as the first component. The term of and/or includes any combination of a plurality of related described items or any item in the plurality of related described items.

When it is described that a certain component is “connected” or “linked” to another component, the certain component may be directly connected or linked to the other component, but it should be understood that another component may exist therebetween. On the other hand, when it is described that a certain component is “directly connected” or “directly linked” to another component, it should be understood that another component does not exist therebetween.

The terms used in the present application are used only to describe specific embodiments, and are not intended to limit the present disclosure. A singular expression includes a plurality of expressions unless the context clearly indicates otherwise. In the present application, it should be understood that the terms of “including”, “having”, and the like are intended to specify the presence of a feature, a number, a step, an operation, a component, a part, or a combination thereof described in the specification, and do not exclude in advance a possibility of the presence or the addition of one or more other characteristics, numbers, steps, operations, components, parts, or combinations thereof.

Unless otherwise defined, all terms used herein, including technical or scientific terms, have the same meaning as those commonly understood by a person having ordinary skill in the art to which the present disclosure belongs. The terms defined in commonly used dictionaries should be interpreted as having a meaning consistent with a meaning in the context of the related art, and will not be interpreted in an idealized or overly formal meaning unless expressly defined in the present application.

Hereinafter, with reference to the accompanying drawings, preferred embodiments of the present disclosure will be described in more detail. In order to facilitate overall understanding in describing the present disclosure, the same reference numerals are used for the same components in the drawings, and repeated description of the same components will be omitted.

Since the embodiments described in the present disclosure are intended to clearly describe the idea of the present disclosure to a person having ordinary skill in the art to which the present disclosure belongs, the present disclosure is not limited to the embodiments described in the present disclosure, and the scope of the present disclosure should be interpreted to include correction examples or modification examples which do not depart from the idea of the present disclosure.

The terms used in the present disclosure are selected from general terms that are currently widely used in the technical field to which the present disclosure belongs, but the meanings may vary depending on intentions of a person having ordinary skill in the art to which the present disclosure belongs, customs, or new technology introduction. However, when a specific term is used after being defined with any arbitrary meaning, the meaning of the term will be separately described. Accordingly, the terms used in the present disclosure should be interpreted based on an actual meaning of the term and overall contents of the present disclosure, instead of the name of the simple term.

The accompanying drawings of the present disclosure are intended to facilitate description of the present disclosure, and in order to facilitate understanding of the present disclosure, shapes shown in the drawings may be exaggerated or abbreviated when necessary. Therefore, the present disclosure is not limited by the drawings.

In the present disclosure, when it is determined that detailed description of configurations or functions associated with the present disclosure may obscure the concept of the present disclosure, detailed description thereof will be omitted when necessary.

According to one aspect of the present disclosure, there is provided a method for tracking a trajectory of an object during a target time interval, based on image based locational information and sensor based locational information. The method includes a step of determining a confidence interval of the image based locational information, the confidence interval being at least a partial time interval in the target time interval, a step of tracking the trajectory of the object during the confidence interval, based on the image based locational information, and a step of tracking the trajectory of the object during a non-confidence interval which is an interval other than the confidence interval in the target time interval, based on the sensor based locational information. The image based locational information may include information on a location of at least one object determined from the captured image obtained by imaging one or more objects, and the sensor based locational information may include information on a location or a displacement of at least one determined object, based on signals from sensors corresponding to each of the one or more objects.

According to one aspect, the step of determining the confidence interval may include a step of determining at least one confidence frame in a plurality of frames forming a video corresponding to the target time interval, and a step of determining a plurality of subsequent frames subsequent to the confidence frame, based on a relationship with the confidence frame. The confidence interval may correspond to the confidence frame and the plurality of subsequent frames.

According to one aspect, the step of determining the confidence frame may include a step of detecting a plurality of objects from a first frame which is one of the plurality of frames, and a step of performing minimum cost assignment between the location of each of the plurality of objects included in the sensor based locational information corresponding to the first frame and the location of each of the plurality of objects detected from the first frame.

According to one aspect, in the step of determining the confidence frame, the first frame may be determined as the confidence frame in response to a determination that the number of the objects detected from the first frame is equal to a predetermined number of reference objects.

According to one aspect, the number of the reference objects may be a sum of the number of sensors associated with the sensor based locational information and the number of predetermined dummy objects.

According to one aspect, in the step of determining the confidence frame, the first frame may be determined as the confidence frame in response to a determination that a minimum distance between the objects detected from the first frame is greater than a predetermined threshold distance.

According to one aspect, in the step of determining the confidence frame, the first frame may be determined as the confidence frame in response to a determination that no occlusion occurs between the objects detected from the first frame.

According to one aspect, in the step of determining the confidence frame, the first frame may be determined as the confidence frame in response to a determination that an assignment cost for the location of each of the plurality of objects included in the sensor based locational information according to the minimum cost assignment and the location of each of the plurality of objects detected from the first frame is equal to or smaller than a predetermined first threshold value.

According to one aspect, in the step of determining the confidence frame, the first frame may be determined as the confidence frame in response to a determination that a maximum distance between any one of the plurality of objects included in the sensor based locational information matched according to the minimum cost assignment and any one of the plurality of objects detected from the first frame is equal to or smaller than a predetermined second threshold value.

According to one aspect, in the step of determining the confidence frame, the first frame may be determined as the confidence frame in response to a determination that the assignment cost for the minimum cost assignment according to a distance between the location of each of the plurality of objects detected from the first frame and the location of each of the plurality of objects detected from a frame adjacent to the first frame is equal to or smaller than a predetermined third threshold value.

According to one aspect, in the step of determining the confidence frame, the first frame may be determined as the confidence frame in response to a determination that a maximum distance between any one of the plurality of objects detected from the first frame and any one of the plurality of objects detected from a frame adjacent to the first frame is equal to or smaller than a predetermined fourth threshold value.

According to one aspect, the step of determining the subsequent frames may include a step of determining the second frame as one of the subsequent frames in response to a determination that the assignment cost for the minimum cost assignment according to a distance between the location of each of the plurality of objects detected from the confidence frame and the location of each of the plurality of objects detected from a second frame subsequent to the confidence frame is equal to or smaller than a predetermined fifth threshold, and a step of determining the third frame as one of the subsequent frames in response to a determination that the assignment cost for the minimum cost assignment according to a distance between the location of each of the plurality of objects detected from the second frame and the location of each of the plurality of objects detected from a third frame subsequent to the second frame is equal to or smaller than a predetermined fifth threshold value.

According to one aspect, the step of determining the subsequent frames may include a step of determining the second frame as one of the subsequent frames in response to a determination that a maximum distance between any one of the plurality of objects detected from the confidence frame and any one of the plurality of objects detected from a second frame subsequent to the confidence frame is equal to or smaller than a predetermined sixth threshold, and a step of determining the third frame as one of the subsequent frames in response to a determination that a maximum distance between any one of the plurality of objects detected from the second frame and any one of the plurality of objects detected from a third frame subsequent to the second frame is equal to or smaller than a predetermined sixth threshold value.

According to one aspect, in the step of determining the subsequent frames, the second frame may be determined as one of the subsequent frames in response to a determination that the number of the objects detected from the confidence frame is equal to the number of the objects detected from a second frame subsequent to the confidence frame.

According to one aspect, in the step of determining the confidence interval, the determination of the confidence interval may be confirmed in response to a determination that a time length corresponding to the confidence frame and the plurality of subsequent frames is equal to or greater than a predetermined threshold time length.

According to one aspect, the confidence interval includes a first confidence interval and a second confidence interval after the first confidence interval, and the step of tracking the trajectory of the object during the non-confidence interval may be configured to track the trajectory of the object during the non-confidence interval, based on an object location according to the image based locational information at an end point of the first confidence interval, an object location according to the image based locational information at a start point of the second confidence interval, and the trajectory of the object according to the sensor based locational information during the non-confidence interval between the first confidence interval and the second confidence interval.

According to one aspect, the step of tracking the trajectory of the object during the non-confidence interval may be performed through interpolation between the object location according to the image based locational information at the end point of the first confidence interval and the object location according to the image based locational information at the start point of the second confidence interval, by using the trajectory of the object according to the sensor based locational information in the non-confidence interval between the first confidence interval and the second confidence interval.

In one aspect, the sensor may include any one of a sensor for a Global Navigation Satellite System (GNSS), a sensor for a Local Positioning System (LPS), and a sensor for an Inertial Measurement Unit (IMU).

According to one aspect of the present disclosure, there is provided an apparatus for tracking a trajectory of an object during a target time interval, based on image based locational information and sensor based locational information. The apparatus includes a processor and a memory. The image based locational information includes information on a location of at least one object determined from a captured image obtained by imaging one or more objects, and the sensor based locational information includes information on a location or a displacement of at least one determined object, based on signals from sensors corresponding to each of the one or more objects. The processor may be configured to determine a confidence interval of the image based locational information, the confidence interval being at least a partial time interval in the target time interval, to track the trajectory of the object during the confidence interval, based on the image based locational information, and to track the trajectory of the object during the non-confidence interval which is an interval other than the confidence interval in the target time interval, based on the sensor based locational information.

According to one aspect of the present disclosure, there is provided a non-transitory computer-readable storage medium storing instructions executable by a processor. The instructions are provided to track a trajectory of an object during a target time interval, based on image based locational information and sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects. The instructions are executed by the processor. The processor is configured to determine a confidence interval of the image based locational information, the confidence interval being at least a partial time interval in the target time interval, to track the trajectory of the object during the confidence interval, based on the image based locational information, and to track the trajectory of the object during a non-confidence interval which is an interval other than the confidence interval in the target time interval, based on the sensor based locational information.

According to one aspect of the present disclosure, there is provided a method for tracking a trajectory of an object during a target time interval, based on image based locational information and sensor based locational information. The method includes a step of tracking the trajectory of each of the one or more objects during a reference time interval, based on the image based locational information, a step of tracking the trajectory of each of the one or more objects during the reference time interval, based on the sensor based locational information, and a step of matching each object from the image based locational information with each object from the sensor based locational information by performing minimum cost assignment between a plurality of trajectories according to the image, based locational information and a plurality of trajectories according to the sensor based locational information. The image based locational information may include information on a location of at least one object determined from a captured image obtained by imaging one or more objects, and the sensor based locational information may include information on a location or a displacement of at least one determined object, based on signals from sensors corresponding to each of the one or more objects.

According to one aspect, the reference time interval may be a confidence interval of the image based locational information, which is at least a partial time interval in the target time interval.

According to one aspect, the confidence interval may be determined, based on the step of determining at least one confidence frame in a plurality of frames forming a video corresponding to the target time interval, and the step of determining a plurality of subsequent frames subsequent to the confidence frame, based on a relationship with the confidence frame. The confidence interval may correspond to the confidence frame and the plurality of subsequent frames.

According to one aspect, the minimum cost assignment may be performed based on a Hungarian algorithm.

According to one aspect, the assignment cost for the minimum cost assignment may include a mean distance determined, based on a distance between a plurality of trajectories according to the image based locational information and a plurality of trajectories according to the sensor based locational information.

According to one aspect, the mean distance may be determined, based on a distance value between the location of the object according to the image based locational information and the location of the object according to the sensor based locational information at each start point included in the reference time interval.

According to one aspect, the assignment cost for the minimum cost assignment may include a shape distance determined, based on a shape similarity between a plurality of trajectories according to the image based locational information and a plurality of trajectories according to the sensor based locational information.

According to one aspect, the shape distance may be determined, based on a difference value between a location distance and the mean distance at each start point included in the reference time interval. The location distance may be a distance between the location of the object according to the image based locational information and the location of the object according to the sensor based locational information, and the mean distance may be a mean value of the location distances at each start point included in the reference time interval.

According to one aspect, the assignment cost for the minimum cost assignment may include a weighted sum of the mean distance and the shape distance between a plurality of trajectories according to the image based locational information and a plurality of trajectories according to the sensor based locational information, and may be a shape-weighted assignment cost that assigns a weight to the shape distance.

According to one aspect, the sensor based locational information may further include identification information for each of the one or more objects, and the method may further include a step of allocating identification information to each of the one or more objects from the image based locational information, based on matching between the object from the image based locational information and the object from the sensor based locational information.

According to one aspect, the method may further include a step of determining error values of trajectories according to the sensor based locational information for each of the objects, based on a comparison result between trajectories according to the image based locational information and trajectories according to the sensor based locational information for each of the objects matched by the minimum cost assignment.

According to one aspect, the error value may be a mean value of distance values between the location of the object according to the image based locational information and the location of the object according to the sensor based locational information at each start point included in the reference time interval.

According to one aspect, the method may further include a step of acquiring a corrected sensor based trajectory of each of the one or more objects by removing the error value for each of the trajectories from each trajectory of the one or more objects according to the sensor based locational information.

According to one aspect, the method may further include a step of re-matching each object from the image based locational information with each object from the sensor based locational information by performing the minimum cost assignment between a plurality of trajectories according to the image based locational information and the corrected sensor based trajectories.

According to one aspect, the step of re-matching may be performed in response to a determination that an evaluation value for the error value of each of the objects is equal to or greater than a predetermined threshold evaluation value.

In one aspect, the sensor may include any one of a sensor for the Global Navigation Satellite System (GNSS), a sensor for the Local Positioning System (LPS), and a sensor for the Inertial Measurement Unit (IMU).

According to one aspect of the present disclosure, there is provided an apparatus for tracking a trajectory of an object during a target time interval, based on image based locational information and sensor based locational information. The apparatus includes a processor and a memory. The image based locational information includes information on a location of at least one object determined from a captured image obtained by imaging one or more objects, and the sensor based locational information includes information on a location or a displacement of at least one determined object, based on signals from sensors corresponding to each of the one or more objects. The processor is configured to track the trajectory of each of the one or more objects during a reference time interval, based on the image based locational information, to track the trajectory of each of the one or more objects during the reference time interval, based on the sensor based locational information, and to match each object from the image based locational information with each object from the sensor based locational information by performing the minimum cost assignment between a plurality of trajectories according to the image based locational information and a plurality of trajectories according to the sensor based locational information.

According to one aspect of the present disclosure, there is provided a non-transitory computer-readable storage medium storing instructions executable by a processor. The instructions are provided to track a trajectory of an object during a target time interval, based on image based locational information and sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects. The instructions are executed by the processor. The processor is configured to track the trajectory of each of the one or more objects during a reference time interval, based on the image based locational information, to track the trajectory of each of the one or more objects during the reference time interval, based on the sensor based locational information, and match each object from the image based locational information with each object from the sensor based locational information by performing the minimum cost assignment between a plurality of trajectories according to the image based locational information and a plurality of trajectories according to the sensor based locational information.

According to one aspect of the present disclosure, there is provided a method for tracking a trajectory of an object during a target time interval, based on image based locational information and sensor based locational information. The method includes a step of determining an error value existing in the sensor based locational information, based on the image based locational information and the sensor based locational information, a step of acquiring the sensor based locational information corrected by removing the error value from the sensor based locational information, and a step of tracking the trajectory of the object during the target time interval, based on the corrected sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects.

According to one aspect, the step of determining the error value may include a step of tracking a trajectory of one or more objects during a reference time interval, based on the image based locational information, a step of tracking a trajectory of one or more objects during a reference time interval, based on the sensor based locational information, and a step of calculating an error value existing in the sensor based locational information for the one or more objects during the reference time interval, based on a comparison result between the trajectory according to the image based locational information and the trajectory according to the sensor based locational information.

According to one aspect, the error value during the reference time interval may be a mean value of distance values between the location of the object according to the image based locational information and the location of the object according to the sensor based locational information at each start point included in the reference time interval.

According to one aspect, the reference time interval may be a confidence interval of the image based locational information which is at least a partial time interval in the target time interval.

According to one aspect, the confidence interval may be determined, based on a step of determining at least one confidence frame in a plurality of frames forming a video corresponding to the target time interval, and a step of determining a plurality of subsequent frames subsequent to the confidence frame, based on a relationship with the confidence frame. The confidence interval may correspond to the confidence frame and the plurality of subsequent frames.

According to one aspect, the step of calculating the error value during the reference time interval may be performed based on a comparison result between the trajectory according to the image based locational information and the trajectory according to the sensor based locational information, which are matched by performing the minimum cost assignment between a plurality of trajectories according to the image based locational information and a plurality of trajectories according to the sensor based locational information.

According to one aspect, the minimum cost assignment may be performed based on the Hungarian algorithm.

According to one aspect, the step of determining the error value may further include a step of calculating a second error value existing in the corrected sensor based locational information, based on a comparison result between the trajectory according to the image based locational information and the trajectory according to the corrected sensor based locational information, by performing the minimum cost assignment between the plurality of trajectories according to the image based locational information and the plurality of trajectories according to the corrected sensor based locational information, after the step of acquiring the corrected sensor based locational information, in response to a determination that the evaluation value for the error value is equal to or greater than a predetermined threshold evaluation value.

According to one aspect, the method may further include a step of updating the corrected sensor based locational information, based on the second error value. The step of tracking the trajectory of the object during the target time interval may be performed based on updated corrected sensor based locational information.

According to one aspect, the step of tracking the trajectory of the object during the target time interval may be performed in response to a determination that the evaluation value for the error value or the second error value is smaller than a predetermined threshold evaluation value.

According to one aspect, the step of determining the error value may further include a step of determining an error value existing in the sensor based locational information for the one or more objects during a non-confidence interval which is an interval other than the confidence interval in the target time interval.

According to one aspect, the step of determining the error value during the non-confidence interval may be configured such that the error value of the most anterior confidence interval in the target time interval is used as the error value during the non-confidence interval before the most anterior confidence interval.

According to one aspect, the step of determining the error value during the non-confidence interval may be configured such that the error value of the most posterior confidence interval in the target time interval is used as the error value during the non-confidence interval after the most posterior confidence interval.

According to one aspect, the step of determining the error value during the non-confidence interval may be configured such that for a first confidence interval and a second confidence interval which are included in the target time interval, a linear interpolation value between the error value of the first confidence interval and the error value of the second confidence interval is used as the error value during the non-confidence interval between the first confidence interval and the second confidence interval.

In one aspect, the sensor may include any one of a sensor for the Global Navigation Satellite System (GNSS), a sensor for the Local Positioning System (LPS), and a sensor for the Inertial Measurement Unit (IMU).

According to one aspect of the present disclosure, there is provided an apparatus for tracking a trajectory of an object during a target time interval, based on image based locational information and sensor based locational information. The apparatus includes a processor and a memory. The image based locational information includes information on a location of at least one object determined from a captured image obtained by imaging one or more objects, and the sensor based locational information includes information on a location or a displacement of at least one determined object, based on signals from sensors corresponding to each of the one or more objects. The processor is configured to determine an error value existing in the sensor based locational information, based on the image based locational information and the sensor based locational information, to acquire corrected sensor based locational information in which the error value is removed from the sensor based locational information, and to track the trajectory of the object during the target time interval, based on the corrected sensor based locational information.

According to one aspect of the present disclosure, there is provided a non-transitory computer-readable storage medium storing instructions executable by a processor. The instructions are provided to track a trajectory of an object during a target time interval, based on image based locational information and sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects. The instructions are executed by the processor. The processor is configured to determine an error value existing in the sensor based locational information, based on the image based locational information and the sensor based locational information, to acquire corrected sensor based locational information in which the error value is removed from the sensor based locational information, and to track the trajectory of the object during the target time interval, based on the corrected sensor based locational information.

According to one aspect of the present disclosure, there is provided a method for tracking a trajectory of an object during a target time interval, based on image based locational information and sensor based locational information. The method includes a step of determining a first object group including at least some of a plurality of objects existing in the captured image, and a step of determining a confidence interval of the image based locational information, based on the image based locational information and the sensor based locational information which correspond to the first object group, the confidence interval being at least a partial time interval in the target time interval. The image based locational information includes information on a location of at least one object determined from a captured image obtained by imaging one or more objects, and the sensor based locational information includes information on a location or a displacement of at least one determined object, based on signals from sensors corresponding to each of the one or more objects.

According to one aspect, the method may further include a step of tracking the trajectory of the object included in the first object group during the confidence interval, based on the image based locational information corresponding to the first object group, and a step of tracking the trajectory of the object included in the first object group during a non-confidence interval which is an interval other than the confidence interval in the target time interval, based on the sensor based locational information.

According to one aspect, the method may include a step of determining an error value existing in the sensor based locational information corresponding to the first object group during the confidence interval, based on the image based locational information and the sensor based locational information which correspond to the first object group, a step of acquiring corrected sensor based locational information in which the error value is removed from the sensor based locational information corresponding to the first object group, and a step of tracking the trajectory of the object included in the first object group during the confidence interval, based on the corrected sensor based locational information.

According to one aspect, the step of determining the first object group may be configured to determine whether the object within an object detection area is included in the first object group, based on a characteristic value determined by using internal pixel values of each of a plurality of object detection areas extracted from the captured image.

According to one aspect, the step of determining the first object group may be configured to determine whether the object inside the object detection area is included in the first object group, based on a dominant value in the internal pixel values of each of the plurality of object detection areas extracted from the captured image.

According to one aspect, the dominant value may be calculated from pixels excluding pixels corresponding to a background other than the object in pixels included in the object detection area.

According to one aspect, the object included in the first object group may be an object equipped with a sensor for acquiring the sensor based locational information.

According to one aspect, the method is a method for tracking a plurality of players in a team sports game, and the plurality of objects existing in the captured image may be divided into a first object group corresponding to first team players in a team sports game, a second object group corresponding to second team players in the team sports game, and a third object group corresponding to non-participants in the game.

According to one aspect, the step of determining the confidence interval may include a step of determining at least one confidence frame in the plurality of frames forming a video corresponding to the target time interval, and a step of determining a plurality of subsequent frames subsequent to the confidence frame, based on a relationship with the confidence frame. The confidence interval may correspond to the confidence frame and the plurality of subsequent frames.

According to one aspect, the step of determining the confidence frame may include a step of detecting a plurality of objects included in the first object group from a first frame which is one of the plurality of frames, and a step of performing the minimum cost assignment between the location of each of the plurality of objects included in the sensor based locational information corresponding to the first frame and the location of each of the plurality of objects included in the first object group detected from the first frame.

According to one aspect, in the step of determining the confidence frame, the first frame may be determined as the confidence frame in response to a determination that the number of the objects included in the first object group detected from the first frame is equal to a predetermined number of reference objects.

According to one aspect, in the step of determining the confidence frame, the first frame may be determined as the confidence frame in response to a determination that a minimum distance between the objects included in the first object group detected from the first frame is greater than a predetermined threshold distance.

According to one aspect, in the step of determining the confidence frame, the first frame may be determined as the confidence frame in response to a determination that no occlusion has occurred between objects included in the first object group detected from the first frame.

According to one aspect, in the step of determining the confidence frame, the first frame may be determined as the confidence frame in response to a determination that the assignment cost for the location of each of the plurality of objects included in the sensor based locational information according to the minimum cost assignment and each location of the objects included in the plurality of first object groups detected from the first frame is equal to or smaller than a predetermined first threshold value.

According to one aspect, in the step of determining the confidence frame, the first frame may be determined as the confidence frame in response to a determination that a maximum distance between any one of the plurality of objects included in the sensor based locational information matched according to the minimum cost assignment and any one of the objects included in the plurality of first object groups detected from the first frame is equal to or smaller than a predetermined second threshold value.

According to one aspect, in the step of determining the confidence frame, the first frame may be determined as the confidence frame in response to a determination that the assignment cost for the minimum cost assignment according to a distance between each position of the objects included in the plurality of first object groups detected from the first frame and each position of the objects included in the plurality of first object groups detected from a frame adjacent to the first frame is equal to or smaller than a predetermined third threshold value.

According to one aspect, in the step of determining the confidence frame, the first frame may be determined as the confidence frame in response to a determination that a maximum distance between any one of the objects included in the plurality of first object groups detected from the first frame and any one of the objects included in the plurality of first object groups detected from the frame adjacent to the first frame is equal to or smaller than a predetermined fourth threshold value.

In one aspect, the sensor may include any one of a sensor for the Global Navigation Satellite System (GNSS), a sensor for the Local Positioning System (LPS), and a sensor for the Inertial Measurement Unit (IMU).

According to one aspect of the present disclosure, there is provided an apparatus for tracking a trajectory of an object during a target time interval, based on image based locational information and sensor based locational information. The apparatus includes a processor and a memory. The image based locational information includes information on a location of at least one object determined from a captured image obtained by imaging one or more objects, and the sensor based locational information includes information on a location or a displacement of at least one determined object, based on signals from sensors corresponding to each of the one or more objects. The processor is configured to determine a first object group including at least some of a plurality of objects existing in the captured image, and determine a confidence interval of the image based locational information, based on the image based locational information and the sensor based locational information which correspond to the first object group, the confidence interval being at least a partial time interval in the target time interval.

According to one aspect of the present disclosure, there is provided a non-transitory computer-readable storage medium storing instructions executable by a processor. The instructions are provided to track a trajectory of an object during a target time interval, based on image based locational information and sensor based locational information. The image based locational information includes information on a location of at least one object determined from a captured image obtained by imaging one or more objects, and the sensor based locational information includes information on a location or a displacement of at least one determined object, based on signals from sensors corresponding to each of the one or more objects. The instructions are executed by the processor. The processor is configured to determine a first object group including at least some of a plurality of objects existing in the captured image, and to determine a confidence interval of the image based locational information based on the image based locational information and the sensor based locational information which correspond to the first object group, the confidence interval being at least partial time interval in the target time interval.

### Object Tracking

As described above, sports analyses have gradually become more important in response to an explosive growth of a sports industry market and developments of sports science. In this trend, Electronic Performance Tracking Systems (EPTS) for tracking sports players during games or training hours have been consecutively introduced, especially in major sports such as soccer. In the EPTS, locations or movements of the sports players are utilized as important basic data to provide various additional information. Therefore, various efforts have been continuously made to more easily acquire tracking information on the locations of sports players and to improve accuracy thereof.

More specifically, in a sports industry field, as in many other industry fields, data science starts to be used as a very important tool, and data mainly utilized in the sports industry field may be divided into event data and tracking data. The event data may include information on ball-related events which may occur during a sports game, and tracking data may include information obtained by collecting locations of respective players in accordance with a specific time scale.

In a case of dynamic team sports such as soccer, basketball, and ice hockey, player tracking data may provide rich information such as player interactions and off-the-ball movements which may be overlooked in the event data. In the soccer game, for example, based on the player tracking data, various applications such as formation, role estimation, spatial control analysis, playing style identification, and false prediction may be utilized.

In recent years, in order to acquire the tracking data, different types of tracking systems, such as a Global positioning system (GPS), a Local Positioning System (LPS), and an Optical Tracking System (OTS) based on a plurality of cameras, have been proposed and successfully adopted for the soccer games.

The GPS has advantages of low cost and easy installation, compared to other methods, but it is known that the GPS is more sensitively affected by a measurement environment such as weather and stadium conditions. On the other hand, the OTS may provide more accurate tracking information when many high-definition cameras are sufficiently installed to surround a stadium at different angles. However, it is not easy to install facilities for the OTS in all stadiums, and in many cases, it is difficult to install OTS equipment in a training stadium or an away stadium which is not a home stadium. In addition, when the OTS needs to be realized with a smaller number of cameras, low-quality raw data is secured, and a manual correction process is required. Consequently, reliable tracking data cannot be secured.

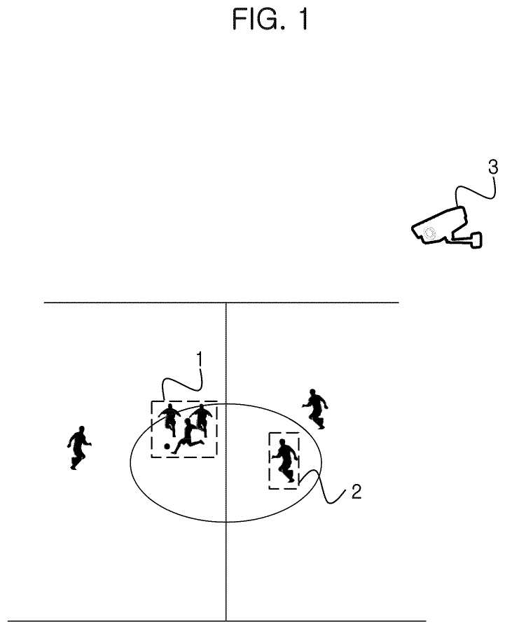

In this regard, FIG. 1 is an example of acquiring the image based locational information. As shown in FIG. 1, a positioning method for calculating the spot of a player from an image captured through a camera 3 may be utilized.

According to the positioning method using the image, only when the tracking target player has to be recognized within the video, the location of the player may be accurately calculated.

For example, for the player located in a second area 2 in FIG. 1, the player may be recognized, and the location of the tracking target player may be calculated.

However, for the player located in a first area 1 in FIG. 1, an occlusion event may occur in which the player is less likely to be recognized. Specifically, since a plurality of players are densely located in the first area 1, the occlusion event may occur in which the tracking target player in the video is occluded by another player. Accordingly, a location of a tracking target player occluded by another player cannot be accurately acquired.

In other words, the positioning method using the video cannot respond to an occlusion situation in which the tracking target player is occluded by another player within the video.

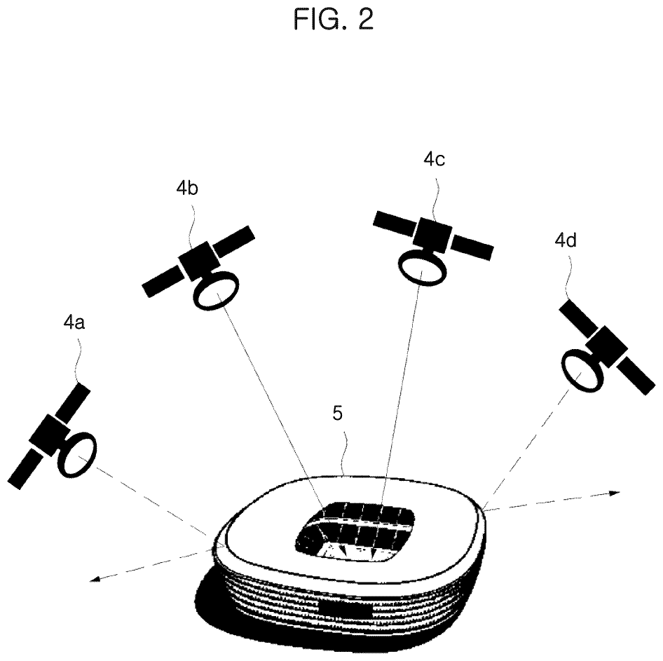

FIG. 2 is an example of acquiring the sensor based locational information. As shown in FIG. 2, a positioning method for calculating the spot of the player by using a sensor based positioning device, for example, such as a GPS module, may be utilized.

Specifically, in the positioning method using the GPS module, the location of the tracking target player is calculated depending on signals transmitted from satellites 4a, 4b, 4c, and 4d. However, the signals or the like transmitted from satellites may be greatly affected by structures surrounding the tracking target player.

For example, the GPS signals transmitted from some satellites 4b and 4c in FIG. 2 may be transmitted into the stadium without being affected by the structures surrounding the tracking target player. However, the GPS signals transmitted from some satellites 4a and 4d in FIG. 2 may be affected by the structures surrounding the tracking target player, and may not reach the stadium. In this case, when the GPS signals transmitted from some satellites 4a and 4d are affected by the structures surrounding the player, the location of the player which is calculated from the GPS signals may have an error.

Meanwhile, in order to track the object, detection and identification of the object are required. That is, tracking a specific object may include acquiring information on continuous locations of the specific object during a time interval having a predetermined length and determining a trajectory of the specific object. For example, in a case of team sports, instead of tracking a single object, a plurality of objects are tracked in many cases. Therefore, after the plurality of objects are detected, when the objects are tracked, it is essential to identify whether each object corresponds to any object.

In this regard, for example, in a case of acquiring the sensor based locational information such as the GPS and the LPS, a separate identification process may not be required. A plurality of sensors for acquiring locational information may each correspond to the specific object in the plurality of objects, and each sensor device may be configured to have a device ID. Accordingly, it is possible to recognize whether locational information measured by a specific sensor is locational information for a certain object by using the device ID without a separate identification procedure.

On the other hand, in acquiring the image based locational information such as the OTS, when the plurality of objects are detected in each frame in a plurality of frames forming a video, it is required to identify whether a certain object corresponds to the object detected in a next frame. That is, for example, when first to tenth objects exist as tracking targets, when ten objects are detected in the first frame and ten objects are detected in the second frame, it has to be determined whether a certain object in the first frame corresponds to any object in the second frame. In this case, it is possible to secure the tracking data for the trajectory of the object by matching time series information during a time interval having a predetermined time length.

For this purpose, a procedure for acquiring the tracking data using the image based locational information may include a procedure for detecting the object for each frame and a procedure for matching the objects between respective frames. However, errors may occur in each of the object detection procedure and the object matching procedure.

First, in the object detection procedure, a false negative error may occur in which a detection target object is not detected, or a false positive error may occur in which an incorrect object is detected.

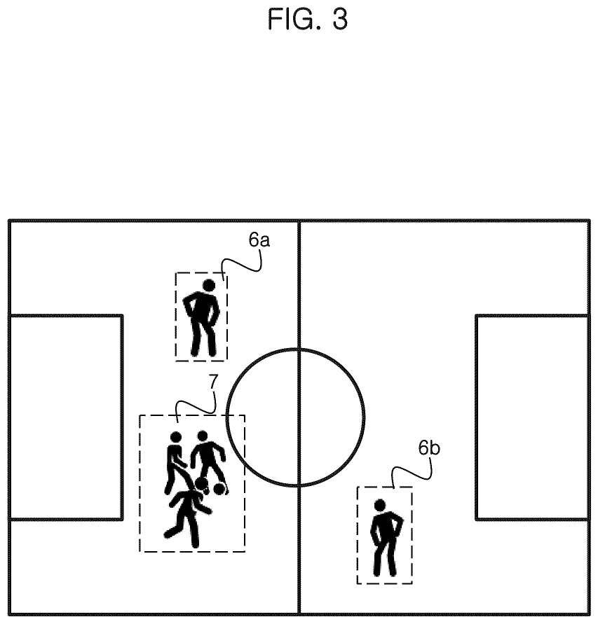

FIG. 3 shows an example of a false negative error state including a missing object. As shown in FIG. 3, objects located in detection areas 6a and 6b, such as bounding boxes B-boxes in an image acquired by a camera, may be normally detected, but three objects located in a detection area 7 may be occluded by each other. Accordingly, there may be a problem in that at least one of the three objects is not detected. That is, some of the tracking target objects may not be detected in the corresponding frame.

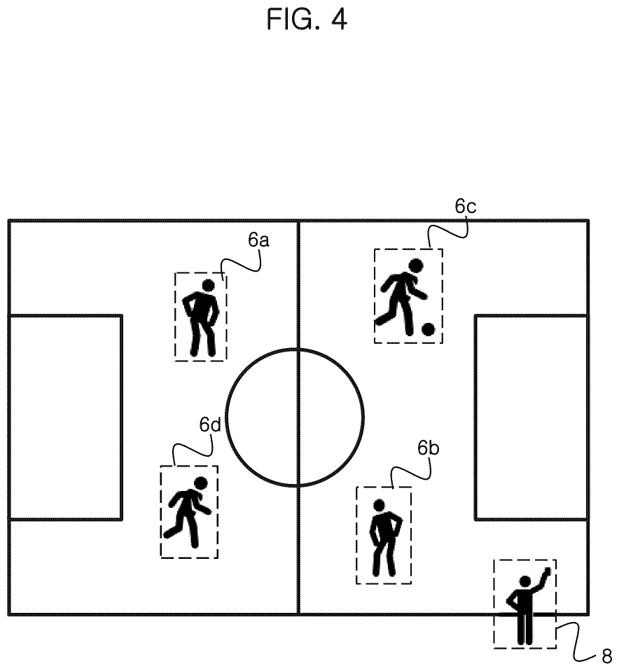

FIG. 4 shows an example of a false positive error state including an incorrectly detected object. As shown in FIG. 4, objects located in detection areas 6a, 6b, 6c, and 6d may be normally detected objects. However, for example, an object located in a detection area 8 may be a referee. Since the referee is not a tracking target object, the referee is detected even though the referee should not be detected. Consequently, there may be a problem. For example, in some frames, there may be a problem in that 11 objects may be detected instead of 10 objects intended to be detected, or in some situations, detecting a specific object is missed at the same time. Consequently, 10 objects including nine tracking target objects and one object which is not the tracking target object may be detected.

Errors in the object detection procedure may further increase a possibility of errors in the object matching procedure. For example, detected objects may be matched in consecutive frames to secure continuous locational information of the specific object. Any algorithm in various algorithms may be selected to match the detected objects between frames. For example, the Hungarian algorithm which minimizes matching costs, such as the sum of distance differences between the objects, may be adopted.

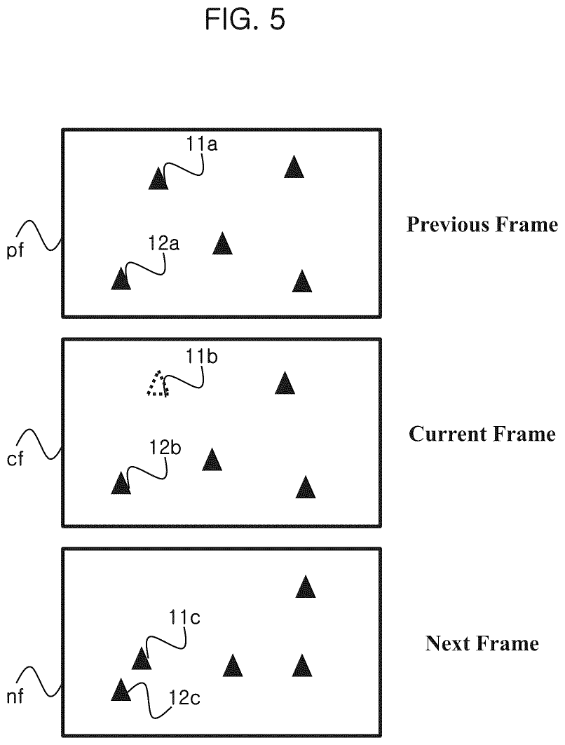

FIG. 5 shows object matching between frames in a video including a plurality of objects. Depending on an arrangement form of the detected objects, such as when a distance between specific objects is very close, an error may occur in which mutually different objects in each frame are matched, and a possibility of error occurrence becomes higher when an error previously occurs in the step of detecting the object. As shown in FIG. 5, an object matching procedure during a plurality of frames including a previous frame pf, a current frame cf, and a next frame nf will be examined. In a case of three objects on a right side of the frame, which have no separately assigned reference numeral, the objects detected without difficulty may be matched frame by frame. However, an error which may occur in matching between frames of a first object 11 and a second object 12 will be examined with reference to FIG. 5. The first object 11 may be detected as an object 11a in the previous frame, and may also be detected as an object 11c in the next frame. However, a situation may occur in which detection is missed due to an error in the object detection procedure, even though the first object 11 has to be detected as an object 11b in the current frame. The second object 12 may be detected as an object 12a in the previous frame, may be detected as an object 12b in the current frame, and may be detected as an object 12c in the next frame. In a case of examining the object matching between frames, when the object matching between the previous frame and the current frame is performed, it may be determined that the objects 12a and 12b may match each other, and that the object 11a does not have a matching object. When the object matching between the current frame and the next frame is performed, there may be a problem in that the object 12b has to match any one of the object 11c and the object 12c. When the object 12b matches the object 11c, an error occurs in which the first object and the second object are incorrectly matched. Even when the distance between the plurality of objects is relatively close, when there are continuous movements, the objects may be properly matched. However, as shown in FIG. 5, when the detected location for the first object 11 instantaneously moves from the location of the object 11a to the location of the object 11c, it may be difficult to expect the object matching between the frames.

That is, when the object is tracked by using the image based locational information such as the OTS, a problem may occur in detecting the object, or a problem may occur in matching the detected objects frame by frame. In order to solve the problems, a method has been proposed in which a plurality of cameras are respectively installed at mutually different spots surrounding the objects and images at a plurality of angles are utilized. However, high cost is required for installing the cameras. Moreover, it is not easy to secure proper locations for installing the plurality of cameras inside the stadium.

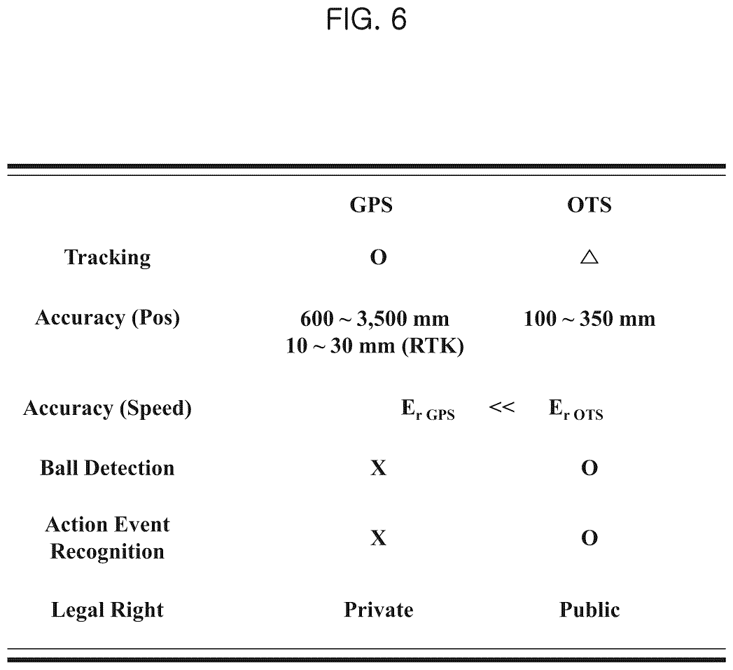

As described above, the object tracking using the image based locational information such as the OTS and the sensor based locational information such as the GPS may have different advantages and disadvantages. FIG. 6 shows a comparison between the GPS method and the OTS method.

As shown in FIG. 6, in terms of the object tracking, the GPS may track a specific object by simply collecting time-series location data from a specific sensor without a separate identification procedure by utilizing a device ID of a sensor corresponding to each object. On the other hand, the OTS has to consider a possibility of errors occurring in the procedures of the object detection and matching between the frames.

However, the GPS generally has an error range of approximately 600 to 3,500 mm in terms of position accuracy. Although it is possible to reduce the error range to approximately 10 to 30 mm when a solution such as RTK is introduced, the solution is less likely to be introduced due to cost issues. On the other hand, the OTS may secure information on the location of the object with high accuracy of an error range of 100 to 350 mm.

Accuracy in information on a displacement such as a speed may be higher in the GPS method than in the OTS method. Due to factors of Doppler displacement measurement using signals from satellites, unlike accuracy in determining a location of a specific start point, a measurement error ErGPS in displacement based information such as the speed measured by the GPS method is much smaller than a measurement error ErOTS in the OTS method.

In terms of ball detection used in sports games, the OTS method is advantageous. The OTS may enable the ball detection by processing a captured image without having to insert a specific sensor or device into a ball. On the other hand, in order to enable the ball detection through the GPS, a GPS sensor has to be inserted into the ball. Consequently, especially in a situation where an outcome of the game is sensitive as in professional sports, there is a problem in that inserting the sensor into the ball which may affect the game greatly provokes antipathy.

In terms of action event recognition in sports games, the OTS method is advantageous. In a case of the GPS method, since the information on the location of the object is acquired, it is not easy to recognize specific actions such as passing and shooting. On the other hand, since the OTS method performs a video analysis, it is possible to detect specific action events such as shooting and passing by the player by establishing a proper video processing procedure and analysis algorithm.

In terms of legal rights, the OTS method may be somewhat advantageous. In a case of the GPS method, data measured through the GPS method may belong to an owner of the GPS sensor. For example, in a case of sports data, rights to GPS based collected data on players of a specific club belong to the club. In a sports analysis, it is important to analyze the games of competing clubs as well as analyzing the club to which the players belong. However, it may not be easy to secure the GPS data on players of other clubs. On the other hand, in a case of videos for the OTS, videos of any club may be released to a public domain through broadcasts, for example, such as sports broadcasts. Therefore, tracking data on players or games of other clubs may be secured and utilized by using a method for analyzing broadcasted videos.

As described above, the object tracking using the image based locational information and the sensor based locational information have mutually different advantages and disadvantages, and it is difficult to satisfy both accuracy and reliability with one method. In order to solve the problems, the present disclosure discloses embodiments for tracking the trajectory of the object during a time interval having a predetermined time length, based on the image based locational information and the sensor based locational information.

Meanwhile, in addition to the above-described sports analysis field, there are increasing cases of tracking and utilizing the locations and the trajectories of the objects for various purposes. For example, there are increasing interests in various industries using the object tracking, such as services of tracking a location of a vehicle to provide additional services, utilizing the location of the vehicle to collect vehicle-related statistics, and location monitoring for child protection. In each of various technical fields, ensuring reliability and improving accuracy in detecting the trajectory of the object are recognized as important.

In the present disclosure, for convenience of description below, a form of tracking the trajectory of the player for sports analysis may be described as an example. However, the technical scope of the present disclosure is not limited thereto, and it should be interpreted that the object tracking method according to one embodiment of the present disclosure is applicable to any object tracking field in which information on the location of the object is acquired and utilized.

### Terms

In the present disclosure, specific technical terms may be used. Hereinafter, the terms used in the present disclosure will be described to establish definitional support for the terms used in the present disclosure.

The following description is a summary of preferred definitions of some terms used in the present disclosure. The definitions described below are provided as examples only, and are not intended to be exhaustive or restrictive.

The term of “the image based locational information” may refer to information on a location of a determined object by using an image including the object. The image based locational information may include information on a location of at least one determined object from a captured image obtained by imaging one or more objects. For example, the image based locational information may include information on each location of players determined by analyzing a video of a team sport game in which a plurality of players participate. However, without being limited thereto, it should be interpreted in a comprehensive sense including locational information acquired from a captured image of any type of object.

The term of “the sensor based locational information” may refer to information on a location of a determined object by using signals from sensors corresponding to the objects. The sensor based locational information may include information on a location or a displacement of at least one determined object, based on signals from sensors corresponding to each of the one or more objects. For example, the sensor based locational information may include locational information acquired through a positioning solution of the Global Navigation Satellite System (GNSS) such as the GPS or the Local Positioning System (LPS). However, without being limited thereto, it should be interpreted in a comprehensive sense including locational information of the object acquired through signals from a sensor corresponding to a specific object.

For example, acceleration-related signals may be measured from an inertial measurement unit (IMU) corresponding to an object, and acceleration measurement values may be integrated to secure information on a speed. This secured information may be integrated again to acquire the displacement. In this manner, a form of measuring a movement path of the corresponding object may be implemented. It should be interpreted that this information on the displacement of the object may also be included in the sensor based locational information.

The object tracking methods, apparatuses, and systems according to the embodiments of the present disclosure may track and provide the trajectory of the object. The trajectory of the object may be understood as the movement path including time series information of the locations of the objects during the time interval having a predetermined time length.

### System

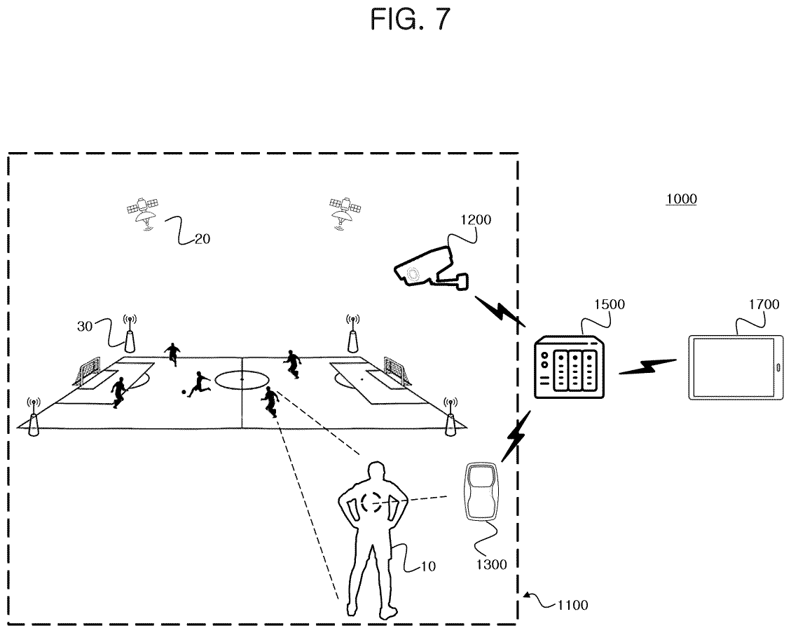

FIG. 7 shows an exemplary system in which the object tracking method according to one embodiment of the present disclosure may be performed. Hereinafter, an object tracking system 1000 according to the embodiments of the present disclosure will be described with reference to FIG. 7. However, the object tracking procedure according to the present disclosure is not limited to a case of being performed only by a system configuration in FIG. 7, and it should be understood that any hardware configuration and a combination thereof for acquiring the image based locational information and the sensor based locational information and performing operations thereon may be adopted to implement the object tracking method according to the embodiments of the present disclosure.

As shown in FIG. 7, the system 1000 may include a sensing platform 1100 and a server 1500. According to one aspect, the system 1000 may further include a terminal 1700.

The system 1000 may detect information on an object 10 during a target time interval through the sensing platform 1100, and may determine the trajectory of the object from the detected information through the server 1500. In addition, information on the determined trajectory of the object may be displayed through the terminal 1700.

Hereinafter, exemplary components of the object tracking system according to the embodiments of the present disclosure will be described.

### Sensing Platform

For example, the sensing platform 1100 may detect various information on the object 10. For example, the sensing platform 1100 may perform positioning on the object 10, or may detect the movement of the object 10.

As an example, the sensing platform 1100 may detect kinematic information on the object 10. The kinematic information is information on the location, a posture, or the movement of the object 10. The kinematic information may include at least one of locational information, orientational information, and movement information. The movement information may include at least one of the speed, acceleration, jerk, angular speed, angular acceleration, angular jerk, magnitudes thereof (for example, in a case of the speed, velocity), and orientations thereof (for example, in a case of the speed, a direction of the movement).

Results of the positioning performed on the object 10 by the sensing platform 1100 may be provided as the locational information of the object. Alternatively, the location of the object may be determined by processing at least one of various kinematic information described above or a combination thereof, and may be provided as the locational information of the object.

The sensing platform 1100 may be provided in various forms for detecting various information described above. As an example, the sensing platform 1100 may be implemented as a sensor based platform using a sensor device 1300 provided to correspond to each object 10 and providing a signal for a measurement result, an image based platform using a camera 1200 arranged in or around a playground, or a combination of the two platforms.

### Sensor Based Platform

Hereinafter, a sensor based sensing platform will be described.

The sensor based sensing platform may include the sensor device 1300. The sensing platform may acquire activity information on the object 10 corresponding to the sensor device 1300 by using a sensor mounted on the sensor device 1300. According to one aspect, the sensor device 1300 may be implemented in a form of an attachable device attached to each of the objects 10. However, without being limited thereto, the sensing platform may include any form of devices configured to perform sensing on the corresponding object.

The sensor device 1300 according to the embodiment may be attached to the object 10 to be used to detect activity information of the object 10. For example, the sensor device 1300 may include a Global Positioning System (GPS) sensor, and may be used to position the object 10 to which the sensor device 1300 is attached.

One or more sensor devices 1300 may be attached to one object 10. In particular, when the sensing platform is less likely to acquire all of information to be acquired through the sensor device 1300 with a single sensor device 1300, a plurality of the sensor devices 1300 may be needed for one object 10. For example, one attachable device including the GPS sensor and an Inertial Measurement Unit (IMU) sensor and another attachable device including a heart rate sensor may be respectively attached to a torso and a wrist of the object 10, and the attachable device attached to the torso may be configured to sense the location and the movement of the object 10.

As an example, the sensor based sensing platform may acquire kinematic information by using the sensor device 1300.

Hereinafter, some examples in which the sensor based sensing platforms acquire the kinematic information will be described.

The sensing platform may acquire locational information by using a positioning module of the sensor device 1300.

For example, the sensor device 1300 may include a global positioning module (in other words, a satellite positioning module or a Global Navigation Satellite System (GNSS) module), and the sensing platform may use the global positioning module to measure the location for the object 10 by performing global positioning. Specifically, the sensing platform may perform the global positioning on the object 10 in such a manner that the GNSS module receives satellite signals from navigation satellites 20 and calculates a global location (for example, a latitude and a longitude) from the received satellite signals through a triangulation technique. Meanwhile, the sensing platform may additionally include a base station for performing Real-Time Kinematic (RTK) for more accurate positioning. The sensing platform may use the global location as activity information as it is, but may also use the global location as activity information by processing the global location into a local location defined as a reference coordinate system for a playground. Here, the reference coordinate system may be a two-dimensional planar coordinate system in which a length direction and a width direction of the playground are set as axes and one spot on the playground or a periphery thereof (for example, one of corners or a center of the stadium) is set as an origin. Meanwhile, it should be noted in advance that all position-related information processed below may be processed without limitation according to the reference coordinate system.

As another example, the sensor device 1300 may include a local positioning module, and the sensing platform may measure a location for the object 10 in such a manner that local positioning is performed by using a local positioning sensor network including the sensor device 1300. The local positioning sensor network may include a tag node moving while being attached to a positioning target object, and an anchor node 30 fixedly installed in a positioning area, and may perform positioning by using a local positioning system (LPS) signal transmitted and received between the tag node and the anchor node. The sensing platform may perform the local positioning for the object 10 by using results of transmitting and receiving LPS signals between the sensor device 1300 including the local positioning module, attached to the positioning target object 10, operated as the tag node, and the anchor node 30 fixedly installed in the playground or the periphery thereof.

The sensing platform may acquire movement information and/or orientational information by using a motion sensing module of the sensor device 1300.

For example, the sensor device 1300 may include an IMU sensor (or an Attitude and Heading Reference System (AHRS) sensor), and the sensing platform may acquire the movement information and/or the orientational information of the object 10 or a partial body of the object 10 by using the acceleration, the angular speed, and an azimuth which are detected by the IMU sensor. When the sensor device 1300 is attached to the torso of the object 10, the movement information according to the locational movement of the object 10 may be acquired, and when the sensor device 1300 is attached to a foot or a leg of the object 10, the movement information of the arm or the leg of the object 10 may be acquired.

Meanwhile, the sensing platform may calculate other kinematic information by using the measured kinematic information. For example, the sensing platform may output the velocity, based on the global locations continuously measured by the GPS module and a sampling interval thereof. Since the kinematic information may be calculated through simple mathematical operations including vector operations or calculus on a time axis, detailed description thereof will be omitted. Here, the kinematic information may be internally calculated in the sensor device 1300, or may be calculated in the server 1500 that receives information from the sensor device 1300. The kinematic information may be directly calculated by the sensing module inside the sensor device 1300, or may be calculated by a controller of the sensor device 1300, based on a detection result of the sensing module.

### Sensor Device

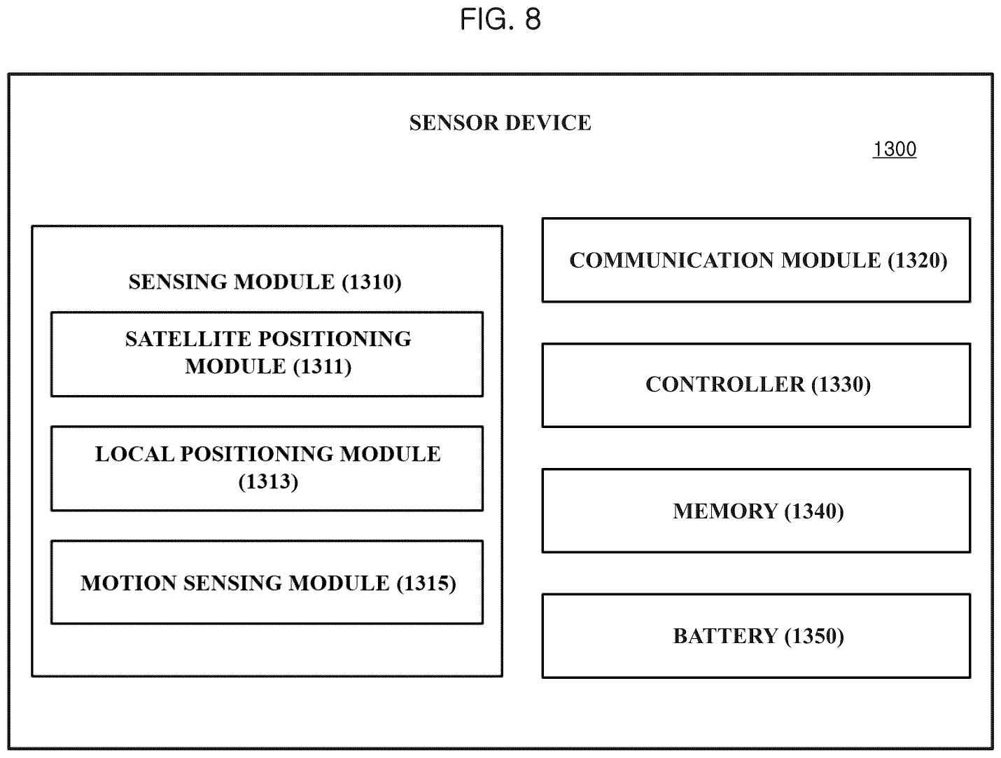

FIG. 8 is a block diagram of the sensor device which may be used to acquire the sensor based locational information according to one embodiment of the present disclosure.

As shown in FIG. 8, the sensor device 1300 according to one embodiment of the present disclosure may include a sensing module 1310, a communication module 1320, a controller 1330, a memory 1340, and a battery 1350.

The sensing module 1310 may detect various signals for acquiring activity information. The sensing module may be a positioning module or a motion sensing module.

The positioning module may be a satellite positioning module 1311 or a local positioning module 1313. The satellite positioning module 1311 may perform positioning by using a global navigation satellite system, that is, the GNSS. Here, the GNSS may include a global positioning system (GPS), GLONASS, BeiDou, Galileo, and the like. Specifically, the global positioning module may include a satellite antenna that receives the satellite signals and a positioning processor that performs the positioning by using the received satellite signals. For example, the satellite positioning module may be a GPS module including the GPS antenna that receives the GPS signal and the GPS processor that performs the positioning by using the GPS signal. In this case, the sensor device 1300 may be operated as a GPS receiver, may receive the GPS signal from the satellite, and may acquire the latitude, the longitude, the altitude, the velocity, the azimuth, dilution of precision (DOF), and time from the GPS signal.

The local positioning module 1313 may perform the positioning in collaboration with the sensor network. The sensor device 1300 including the local positioning module may be operated as the tag node of the local positioning sensor network to transmit and receive LPS signals to and from surrounding anchor nodes, and the positioning may be performed by using results of transmitting and receiving the LPS signals. For example, the sensor device 1300 may transmit the LPS signal as a transmitter of the sensor network for local positioning, and the anchor nodes may receive the LPS signals, or the anchor nodes may transmit the LPS signals, and the sensor device 1300 may receive the LPS signal as a receiver of the sensor network for local positioning. In this case, the LPS signal may be periodically broadcast according to a communication method such as the Ultra-Wide Band (UWB) communication, the Bluetooth, the Wi-Fi, and the RFID, and a time or a device identifier may be incorporated in the LPS signal. Position estimation may be performed based on measurement results according to the transmission and reception of the LPS signals. The Received Signal Strength (RSS) technique, the Time-of-Arrival (ToA) technique, the Time Difference-of-Arrival (TDoA) technique, the Angle-of-Arrival (AOA) technique, the triangulation technique, the hyperbolic triangulation technique, and the like may be used. Position estimation may be performed by a master of the sensor network, and any one of the tag node and the anchor node, or the server may function as the master of the sensor network. When the sensing platform additionally includes an RTK base station, the base station may be provided with a position estimation function of the master.

The motion sensing module 1315 may be referred to as a kinematic sensing module, and may detect a movement and/or a posture. Here, the motion sensing module 1315 may include an IMU module or an AHRS module. The IMU module and the AHRS module may include an accelerometer and a gyroscope, and sensors optionally including a magnetometer, and may measure the movement and the posture from detection results of the sensors.

Meanwhile, the above-described sensing modules do not necessarily have to be all equipped in one sensor device 1300, and a plurality of similar sensing modules may be provided in one sensor device 1300. The sensing modules provided in each sensor device 1300 may be different from each other. For example, the sensing platform may include the GPS sensor and the Inertial Measurement Unit (IMU) sensor to acquire locational information and movement information on the object 10, and may include two mutually different sensor devices 1300, one attached to the torso of the object 10 and the other attached to the wrist of the object 10.

The sensor device 1300 may transmit and receive data to and from an external device such as the server 1500 or another sensor device 1300 through the communication module 1320. The communication module 1320 may perform wired communication and/or wireless communication. The sensor device 1300 may transmit and receive data to and from an external device by using a wireless communication module that performs wireless communication of various standards such as a mobile communication network (for example, LTE, 5G, and the like), the Wi-Fi, the Bluetooth, Zigbee, and others. For example, the wireless communication module 1320 may transmit information acquired by the sensor device 1300 using the sensing module 1310 to the server 1500 on a real-time basis so that the system may monitor the object 10 by using activity information, or may transmit and receive data to and from the sensor devices 1300 when the plurality of sensor devices 1300 are attached to one object 10. In addition, the sensor device 1300 may transmit and receive data to and from an external device by using a wired communication module that performs universal serial bus (USB) communication or wired local area network (LAN) communication. For example, the wired communication module may collectively transmit data collected by the sensor device 1300 to the server 1500 or a docking station that performs charging and/or data management of the sensor device 1300.

The controller 1330 may control an overall operation of the sensor device 1300. The controller 1330 may be implemented as a hardware configuration, a software configuration, or a combination thereof. From a hardware viewpoint, the controller 1330 may be provided in various forms including an electronic circuit, an integrated circuit (IC), a microchip, and a processor that may perform operations or data processing. In addition, since a physical configuration of the controller 1330 is not necessarily limited to a single physical entity, the controller 1330 may be provided as a single processor that comprehensively processes all processing of the sensor device 1300, or as a plurality of processors that each perform different functions, or may be provided in a form combined with some of other components of the sensor device 1300. For example, the controller 1330 may be provided in a form including a GPS processor that processes GPS signals to perform positioning, an IMU processor that performs various operations by using results detected by the sensor of the IMU module, and a main processor that controls the operation and the overall operation of the sensor device 1300.

The memory 1340 may store various data associated with operations in the sensor device 1300. For example, the memory 1340 may store firmware that manages the operation of the sensor device 1300 or detection results of the sensors of the sensor device 1300. The memory 1340 may be provided as various volatile and non-volatile memories.

The battery 1350 may provide a power source required for driving the operation of sensor device 1300. The battery 1350 may be a built-in type or a detachable type, and may be charged by receiving power from an external power source.

### Video Based Sensing Platform

Hereinafter, a video based sensing platform will be described.

The video based sensing platform may include a camera 1200. The video based sensing platform may acquire various activity information through image processing and analysis of a videos captured by the camera 1200.

For example, for sports analysis applications, the camera 1200 may be arranged on or around a sports field to capture the video of the sports field or the object 10 moving inside the sports field. The camera 1200 may be installed semi-permanently (for example, installed in an auxiliary facility of the sports field), may be installed temporarily (installed in a movable pole), or may be arranged in a form of being carried by a photographer. The sports video captured by the camera 1200 may be tactical views, broadcast views, or player-focused views. The tactical view is a video generally used for sports tactical analysis, and may be a video captured so that most of the objects 10 are included in the video for team tactical analysis, and a horizontal axis of the tactical view may correspond to a length direction or a width direction of the stadium. The broadcast view is a video mainly used for sports broadcasting, may be generally captured at a smaller angle of view than the tactical view, and the player-focused view is a video captured along the specific object 10, and may be mainly used to analyze capability of the individual object 10.

The video based sensing platform may include one or more cameras. The cameras may be provided in a multi-camera form that enables panoramic image capturing at a single spot, may be provided in a distributed form across multiple spots, or may be provided in a combined form of the two.

The sensing platform may analyze the video captured by the camera 1200, and may acquire activity information therefrom. For example, the sensing platform may perform object recognition for the object 10 on the video, may extract the location (for example, pixel coordinates) of the object 10 within the video, may project the location within the video onto the ground by using posture information of the camera 1200, and may acquire the locational information on the object 10. Here, a deep learning algorithm may be used for video processing such as object detection. Specifically, for the object detection (for example, detecting the object 10), various deep learning algorithms for the object detection which range from Area based Convolutional Neural Network (R-CNN) to You-Only-Look-Once (YOLO) may be used. For coordinate transformation, top-view transformation using camera parameters (for example, installation locations, image capturing postures, and the like) may be used. For example, the server 1500 may acquire a sports video from the camera 1200 arranged to capture the tactical view, may acquire a bounding box for a sports object such as a ball or the object 10 in the sports video through an artificial neural network model that performs the object detection, may determine a representative pixel (for example, the bottom center of the bounding box) for the sports object by considering the bounding box, may perform the top-view transformation by using a coordinate transformation metric between the pixel coordinate system and the reference coordinate system within the sports video generated by considering the camera parameters for the determined representative pixel, and may acquire location data for the sports object. Here, the object detection using the artificial neural network may be replaced with object segmentation. Accordingly, the server 1500 may acquire location data for the sports object within the sports video captured by the camera 1200 through image analysis.

As described above, when needed, the sensing platform 1100 may optionally further include a base station for RTK correction and an anchor node for building a local positioning sensor network.

In addition, some of various operations performed in the sensing platform 1100 may be processed in the processor or the controller mounted on the sensor device 1300, but other operations may be processed in the server 1500. For example, the object detection for the video may be processed by the server 1500, the position estimation using the results of transmitting and receiving the LPS signals between the respective nodes in the local positioning sensor network may be processed by the server 1500, and various processing associated with the video analysis may be processed by the server 1500. Accordingly, in this case, it may be understood that the server 1500 is included in the sensing platform 1100.

### Server

The server 1500 may be configured to receive the locational information from the sensing platform 1100, to acquire the locational information in collaboration with the sensing platform 1100, and to track the trajectory of the object by using the locational information.

The server 1500 may be provided as a local server located near the sports field and/or as a web server connected via a web. In addition, the server 1500 does not necessarily have to be implemented as a single entity. For example, the web server may be implemented by including a main server that processes operations and a data server that stores various data. Meanwhile, the local server may be provided as an independently operated device that performs only original functions of the server, but may also be provided as a device having a composite function combined with other components of an exercise load information provision system. For example, the server may be provided in a form of a docking station that is a container for accommodating, storing, and managing the sensor device 1300. Here, the docking station may have an internal space that accommodates many sensor devices 1300, including a docking unit that accommodates the sensor device 1300, and may store the sensor device 1300 when the sensor device 1300 is not in use. Furthermore, the docking station may provide various convenient functions required for using the sensor device 1300 in addition to simply storing the sensor device 1300. For example, the docking station may perform functions such as charging the sensor device 1300, displaying a battery state, updating firmware, and collecting data.

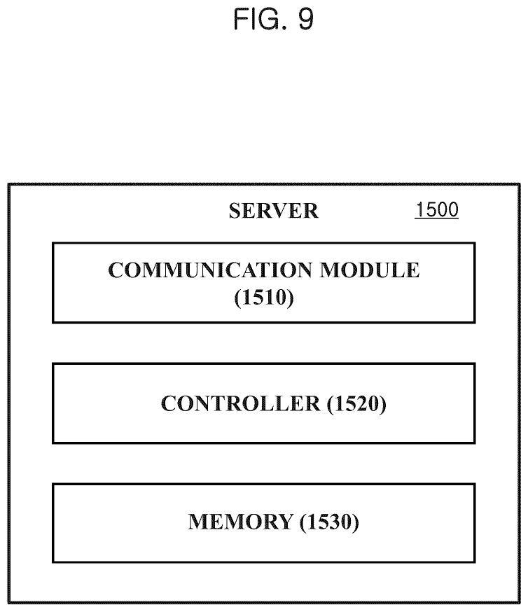

FIG. 9 is a block diagram of the server according to the embodiment of the present invention.

The server 1500 may include a communication module 1510, a controller 1520, and a memory 1530.

The communication module 1510 may perform data transmission and reception between the server 1500 and other components of the object tracking system or external devices. For example, through the communication module 1510, the server 1500 may collect data from the sensor device 1300, may receive the video from the camera 1200, or may transmit various information to the terminal 1700 via the web.

The controller 1520 may control the overall operation of the server 1500. As in the controller of the sensor device 1300, the controller 1520 of the server may be implemented by a hardware configuration, a software configuration, or a combination thereof. From a hardware viewpoint, the controller may be provided in various forms including an electronic circuit, an integrated circuit (IC), a microchip, a processor, and other forms and performing operations or data processing. The physical configuration is not necessarily limited to a single physical entity. Meanwhile, specific operations performed by the server 1500 will be described later, and it should be understood in advance that methods or the operations according to the embodiment of the present disclosure described later are performed by the controller 1520 of the server unless otherwise stated.

However, as described in the present disclosure, the embodiments according to the present disclosure are not necessarily limited to a case performed by the controller 1520 of the server, and it should be understood that the embodiments according to the present disclosure may be performed by an operable processor, such as the controller 1330 of the sensor device 1300, or at least some of the procedures may be performed by the server and at least some other procedures may be performed by another processor.

### Terminal

The terminal (or terminal device) 1700 may function as a user interface that provides various data or information collected or calculated by the system to a user or receives a user input from the user. For example, the terminal 1700 may receive a user input instructing a specific target time interval in which the user wants to know the tracked trajectories of objects, may request the server 1500 for information on the trajectory of the object during the corresponding time interval, may receive a response to the request, may display the response, and may provide the user with the information on the object trajectory. The terminal 1700 may be a smart device such as a smart phone and a tablet, a personal computer such as a laptop and a desktop, or any other electronic device having an input interface such as an output interface and a display for receiving the user input.

### Acquisition of Image Based Locational Information and Sensor Based Locational Information

Hereinafter, an object tracking procedure using the image based locational information and the sensor based locational information according to an embodiment of the present disclosure will be described. In the following description, the object tracking procedure may be described as an example performed by the object tracking system 1000 described above, but the example is only for convenience of description, and the procedures are not limited by the system.

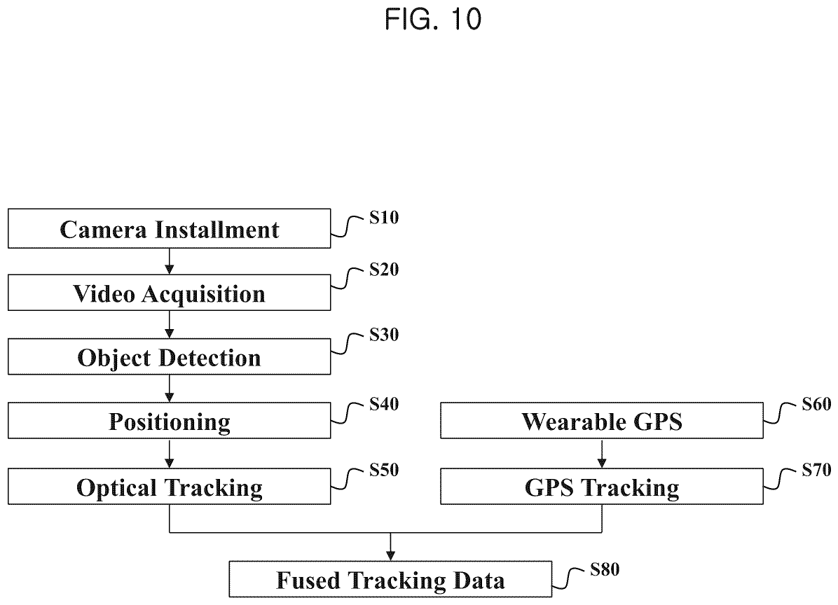

FIG. 10 schematically shows procedures for acquiring the image based locational information and the sensor based locational information and for acquiring integrated tracking data according to one embodiment of the present disclosure. The object tracking procedure according to the embodiments of the present disclosure may include a procedure for acquiring the image based locational information and a procedure for acquiring the sensor based locational information.

As shown in FIG. 10, the procedure for acquiring the image based locational information may include camera installation (Step 10), video acquisition (Step 20), object detection (Step 30), object location determination (Step 40), and optical tracking (Step 50). For example, the procedure for acquiring the sensor based locational information may include preparing the GPS sensor such as a wearable GPS (Step 60), and GPS tracking (Step 70). When the OTS based tracking information and the GPS based tracking information are acquired, integrated tracking data may be acquired, based on the tracking information (Step 80).

For example, the image based locational information may be acquired by the image based sensing platform of the object tracking system 1000 according to one aspect of the present disclosure as described above.

Hereinafter, the procedure for acquiring the image based locational information will be described in more detail, but not exclusively. As shown in FIG. 10, a camera for acquiring video data (Step 10) may be first installed. In order to secure proper video data, various factors may be considered for the installation of the camera. For example, in order to acquire the video including the object, the camera may be installed to secure a field of view larger than a predetermined angle with a predetermined plane where the object is located, and may be arranged so that no obstacle is located between the camera and the object. Meanwhile, as means for solving occlusion which may be a problem in acquiring the image based locational information, the camera may be installed in a plurality of places. However, in view of costs or installation constraints, the camera may be installed in a predetermined single spot. Even when the camera is installed in the single place, a plurality of cameras including double, triple, or more cameras may be used in view of various factors including the angle of view of the camera. In this case, a single panoramic image may be acquired through stitching of videos from the plurality of cameras. Hereinafter, the procedure for acquiring the image based locational information will be described in more detail by using an example in which the panoramic image is secured by utilizing the plurality of cameras at the single location.

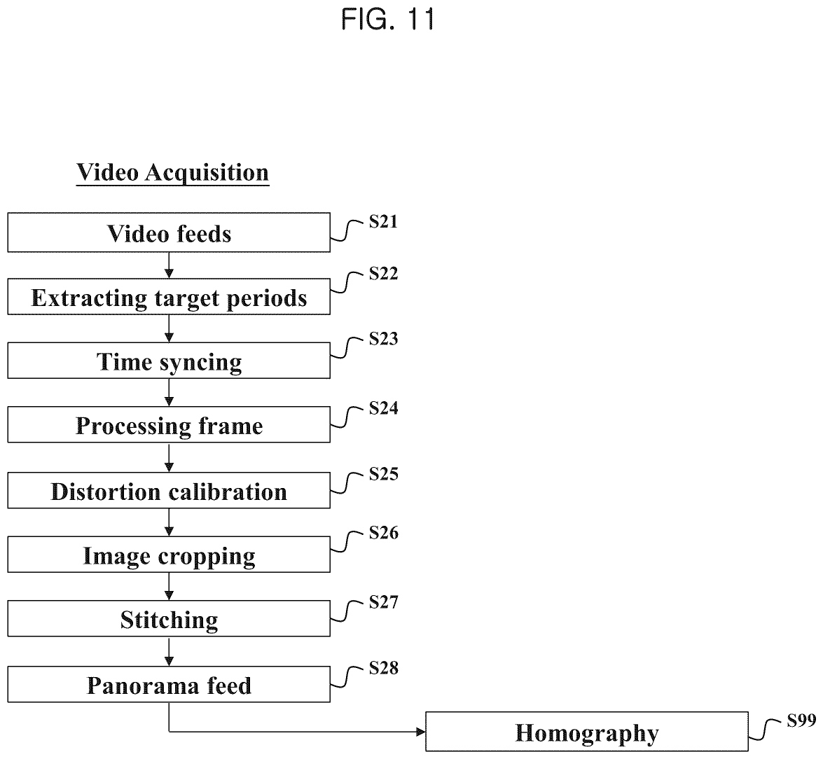

Referring again to FIG. 10, the video may be acquired, based on the installed camera (Step 20). FIG. 11 shows the image acquisition procedure in FIG. 10 in more detail.

As shown in FIG. 11, the object tracking system 1000 may receive video feed from the camera (Step 21).

The target time interval for tracking the trajectory of the object may be extracted from the received video feed (Step 22). According to one aspect, the target time interval may be extracted by utilizing an internal clock.

As described above, when the plurality of cameras are installed and the video feed from the plurality of cameras is performed to extract video data for the target time interval, times may not be synchronized with each other between respective video data. Therefore, a synchronization procedure between the video data for the target time interval extracted from the plurality of cameras may be performed (Step 23).

This procedure may utilize any mechanism of the known mechanisms, such as utilizing an internal clock for synchronization or utilizing a detection start point of a specific event. Even when synchronized video data for the same time interval is secured, in some cases, one or more frames may be missed, or two or more duplicate frames exist in the video data from a specific camera due to factors such as an error in a hardware operation or an error in data transmission. Therefore, the object tracking system 1000 may delete one or more of the duplicate frames, or may copy information on adjacent frame for the missing frames through frame processing (Step 24).

Next, the object tracking system 1000 may perform distortion calibration (Step 25). Image data acquired through the camera may include a distortion of the image data due to distortion of a lens, or a distortion due to a change in the pose (for example, angle) of the camera, a distance from the camera, or a high zoom level. Accordingly, the object tracking system 1000 may perform a procedure for correcting the distortion of the image data.

Next, the object tracking system 1000 may perform image cropping (Step 26). When a plurality of images are secured from a plurality of cameras, an overlapping area between the respective images may be required to be maintained at a proper level for stitching the images. Accordingly, an image cropping procedure may be performed to cut out unnecessary portions of the secured images so that the overlapping area for image stitching may be properly controlled.

Thereafter, the object tracking system 1000 may perform stitching on the plurality of images (Step 27). That is, the plurality of images may be merged to secure a single panoramic feed (Step 28). For example, the images included in this panoramic feed may be images including the entire stadium. According to one aspect, a procedure for adjusting the distortion occurring in the image stitching procedure may be further performed. Even when the best stitching procedure is performed, distortions such as refraction phenomena based on a predetermined spot may exist in the acquired panoramic image due to various causes such as camera installation angle errors. Therefore, the object tracking system 1000 may further perform a procedure for adjusting the distortion due to stitching on the images of the acquired panoramic feed.

Meanwhile, the image based locational information may be acquired by converting coordinates of the detected object in the acquired image into location coordinates by utilizing homography information of the camera. For example, in a case of determining a location of a player in a stadium, a relationship between a pixel position in the acquired image and the location of the object in the stadium may vary depending on an installation position of the camera and an angle with respect to the stadium. The camera homography information of the panoramic image based on the above-described stitching of the plurality of image may be different from the homography information of each of the plurality of cameras. Therefore, the object tracking system 1000 may acquire the homography information for the generated panoramic image (Step 99). In order to acquire the homography information, for example, pixel position information may be used in the image of a plurality of reference points whose positions in stadium coordinates are known, such as corners of a penalty box, corners of a goal area, corner points, and a center point.

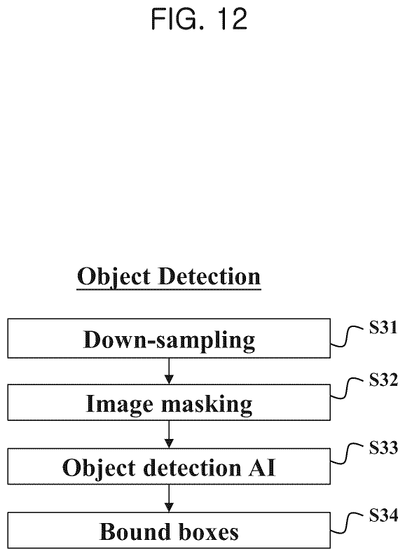

Referring again to FIG. 10, the object tracking system 1000 may detect the object from the acquired image data (Step 30). FIG. 12 shows the object detection procedure in FIG. 10 in more detail.

As shown in FIG. 12, the object tracking system 1000 may optionally perform down-sampling (Step 31) on the acquired image data. For example, when images from two cameras that acquire 4K images are stitched with each other, the acquired panoramic image may be an image of 6K to 7K. Performing the object detection procedure on the images including such a large number of pixels for each frame may consume excessive operational resources and time. Therefore, the object tracking system 1000 may perform the down-sampling on the acquired image to a resolution of FHD quality, for example.

Meanwhile, for example, in tracking players in the team sports, the tracking target objects may exist inside the stadium, and spectators or staff members who are not the tracking targets may be located outside the stadium. Therefore, in order to more easily detect the objects, a necessary portion may be excluded from the image secured through the camera, and the remaining portion may be blanked. That is, the object tracking system 1000 may perform masking on the image data (Step 32).

Next, for example, the object tracking system 1000 may perform the object detection by using the artificial neural network (Step 33). As described above, a deep learning algorithm may be used for image processing for the object detection from the images. Specifically, various deep learning algorithms for the object detection ranging from the Area based Convolutional Neural Network (R-CNN) to the You-Only-Look-Once (YOLO) may be used for the object detection. However, the present invention is not limited thereto, and it should be understood that any algorithm or any artificial neural network model for detecting the object from the images may be applied.

When the object detection procedure for the images is completed, detection areas including the detected objects may be secured (Step 34). For example, the detection area may be a rectangular bounding box (B-box) including the object.

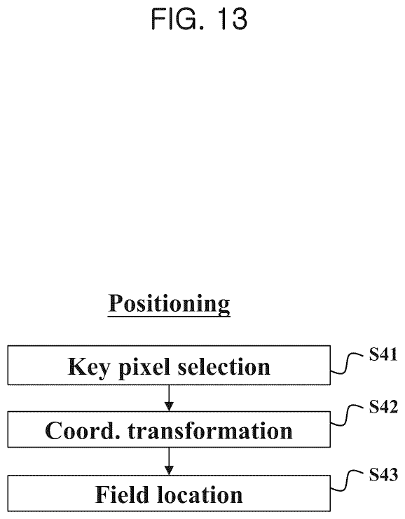

Referring again to FIG. 10, the object tracking system 1000 may determine the location of the object detected from the images (Step 40). FIG. 13 shows the location determination procedure in FIG. 10 in more detail.

As shown in FIG. 13, the object tracking system 1000 may select a key pixel used to determine the location of the object (Step 41). For example, since the detection area of the object, such as the bounding box, has a predetermined size, it has to be determined whether any pixel in the pixels included in the detection area is selected as the location of the object within the image. As described above, since the location within the field coordinate system determined through the homography based coordinate conversion is determined depending on the pixel position within the image, whether any pixel within the detection area is selected as the key pixel has a very important influence on accuracy in determining the location of the object.

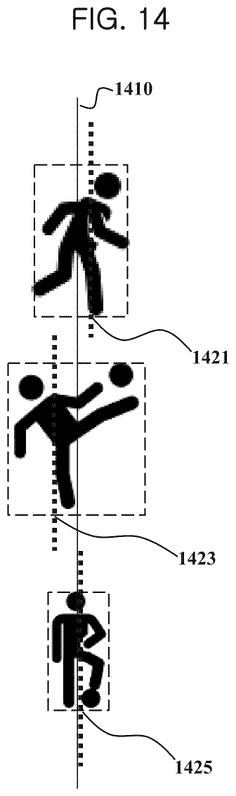

In this regard, FIG. 14 shows a position error according to key pixel determination criteria. As shown in FIG. 14, most fundamentally, a bottom center spot of the bounding box, which may be determined by referring to a center line 1410 for the bounding box, may be determined as the key pixel.

In determining coordinates in an up-down direction within the bounding box of the key pixel, a bottom of the bounding box where the feet of the object may be located may be considered for example, in view of convenience of transformation according to the homography. In determining a position in a left-right direction within the bounding box of the key pixel, the center position may be adopted to simplify the operation without requiring an additional processing procedure. Accordingly, the bottom center spot of the bounding box may be adopted as an exemplary key pixel.

However, the center spot of the bottom of the bounding box may be a point that does not faithfully reflect the location of the object. In a case of the top object in FIG. 14, as indicated by a first position line 1421, it may be determined as more accurate to consider that the location of the object is a point slightly moved to the right side from the center. In a case of the middle object in FIG. 14, as indicated by a second position line 1423, it may be determined as more accurate to consider that the location of the object is a point slightly moved to the left side from the center. In a case of the bottom object in FIG. 14, the object adopts a relatively static posture, and there may be no great difference between the location of the bottom center of the bounding box and a third position line 1425 indicating an exact location of an actual object. In this way, depending on the posture of the object, the locations representing the location of the object within the bounding box may be different from each other, and determining the bottom center point of the bounding box as the key pixel according to standardized criteria may reduce the accuracy in the object location determination.

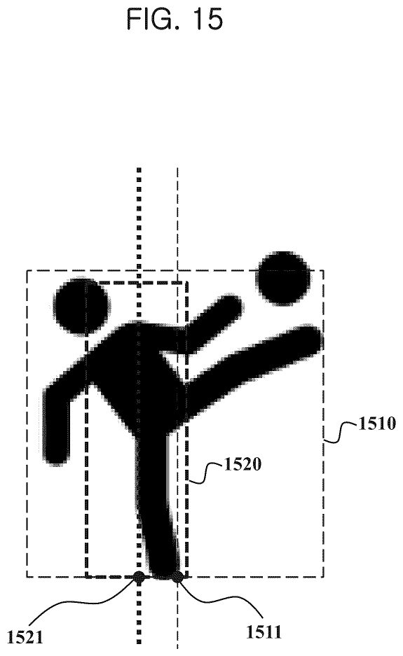

FIG. 15 shows a change in the determination location according to a change in the key pixel determination criteria. As shown in FIG. 15, the key pixel determination criteria are established to reflect a change in the pose of the object. In this manner, key pixel selection that more accurately reflects the location of the object may be performed. The change in the key pixel criteria may be achieved by changing a condition for determining the key pixel within the same bounding box. Alternatively, for example, as shown in FIG. 15, the change in the key pixel criteria may be achieved by changing the settings of the bounding box while maintaining the criteria of the bottom center spot of the bounding box. As shown in FIG. 15, when a first bounding box 1510 having a size that completely includes the object is acquired according to general settings, in a case where a bottom center spot 1511 of the first bounding box is determined as the key pixel, a point that is somewhat different from the actual location of the object may be determined as the key pixel. On the other hand, when a second bounding box 1520 having the width in the left-right direction which includes only the torso portion of the object is acquired, in a case where a bottom center point 1521 of the second bounding box is determined as the key pixel, it may be possible to select the key pixel with improved accuracy. That is, the key pixel may more excellently reflect the object location by properly controlling the size of the bounding box.

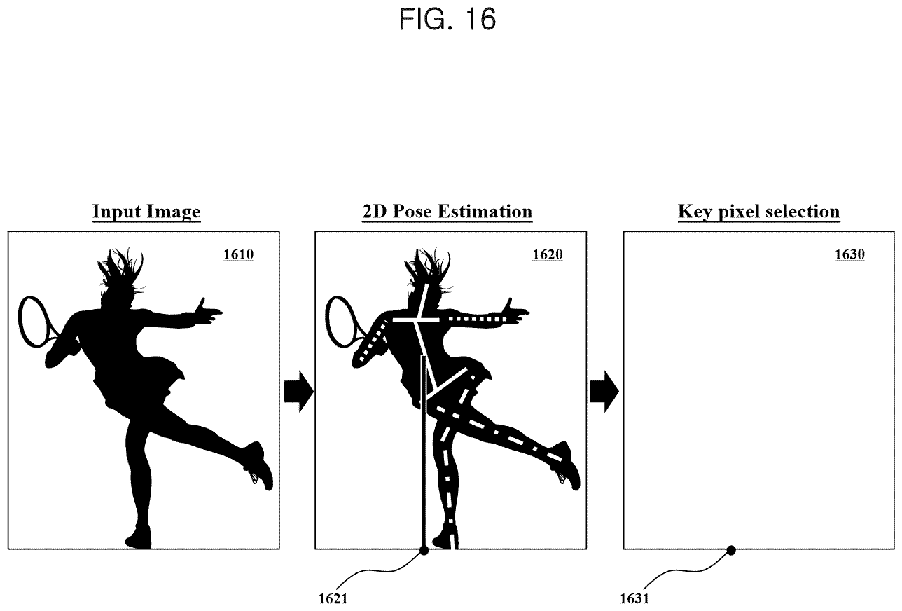

FIG. 16 shows an example of the key pixel determination using pose estimation. As shown in FIG. 16, for more accurate key pixel selection, the object tracking system 1000 may be configured to estimate the pose of the object included in the image and to select the key pixel, based on the estimated pose. The object may be detected from an input image 1610 to secure image data for a detection area including the object. A two-dimensional pose estimation process 1620 may be applied to the detection area image data. A technology for estimating a specific pose of the object by analyzing a captured image has been proposed for various applications in the motion analysis field. For example, a technology for estimating the pose by dividing a portion of the detected object into joint units as shown in FIG. 16 may be employed as an example. For example, the object tracking system 1000 may determine the bottom point of the detection area corresponding to the center spot of the torso portion in a partial area of the divided object as the key pixel of the detection area. That is, a key pixel determination result 1630 and a point 1631 may be the key pixels.

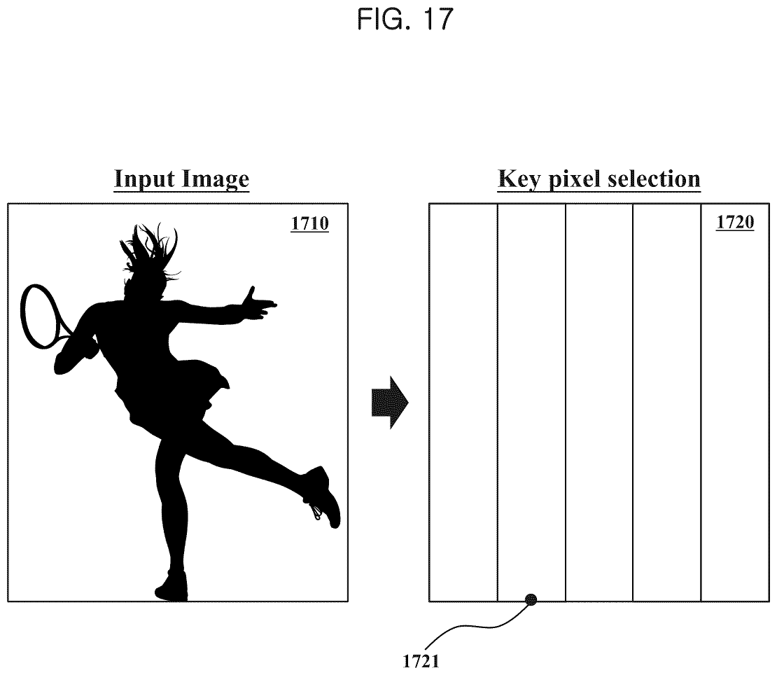

Determining any one of all pixels belonging to the bottom of the detection area as the key pixel may excessively increase complexity of the operation. FIG. 17 shows an example of determining the key pixel according to area division. As shown in FIG. 17, when detection area image data 1710 is secured as an input image for the detected object, the object tracking system 1000 may divide the detection area into a plurality of areas in the left-right direction, and may select any one of the divided areas to select the bottom center point of the selected area as the key pixel. As shown in an example 1720 of selecting the key pixel in FIG. 17, for example, the detection area may be divided into five equal areas in the left-right direction, and the divided area corresponding to an input image 1710 may be determined as a second area from the left side. Accordingly, a bottom center point 1721 in the second area from the left side may be selected as the key pixel.

Meanwhile, since a single frame of the video data may include multiple detection areas, when additional data processing, such as the pose estimation, for each detection area may excessively reduce operational efficiency. Therefore, according to one aspect, the object tracking system 1000 may apply a simplified key pixel determination procedure, for example, such as selecting the bottom center point of the detection area as the key pixel, to the detection area having the width smaller than a threshold length in the left-right direction, and may apply a specific key pixel determination procedure, such as using the pose estimation, to the detection area having the width equal to or larger than the threshold length in the left-right direction. In addition, according to one aspect, it may be determined whether to perform the specific key pixel determination procedure based on the height-to-width ratio of the detection area. That is, when a ratio of the width to the height of the detection area is lower than a threshold ratio, the simplified key pixel determination procedure may be applied, and when the ratio is equal to or higher than the threshold ratio, the specific key pixel determination procedure may be applied.

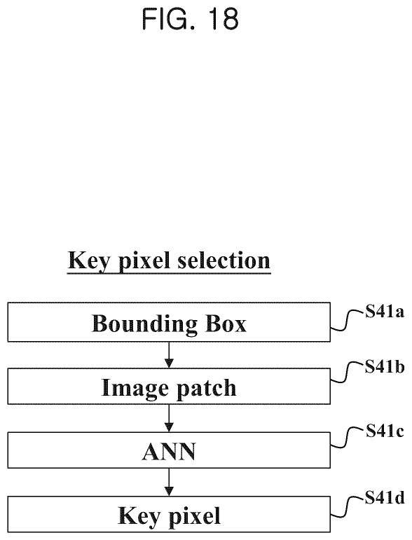

In addition, according to one aspect, key pixel selection for the detection area may be performed by using the artificial neural network. FIG. 18 shows the key pixel determination using the artificial neural network.

As shown in FIG. 18, the object tracking system 1000 may acquire the detection area according to the object detection procedure (Step 41a), and may secure an image patch therefrom (Step 41b). That is, image data for the detection area may be secured. Thereafter, the object tracking system 1000 may input the image patch into a trained artificial neural network (ANN) (Step 41c), and may receive an output of a key pixel value (Step 41d). Therefore, the key pixel may be determined simply by quickly inputting the image patch without a complex operational procedure.

Here, learning data for training the artificial neural network may be secured by labeling the image patch for the plurality of detection areas with corresponding key pixel value. In order to determine the corresponding key pixel values, for example, a pose estimation algorithm may be utilized as described above, but the present invention is not limited thereto. It should be understood that any algorithm for performing accurate key pixel selection may be utilized.

Referring again to FIG. 13, the object tracking system 1000 may perform coordinate transformation, based on the determined key pixel (Step 42), and may determine the location of the object in field coordinates (Step 43). For example, the coordinate transformation may be performed by using the camera homography information described above.

Referring again to FIG. 10, the object tracking system 1000 may acquire object tracking information using the image based locational information by tracking the object, based on the locational information determined for each frame of the video feed (Step 50). Hereinafter, in the present disclosure, information on the trajectory of the object acquired by using the image based locational information may be referred to as image based trajectory information.

Next, the procedure for acquiring the sensor based locational information will be described in detail, but not exclusively. For example, the sensor based locational information may be acquired by the sensor based sensing platform of the object tracking system 1000 according to one aspect of the present disclosure as described above.

As shown in FIG. 10, for example, the object tracking system 1000 may prepare a GPS sensor, such as a wearable GPS (Step 60), and may receive the locational information from the GPS sensor. Thereafter, the object tracking system 1000 may collect time series data of the locational information from the GPS sensor during a target time interval, and may perform GPS tracking (Step 70). Accordingly, information on the trajectory of the object using the sensor based locational information may be secured. Hereinafter, in the present disclosure, the information on the trajectory of the object using the sensor based locational information may also be referred to as sensor based trajectory information.

Referring again to FIG. 10, the object tracking system 1000 may acquire integrated tracking data using the sensor based locational information and the image based locational information by using the acquired sensor based locational information and the acquired image based locational information. The object tracking system 1000 according to the embodiments of the present disclosure may be configured to track the trajectory of the object by using the integrated tracking data.

### Overview of Object Tracking

Hereinafter, a procedure for tracking the trajectory of the object during the target time interval, based on the image based locational information and the sensor based locational information according to embodiments of the present disclosure will be described.

As described above, the image based locational information and the sensor based locational information each have advantages and disadvantages. According to the embodiments of the present disclosure, cost-efficient and bias-robust object tracking may be performed by utilizing both the information. When it is considered that the object tracking using the image based locational information shows higher accuracy in terms of location accuracy for frames satisfying proper conditions, one embodiment of the present disclosure may selectively filter and use the locational information acquired from the detection area, such as a bounding box detected from the image. In addition, in one embodiment of the present disclosure, identification information may be assigned to each of the objects detected from the image based locational information by performing minimum cost matching between the trajectory using the image based locational information and the trajectory using the sensor based locational information. According to one aspect, a bias existing in the sensor based locational information or the sensor based trajectory may be measured and removed by using a matched pair of the image based trajectory and the sensor based trajectory. According to the embodiments of the present disclosure, even when a very small number of fixed cameras located at a single point is used, it is possible to provide an object estimation procedure which shows more reliable and robust tracking performance. Accordingly, it is possible to provide object tracking performance which is improved in terms of both stability and accuracy, compared to a case of using any one information.

The embodiments of the present disclosure are provided to more accurately and reliably track the trajectory of the object by using the image based locational information and the sensor based locational information. According to one aspect, the trajectory of the object may be tracked by using the image based locational information for a specific time interval, based on the reliability of the image based locational information, and the trajectory of the object may be tracked by using the sensor based locational information for the remaining time interval. According to another aspect, the accuracy of the object trajectory tracking using the sensor based locational information may be improved by determining and removing a bias which is an error value existing in the sensor based locational information, by using the image based locational information.

In this regard, the image based locational information acquired through the video from the camera may not include information on which object is tracked in the detection area and whether the detection area properly reflects an area occupied by a specific object. Accordingly, the object tracking system 1000 may determine a confidence interval in which the detection area for the same object may be stably tracked in consecutive frames. Hereinafter, in the present disclosure, ‘the confidence interval’ may also be referred to as an ‘anchor segment’. Thereafter, the object tracking system 1000 may assign object identification information (ID) to each of the objects detected from the image based locational information by matching sequences of the detection areas detected from the image based locational information during the confidence interval, that is, the image based trajectories, with the sensor based trajectories. The image based trajectories having the object identification information may be used to track the trajectory of the object may be tracked, or to determine and remove a bias which is an error value existing in the sensor based trajectory, based on the image based trajectory during the confidence interval, and based on the sensor based trajectory during the non-confidence interval. In this manner, the trajectory of the object may be tracked, based on a corrected sensor based trajectory.

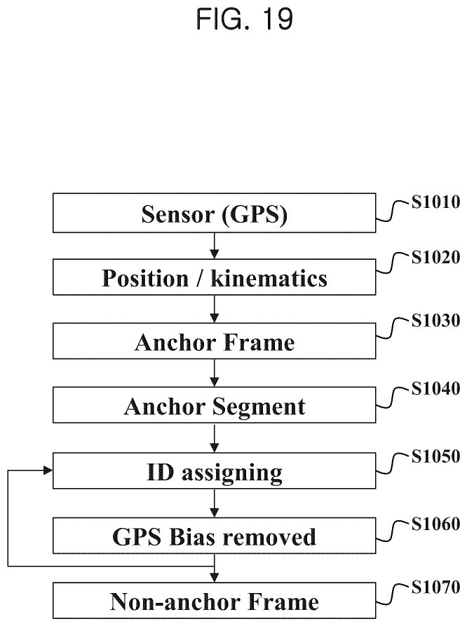

FIG. 19 is a schematic flowchart of an object tracking method using the image based locational information and the sensor based locational information according to one embodiment of the present disclosure. Hereinafter, the object tracking method according to the embodiments of the present disclosure will be described in more detail with reference to FIG. 19, but not exclusively. Hereinafter, although the method according to the embodiment may be described as an example performed by the object tracking system 1000 described above, this example is merely for convenience of description. Therefore, the procedures are not limited by the system, and it should be understood that the method according to the embodiment of the present disclosure may be performed by any computing device having a processor and a memory.

First, for example, the object tracking system 1000 may acquire data on locational information according to a procedure for acquiring the image based locational information and a procedure for acquiring the sensor based locational information as described above.

As shown in FIG. 19, the object tracking system 1000 may receive a signal from the sensor device such as the GPS (Step 1010), and may acquire the locational information and/or kinematic information (Step 1020). In order to determine the locational information, the object tracking system 1000 may utilize any mechanism such as trilateration in a plurality of positioning mechanisms. In addition, the kinematic information may include information such as the speed, acceleration/deceleration, and total movement distance, and may be determined by using the Doppler effect of GPS signals, for example. Empirically, it is known that the image based locational information has higher accuracy in the locational information. In contrast, the sensor based locational information has higher accuracy in the displacement based information such as the speed and the acceleration/deceleration.

Referring again to FIG. 19, the object tracking system 1000 may determine the confidence interval in which the detection area for the same object may be reliably tracked in consecutive frames in a plurality of frames included in the image based locational information.

More specifically, as shown in FIG. 19, the object tracking system 1000 may first determine the confidence frame (Step 1030). Hereinafter, in the present disclosure, ‘the confidence frame’ may also be referred to as an ‘anchor frame’.

For example, the confidence frame which is at least one frame in the frames of the video data associated with the image based locational information may refer to a frame in which each detection area included in the frame properly indicates a location of an actual object and all objects existing in an interest area may be detected as the detection areas. For each frame t, matching may be performed between interest areas {XB(t)={xB1(t), . . . , xBmt(t)} detected from the image and respective coordinates XG(t)={xG1(t), . . . , xGn(t)} of objects p1, . . . , pn according to the sensor based locational information (for example, the GPS). For example, this matching may be performed by the Hungarian algorithm in which the sum of the Euclidean distances of each pair is set as the assignment cost. Here, mt may represent the number of the detection areas detected in the frame t, and may vary for each frame according to each time. According to one aspect, for example, the object tracking system 1000 may determine the frame t as the confidence frame, when the following conditions are satisfied.

(i) The number of actual objects including objects measured by the GPS and objects which are not measured (for example, referees or coaching staff) and the number of detection areas which are detected are equal. That is, when it is assumed that the number nU of objects which are not measured is a constant, mt=n+nU=:m

(ii) Objects are located at a certain distance from each other to ensure that each of all object is detected by its own detection area by preventing potential occlusion. That is, a minimum value of the Euclidean distances for pairs between objects are equal to or greater than a specific threshold value d0.

(iii) It is expected that all objects may be detected by the detection area since the maximum assignment cost in the matched pairs does not exceed a threshold cost c0.

As a result, the object tracking system 1000 may classify confidence frames al, . . . , aK. Here, each ak which is 1≤k≤K satisfies the condition that every xGi(ak) is assigned to a unique detection area xOi(ak)∈XB(ak). In other words, permutation (xO1(ak), . . . , xOm(ak)) of detection areas {XB1(t), . . . , XBm(t)} may be found by performing the minimum cost matching with (xG1(ak), . . . , xGn(ak)). The unmatched detection areas are set to (xOn+1(ak), . . . , xOm(ak)).

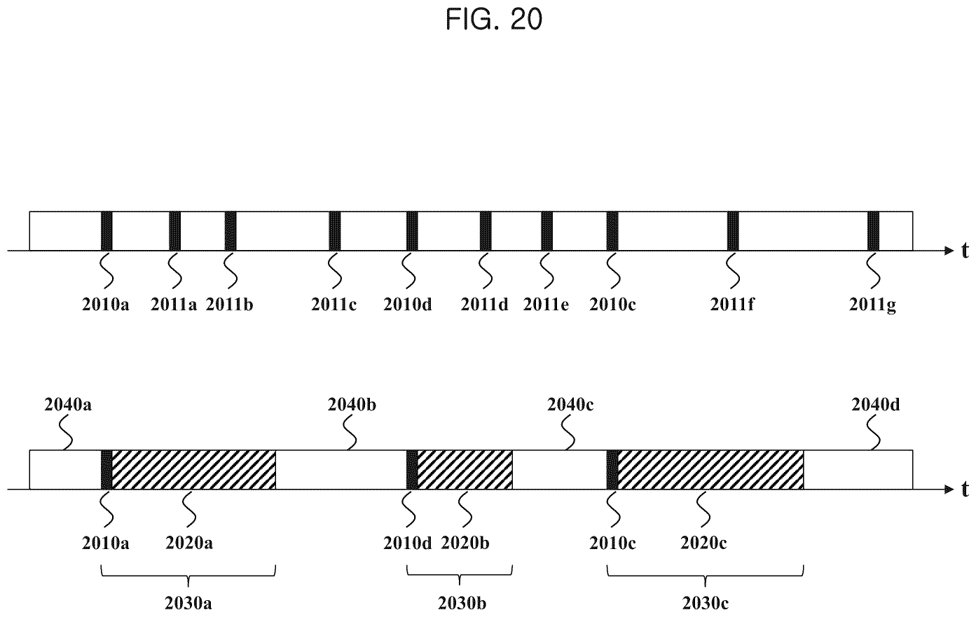

For example, as shown in FIG. 20, the target time interval may include a plurality of confidence frames 2010a, 2010b, 2010b, 2011a, 2011b, 2011c, 2011d, 2011e, 2011f, and 2011g.

Referring again to FIG. 19, the object tracking system 1000 may determine the confidence interval (Step 1040). Hereinafter, in the present disclosure, ‘the confidence interval’ may also be referred to as an ‘anchor segment’.

In the confidence frame, there is a one-to-one correspondence between the detection areas and the actual objects within the interest area. However, a measurement value of the GPS may have a bias. Accordingly, the bias may cause ID switches where identification information is switched with mutually different objects during the assignment in the confidence frame determination step. Therefore, it may not be confirmed whether a detection area xOi(t) matched with xGi(t) above represents the location of a proper object pi. In order to solve this potential intersection problem, the object tracking system 1000 may perform the minimum cost matching again as will be described below, but the minimum cost matching may be matching between trajectories rather than matching between single spots acquired from the GPS and the detection areas. For this purpose, it is necessary to calculate the image based trajectories, each of which includes a sequence of the detection areas for tracking a unique object within the image. For example, in the sports analysis, it is nearly impossible to acquire stable image based trajectories which persist for a time period of the entire game, when it is considered that detection areas of false positive errors and/or false negative errors are arranged. Therefore, the object tracking system 1000 may determine the confidence interval of the image based locational information, which is a well-conditioned time interval during which the algorithm may reliably acquire the image based trajectories.

In order to acquire confidence intervals Tk={ak, ak+Δt, . . . , ak+lkΔt} and image based trajectories xOi(Tk)={xOi(t)∈XB(t):t∈Tk}, the object tracking system 1000 may start from each confidence frame ak, and may repeat the following procedure for the subsequent frames.

(a) For the current frame at time t, determine the minimum-cost matching between image-based coordinates xO1(t), . . . , xOmt(t) and detection areas xB1 (t+Δt), . . . , xBmt+Δt (t+Δt) of the next frame. Note that image-based coordinates xO1(ak), . . . , xOm(ak) in the confidence frame ak are defined in association with the confidence frame determination procedure (Step 1030).

(b) Confirm whether mt=mt+Δt is satisfied and whether the maximum assignment cost does not exceed a specified threshold value cl. When the condition is satisfied, add t+Δt to the current confidence interval {ak, ak+Δt, . . . , t}, and for each i in 1≤i≤mt, determine xOi(t+Δt) E xB(t+Δt) as the detection area coordinate assigned to xOi.

When the confidence interval starting from ak reaches the next confidence frame ak+1, Tk+1⊂Tk is satisfied. Therefore, the object tracking system 1000 may omit finding the confidence intervals of the confidence frames existing in the middle of other confidence intervals.

As described above, the object tracking system 1000 may acquire image based trajectories XO(Tk)={xO1(Tk), . . . , xOm(Tk)}. Here, each sequence xO1(Tk) in detection areas tracks a unique object in the image. Here, note that mt=m is satisfied for all t∈Tk. Due to the ID switches described above, the i-th image based trajectory may not indicate the object pi in the image. However, this problem may be resolved by the matching between the image based trajectories and the sensor based trajectories which are described below. Since excessively short trajectories are not robust to GPS biases, according to one aspect, the object tracking system 1000 may consider that the confidence interval Tk is valid only when the confidence interval Tk lasts at least 1.0 second.

For example, as shown in FIG. 20, the target time interval may include a plurality of confidence intervals 2030a, 2030b, and 2030c.

Referring again to FIG. 19, the object tracking system 1000 may assign identification information to each of the sensor based trajectories by matching the sensor based trajectories with the image based trajectories (Step 1050). According to one aspect, the matching may be performed for the confidence interval.

The GPS has a location bias that varies with the lapse of time, but may accurately track the movement or the displacement of the object. In other words, although the GPS bias for each frame may significantly exist, the GPS bias slowly varies along a time axis. Therefore, according to one aspect of the present disclosure, the object tracking system 1000 may perform the matching between the image based trajectory and the sensor based trajectory for assigning the identification information (ID), rather than simply executing the Hungarian algorithm independently for each frame as in the confidence frame determination step described above.

In particular, the object tracking system 1000 may perform the minimum cost matching between image based trajectories xO1(Tk), . . . , xOm(Tk) and sensor based trajectories xG1(Tk), . . . , xGn(Tk), for the valid confidence interval Tk having a duration of 1.0 second or longer, for example. In order to reduce the influence of the GPS bias, the Hungarian algorithm herein may use a “shape-weighted” assignment cost that matches trajectories having similar shapes without being just located close to each other. That is, the object tracking system 1000 according to one aspect may define a mean distance and a shape distance between a pair of trajectories, and may calculate the assignment cost by using a weighted sum of the distances of the two types.

More specifically, but not exclusively, the object tracking system 1000 may define a mean distance di,j(Tk) and a shape distance si,j(Tk) between pairs of trajectories xGi(Tk) and xOj(Tk) as follows.

$${d}_{i , j} ( {T}_{k} ) := ‖ {\overline{δ}}_{i , j} ( {T}_{k} ) ‖ , {s}_{i , j} ( {T}_{k} ) := \frac{1}{\vert {T}_{k} \vert} {\sum }_{t ∈ {T}_{k}}$$

$$‖ {δ}_{i , j} ( t ) - {\overline{δ}}_{i , j} ( {T}_{k} ) ‖$$

Here, the sequence of difference values is as follows.

$${δ}_{i , j} ( t ) := {x}_{i}^{G} ( t ) - {x}_{j}^{O} ( t )$$

An average of the differences is as follows.

$${\overline{δ}}_{i , j} ( {T}_{k} ) := \frac{1}{\vert {T}_{k} \vert} {\sum }_{t ∈ {T}_{k}} {δ}_{i , j} ( t )$$

Therefore, the object tracking system 1000 may define the shape-weighted assignment cost as follows.

$${c}_{i , j} ( {T}_{k} ) := {d}_{i , j} ( {T}_{k} ) + ω \cdot {s}_{i , j} ( {T}_{k} )$$

Here, a predetermined shape weight ω may be set to be greater than 1.

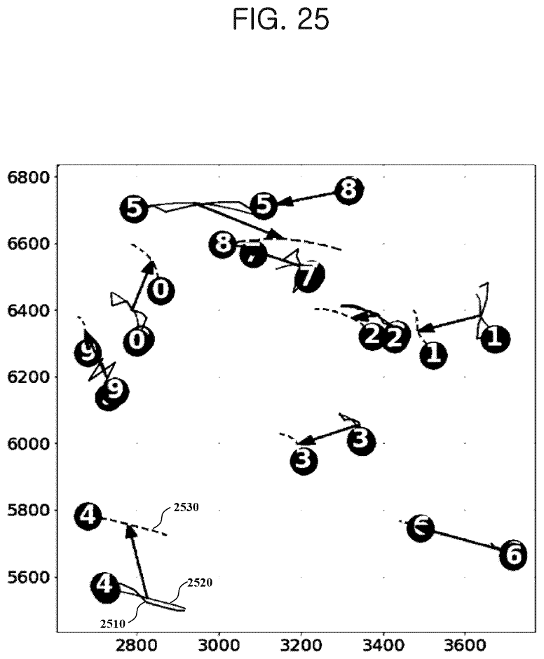

FIG. 25 shows the matching between exemplary image based trajectories and sensor based trajectories during the confidence interval. Here, a dotted curve 2530 represents the sensor based trajectory, and a bent curve 2510 represents the image based trajectory, respectively. A circle at the end of each curve represents an end of a path, and the number inside the circle may be an object ID. That is, the dotted curve having a number i represents x^{G}ᵢ(Tₖ), and the bent curve represents x^{O}ⱼ(Tₖ), respectively.

Referring to FIG. 25, each sensor based trajectory is well matched with the nearby image based trajectories having similar shapes. In particular, it appears that the ID switch occurs between objects p₅ and p₅ in the confidence frame determination step described above. According to one aspect of the present disclosure, it may be confirmed that the object tracking system 1000 corrects the ID switch by matching a sensor based trajectory x^{G}₅(aₖ) and an image based trajectory x^{O}₈(aₖ) to each other.

Referring again to FIG. 19, the object tracking system 1000 may optionally determine and remove a bias which is an error value existing in the sensor based trajectory, by using the image based trajectory, based on a pair of matched image based trajectories and sensor based trajectories (Step 1060).

Referring to FIG. 25, an arrow indicating each sensor based trajectory x^{G}ᵢ(Tk) represent an estimated bias δ̅_{i,σ(i)}(Tₖ), and a solid curve (for example, 2520) crossing a start point of the arrow represents a sensor based trajectory (hereinafter, may be referred to as x^{G*}ᵢ(Tₖ)) transformed by removing the bias from x^{G}ᵢ(Tₖ).

As shown in FIG. 25, the transformed sensor based trajectory is located very close to the corresponding image based trajectory, but shows physically more natural movements.

According to one aspect, the object tracking system 1000 may estimate a bias for the sensor based locational information or the sensor based trajectory of the object during the confidence interval by a mean distance between the image based trajectories and the sensor based trajectories which are matched with each other. For example, the bias for the sensor based locational information or the sensor based trajectory may be a GPS bias. Accordingly, the object tracking system 1000 may remove the estimated bias from the sensor based trajectory or the sensor based locational information to acquire a corrected sensor based locational information or a corrected sensor based trajectory.

Referring again to FIG. 19, the object tracking system 1000 may optionally perform a separate object tracking procedure during the non-confidence interval (Step 1070).

According to one aspect, the object tracking system 1000 may track the trajectory of the object by using the image based locational information during the confidence interval, and may track the trajectory of the object by using the sensor based locational information during the non-confidence interval.

In addition, according to one aspect, the object tracking system 1000 may track the location of the object, based on corrected sensor based locational information in which the bias is removed from the sensor based locational information during the non-confidence interval.

Here, for example, the bias of the sensor based locational information or trajectory during the non-confidence interval may be calculated by linear interpolation between the adjacent confidence intervals. In other words, the object tracking system 1000 may define an estimated GPS bias δᵢ: [symbol] → [symbol] of the object pᵢ over an entire tracking time [symbol] as follows.

$${δ}_{i} ( t ) := \{ \begin{matrix}{\overline{δ}}_{i , {σ}_{k} ( i )} ( {T}_{k} ) & if {a}_{k} \leq t \leq {b}_{k} , 1 \leq k \leq K , \\ {δ}_{i} ( {a}_{0} ) & if t < {a}_{0} , \\ {δ}_{i} ( {b}_{K} ) & if t > {b}_{K} , \\ \frac{{a}_{k + 1} - t}{{a}_{k + 1} - {b}_{k}} {δ}_{i} ( {b}_{k} ) + \frac{t - {b}_{k}}{{a}_{k + 1} - {b}_{k}} {δ}_{i} ( {a}_{k + 1} ) & if {b}_{k} < t < {a}_{k + 1} , 1 \leq k \leq K - 1\end{matrix}$$

Here, the confidence intervals are Tk=[ak, bk], 1≤k≤K.

The object tracking system 1000 may remove the bias from the sensor based trajectories in this way to acquire an object based trajectory x_{G*i}(t) corrected as follows.

$${x}_{i}^{G *} ( t ) := {x}_{i}^{G} ( t ) - {δ}_{i} ( t )$$

The corrected object based trajectory may be acquired for each object pᵢ.

Hitherto, the object tracking procedure according to the embodiment of the present disclosure has been comprehensively described. However, the technical idea of the present disclosure is not to be construed as including all the procedures described above, and it should be noted that the methods according to the embodiments of the present disclosure may be implemented as at least a part of the procedures described above.

Hereinafter, the embodiments of the object tracking method according to the present disclosure will be described in more detail. However, the scope of the technical idea of the present disclosure is not limited by the following embodiments, and it should be noted that the following embodiments are merely intended to exemplify at least a part of the technical idea of the present disclosure.

### Selection of Image-Sensor Based Locational Information Depending on Presence or Absence of Confidence Interval

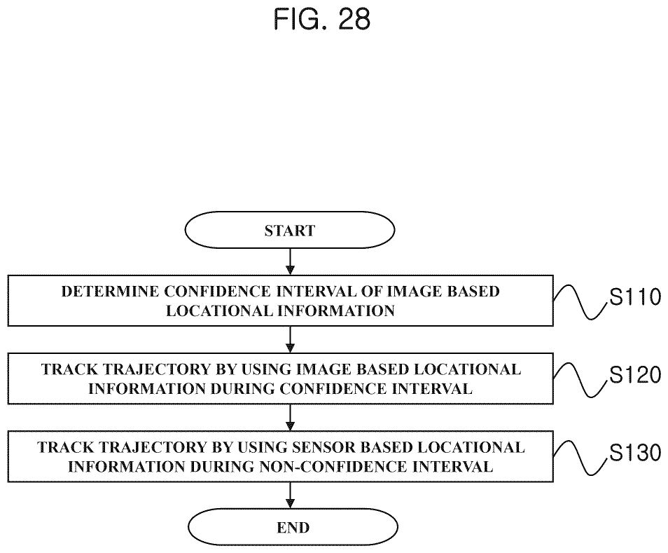

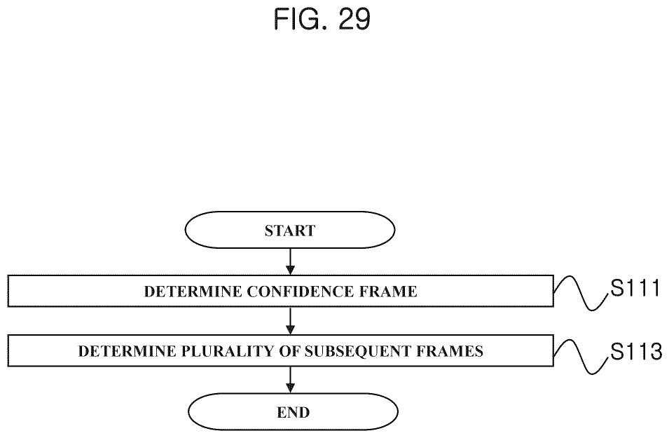

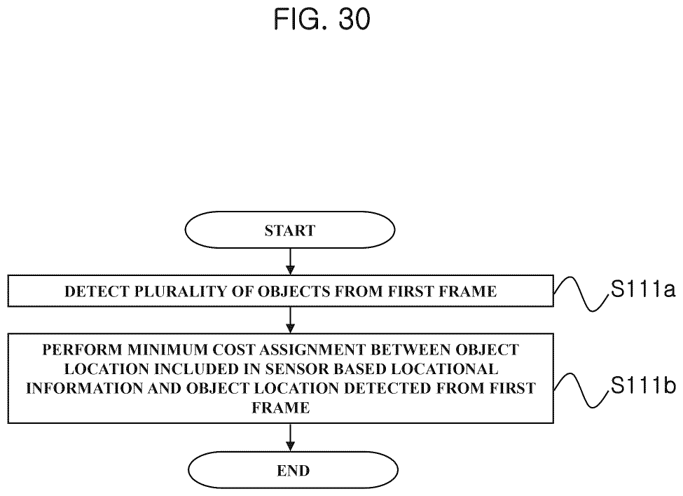

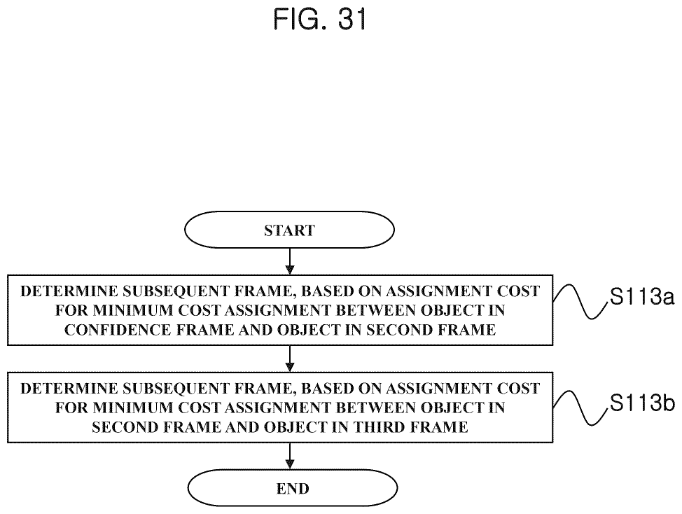

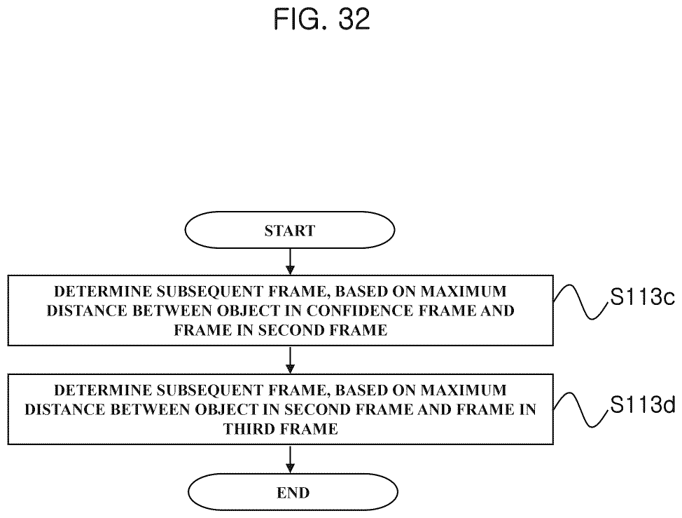

FIG. 28 is a schematic flowchart of the method for tracking the object trajectory by using the image based locational information or the sensor based locational information during the confidence interval according to an embodiment of the present disclosure. FIG. 29 is a detailed flowchart of the confidence interval determination step in FIG. 28, FIG. 30 is a detailed flowchart of the confidence frame determination step in FIG. 29, and FIG. 31 is a detailed flowchart according to one aspect of the subsequent frame determination step in FIG. 29. FIG. 32 is a detailed flowchart according to another aspect of the subsequent frame determination step in FIG. 29. Hereinafter, the method for tracking the trajectory of the object during the target time interval, based on the image based locational information and the sensor based locational information according to one embodiment of the present disclosure, will be described in more detail with reference to FIGS. 28 to 32.

The methods and/or the processes according to one embodiment of the present disclosure may be performed by a computing device. In one aspect, the computing device may be, but is not limited to, the server 1500 or the controller 1520 included in the server 1500 as described with reference to FIGS. 7 to 9. Any operable device including a processor and a memory may be used, and a combination of a plurality of physically separated devices may also be referred to as the computing device.

According to one embodiment of the present disclosure, it is possible to provide the object trajectory determination method in which the influence of false detection caused by a special situation such as occlusion is minimized while improved location accuracy is achieved by tracking the trajectory of the object during the target time interval, based on the image based locational information and the sensor based locational information.

In addition, according to the embodiment of the present disclosure, the confidence interval of the image based locational information may be determined by using the sensor based locational information. Therefore, the locational information during the time interval having no false detection in the image based locational information may be selectively utilized.

According to one embodiment of the present disclosure, the trajectory of the object may be tracked by using the image based locational information during the confidence interval of the image based locational information, and the trajectory of the object may be tracked by using the sensor based locational information during the non-confidence interval. Therefore, it is possible to provide improved object tracking performance in terms of both reliability and accuracy, compared to a case of tracking the object, based on any one locational information.

In the present disclosure, “the target time interval” may mean a time interval which is a target for tracking the trajectory of the object. For example, when a trajectory of a sports player in a team sport needs to be tracked, the target time interval may be an entire game time, or a partial time interval of the game time, such as the first half or the second half.

In addition, “the trajectory of the object” is time series data of information on the location of the object over a time interval having a predetermined length, and may represent a movement path of the object.

As described above, in the present disclosure, the image based locational information may include information on the location of at least one object determined from the captured image obtained by imaging one or more objects, and the sensor based locational information may include information on the location or the displacement of at least one determined object, based on signals from sensors corresponding to each of the one or more objects. Here, the sensor may include, but is not limited to, any one of a sensor for the Global Navigation Satellite System (GNSS), a sensor for the Local Positioning System (LPS), and a sensor for the Inertial Measurement Unit (IMU).

Referring to FIG. 28, the object tracking method according to one embodiment of the present disclosure may include at least one of a step (S110) of determining the confidence interval of the image based locational information, a step (S120) of tracking the trajectory of the object by using the image based locational information during the confidence interval, and a step (S130) of tracking the trajectory of the object by using the sensor based locational information during the non-confidence interval.

Hereinafter, each step of one embodiment of the object tracking method will be described.

As shown in FIG. 28, the computing device may determine the confidence interval of the image based locational information (S110).

As described above, the image based locational information may be acquired by object detection for each of the plurality of frames of the video captured by the camera and matching between the objects in each frame. For example, in the object detection procedure, a false negative error may occur, in which a detection target object is not detected, or a false positive error may occur, in which an incorrect object is detected. Therefore, according to one aspect, the computing device may selectively filter and use the image based locational information. More specifically, the computing device may determine the confidence interval of the image based locational information in which the detection area for the same object may be stably tracked in consecutive frames. Therefore, the confidence interval may be at least a partial time interval in the target time interval.

Exemplary procedures and/or criteria which may be used to determine the confidence interval will be described. FIG. 29 is a detailed flowchart of the confidence interval determination step in FIG. 28, and FIG. 30 is a detailed flowchart of the confidence frame determination step in FIG. 29.

As shown in FIG. 29, in order to determine the confidence interval, the computing device may first determine at least one confidence frame in the plurality of frames forming the video corresponding to the target time interval (S111), and may determine a plurality of subsequent frames subsequent to the confidence frame, based on a relationship with the confidence frame (S113). The confidence interval of the image based locational information may be a time interval corresponding to the confidence frame and the plurality of subsequent frames determined in this manner.

The confidence frame is at least one frame in the frames of video data associated with the image based locational information, and for example, may refer to a frame in which each detection area included in the corresponding frame properly indicates the location of the actual object and all objects existing in the interest area may be detected as the detection areas.

As shown in FIG. 30, in order to determine the confidence frame, the computing device may detect a plurality of objects from a first frame, which is one of a plurality of frames included in the image based locational information (S111a), and may perform the minimum cost assignment between the location of each of the plurality of objects included in the sensor based locational information corresponding to the first frame and the location of each of the plurality of objects detected from the first frame (S111b).

That is, the computing device may detect the plurality of objects in each frame, for each of the plurality of frames associated with the image based locational information, and may perform the minimum cost assignment for matching between the location of each of the plurality of objects included in the sensor based locational information corresponding to the frame and the objects detected in the frame. Here, for example, the minimum cost assignment may be performed by the Hungarian algorithm in which the sum of the Euclidean distances of each pair between the objects detected from the frame and the sensor based location is the assignment cost, but is not limited thereto. Any algorithm for performing proper matching between the objects detected from the frame and the sensor based locations may be adopted.

In the plurality of frames, in order to determine a frame in which the object detection is satisfactorily performed and the location of the detected object satisfactorily reflects the actual location as the confidence frame, the computing device may determine the first frame in the plurality of frames as the confidence frame when the first frame satisfies the following criteria.

According to one aspect, the computing device may determine the first frame as the confidence frame in response to a determination that the number of the objects detected from the first frame is equal to a predetermined number of reference objects. That is, the number of the objects expected to be detected may be determined in advance as the number of reference objects, and it may be determined whether the number of the objects detected in the frame is equal to the number of reference objects. Here, the number of reference objects may not necessarily mean the total number of tracking target objects. According to one aspect, the number of reference objects may be the sum of the number of sensors associated with the sensor based locational information and the number of predetermined dummy objects. That is, the sum of the number of tracking target objects and the number of dummy objects which are not the tracking target objects but are expected to be detected from the image may be the number of reference objects. For example, the dummy objects may include referees, coaching staff, or game officials such as ball boys in an application for the team sports game.

According to one aspect, the computing device may determine the first frame as the confidence frame in response to a determination that the minimum distance between the objects detected from the first frame is greater than a predetermined threshold distance. In order to satisfactorily detect the object from a specific frame, occlusion should not occur within the corresponding frame. In order not to determine the frame in which the occlusion occurs as the confidence frame, the frame may be determined as the confidence frame only when the minimum distance between the detected objects is greater than a predetermined threshold distance. Alternatively, more directly, according to one aspect, the computing device may determine the first frame as the confidence frame in response to a determination that the occlusion does not occur between the objects detected from the first frame. Meanwhile, even when the occlusion does not occur in the corresponding frame, in a case where the distance between the detected objects is too close, there is an increasing possibility that incorrect pairing is performed in matching with the object in the next frame or matching with the sensor based location. Therefore, a possibility of performing incorrect pairing may be reduced by increasing a threshold value for the minimum distance between the detected objects within the frame for determining the confidence frame.

When the object detected from the specific frame satisfactorily reflects the location of the actual object, the frame may be determined as the confidence frame. According to one aspect, the computing device may determine whether the object detected from the frame satisfactorily reflects the location of the actual object through a comparison with the sensor based locational information.

More specifically, for example, the computing device may determine the first frame as the confidence frame in response to a determination that the assignment cost for the location of each of the plurality of objects included in the sensor based locational information according to the minimum cost assignment and the location of each of the plurality of objects detected from the first frame is equal to or smaller than a first threshold value. That is, when the minimum cost assignment is performed on the plurality of objects detected in the specific frame and the sensor based locations corresponding to the frame, it may be considered how high the assignment cost of the minimum cost assignment is. This may reflect overall similarity between the location of the object detected from the frame and the sensor based location.

Alternatively, the computing device may determine the first frame as the confidence frame in response to a determination that the maximum distance between any one of the plurality of objects included in the sensor based locational information matched according to the minimum cost assignment and any one of the plurality of objects detected from the first frame is equal to or smaller than a second threshold value. That is, when at least one pair exceeding the second threshold value exists in pairs of the plurality of objects detected in the specific frame and the sensor based location corresponding to the frame, the frame may not be determined as the confidence frame.

Meanwhile, when the confidence frame is determined, a correlation with the adjacent frames may also be considered. That is, a frame that is excessively distinct from the adjacent frames may not be determined as the confidence frame.

According to one aspect, the computing device may determine the first frame as the confidence frame in response to a determination that the assignment cost for the minimum cost assignment according to the distance between the location of each of the plurality of objects detected from the first frame and the location of each of the plurality of objects detected from the frame adjacent to the first frame is equal to or smaller than a predetermined third threshold value. That is, when the minimum cost assignment is performed between the plurality of objects detected in the specific frame and the plurality of objects detected in the adjacent frames, it may be considered how high the assignment cost of the minimum cost assignment is. This may reflect the overall similarity between the locations of the objects detected in the adjacent frames.

Alternatively, the computing device may determine the first frame as the confidence frame in response to a determination that the maximum distance between any one of the plurality of objects detected from the first frame and any one of the plurality of objects detected from frames adjacent to the first frame is equal to or smaller than a fourth threshold value. That is, when at least one pair exceeding the fourth threshold value exists in the pairs between the plurality of objects detected in the specific frame and the plurality of objects detected from frames adjacent to the frame according to the minimum cost assignment, the frame may not be determined as the confidence frame.

Although various criteria for determining the confidence frame have been described above, the determination of the confidence frame according to one embodiment of the present disclosure is not limited to the above-described criteria, and it should be understood that the confidence frame may be determined when the described criteria are entirely or partially satisfied.

Referring again to FIG. 29, the computing device may determine the plurality of subsequent frames subsequent to the confidence frame, based on a relationship with the previously determined confidence frame (S113). As described above in the present disclosure, the embodiments of the present disclosure may utilize the image based trajectory which is the trajectory of the determined object from the image based locational information. In order to determine this image based trajectory, it is necessary to acquire the image based locational information over the plurality of frames, instead of a single frame. However, it is nearly impossible to acquire stable image based trajectories that persist for the entire target time interval, when it is considered that the detection areas of false positive errors and/or false negative errors are arranged. Therefore, the computing device may determine the confidence interval of the image based locational information, which is a well-conditioned time interval during which the algorithm may reliably acquire the image based trajectories.

The confidence interval may be determined by repeatedly determining whether the frames starting from the previously determined confidence frame and subsequent frames are the subsequent frames which may be included in the confidence interval. In determining whether the specific frame corresponds to the subsequent frame which may be included in the confidence interval, a correlation with the confidence frame or the previous subsequent frame may be considered. That is, a frame that is excessively distinct from the previous frame may not be determined as the subsequent frame.

FIG. 31 is a detailed flowchart according to one aspect of the subsequent frame determination step in FIG. 29.

As shown in FIG. 31, according to one aspect of the present disclosure, the computing device may determine the second frame as one of the subsequent frames in response to a determination that the assignment cost for the minimum cost assignment according to the distance between the location of each of the plurality of objects detected from the confidence frame and the location of each of the plurality of objects detected from the second frame subsequent to the confidence frame is equal to or smaller than a predetermined fifth threshold value (S113a), and may determine a third frame as one of the subsequent frames in response to a determination that the assignment cost for the minimum cost assignment according to the distance between the location of each of the plurality of objects detected from the second frame and the location of each of the plurality of objects detected from the third frame subsequent to the second frame is equal to or smaller than a predetermined fifth threshold value (S113b).

That is, the computing device may detect the plurality of objects for each frame subsequent to the confidence frame, and when performing the minimum cost assignment between the plurality of detected objects and the plurality of objects detected in the previous frame, as the frames progress, the computing device may repeatedly determine whether the assignment cost of the minimum cost assignment is equal to or smaller than the fifth threshold value. When the assignment cost between the previous frame and the current frame is equal to or smaller than the fifth threshold value, the current frame may be determined as the subsequent frame, and the confidence interval may be extended from the confidence frame to the current frame. This may reflect the overall similarity between the locations of the objects detected in the current frame and the objects detected in the previous frame.

FIG. 32 is a detailed flowchart according to another aspect of the subsequent frame determination step in FIG. 29. As shown in FIG. 32, according to one aspect of the present disclosure, the computing device may determine the second frame as one of the subsequent frames in response to a determination that the maximum distance between any one of the plurality of objects detected from the confidence frame and any one of the plurality of objects detected from the second frame subsequent to the confidence frame is equal to or smaller than a predetermined sixth threshold value (S113c), and may determine the third frame as one of the subsequent frames in response to a determination that the maximum distance between any one of the plurality of objects detected from the second frame and any one of the plurality of objects detected from the third frame subsequent to the second frame is equal to or smaller than the predetermined sixth threshold value (S113d).

That is, when detecting the plurality of objects for each frame subsequent to the confidence frame and performing the minimum cost assignment between the plurality of detected objects and the plurality of objects detected in the previous frame, as the frames progress, the computing device may repeatedly determine whether the maximum distance between the pairs according to the minimum cost assignment is equal to or smaller than the sixth threshold value. When the maximum distance between the pairs according to the assignment between the previous frame and the current frame is equal to or smaller than the sixth threshold value, the current frame may be determined as the subsequent frame, and the confidence interval may be extended from the confidence frame to the current frame.

Meanwhile, according to one aspect, the computing device may determine the second frame as one of the subsequent frames in response to a determination that the number of the objects detected from the confidence frame is equal to the number of objects detected from the second frame subsequent to the confidence frame.

Although various criteria for determining the subsequent frames belonging to the confidence interval have been described above, determining the subsequent frame according to one embodiment of the present disclosure is not limited to the above-described criteria, and it should be understood that the subsequent frame may be determined when the above-described criteria are entirely or partially satisfied.

Hitherto, the determination procedure of the confidence frame and the subsequent frames for determining the confidence interval has been described, and determining whether the frames subsequent to the confidence frame corresponds to each of the subsequent frames is repeated. When there is a frame that does not correspond to the subsequent frame determination condition, the confidence interval determination procedure may be completed, and the previous frame may be determined as the confidence interval. However, since excessively short trajectories may not be suitable for performing the method according to the embodiments of the present disclosure, the computing device may confirm the determination of the confidence interval in response to a determination that a time length corresponding to the confidence frame and the plurality of subsequent frames is equal to or longer than a predetermined threshold time length. For example, the computing device may determine that the confidence interval Tₖ is valid only when the confidence interval Tₖ lasts at least 1.0 second.

In this regard, FIG. 20 shows an example of the confidence frame and the confidence interval of the image based locational information. As shown in FIG. 20, a plurality of confidence frames (2010a, 2010b, 2010b, 2011a, 2011b, 2011c, 2011d, 2011e, 2011f, and 2011g) may be included within the target time interval. For each of the confidence frames, it may be determined whether consecutive frames correspond to the subsequent frames. For example, for the confidence frames (2010a, 2010d, and 2010c), a predetermined number or more of the subsequent frames may be determined as the subsequent frames to form a subsequent frame group (2020a, 2020b, and 2020c). Therefore, the confidence frame (2010a) and the subsequent frame group (2020a) may form a first confidence interval (2030a). In addition, the confidence frame (2010d) and the subsequent frame group (2020b) may form a second confidence interval (2030b), and the confidence frame (2010c) and the subsequent frame group (2020c) may form a third confidence interval (2030c). An interval other than the confidence interval in the target time interval may be referred to as the non-confidence interval, and for example, referring to FIG. 20, non-confidence groups (2040a, 2040b, 2040c, and 2040d) are shown.

Referring again to FIG. 28, the computing device may track the trajectory of the object by using the image based locational information during the confidence interval (S120), and may track the trajectory of the object by using the sensor based locational information during the non-confidence interval (S130).

That is, the location of the object is more accurately tracked in such a manner that the location of the object is tracked by using the image based locational information during the confidence interval where the object detection is satisfactorily performed and it is expected to satisfactorily reflect the location of the actual object, and the risk of incorrect location determination according to the image based locational information is supplemented in such a manner that the trajectory of the object is tracked by using the sensor based locational information during the non-confidence interval. In this manner, reliability of the object tracking may be improved.

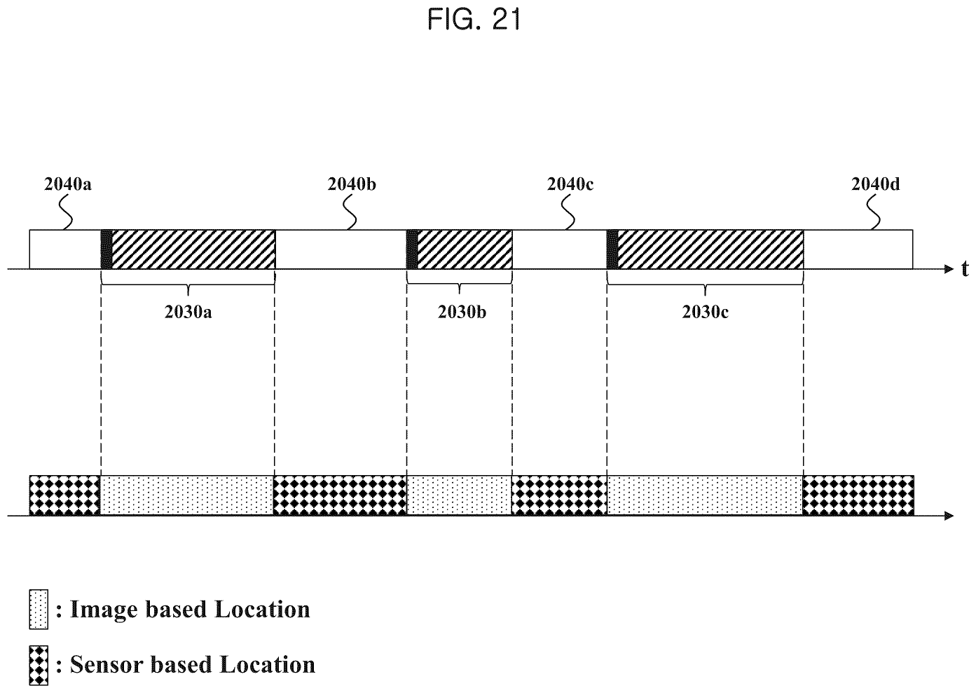

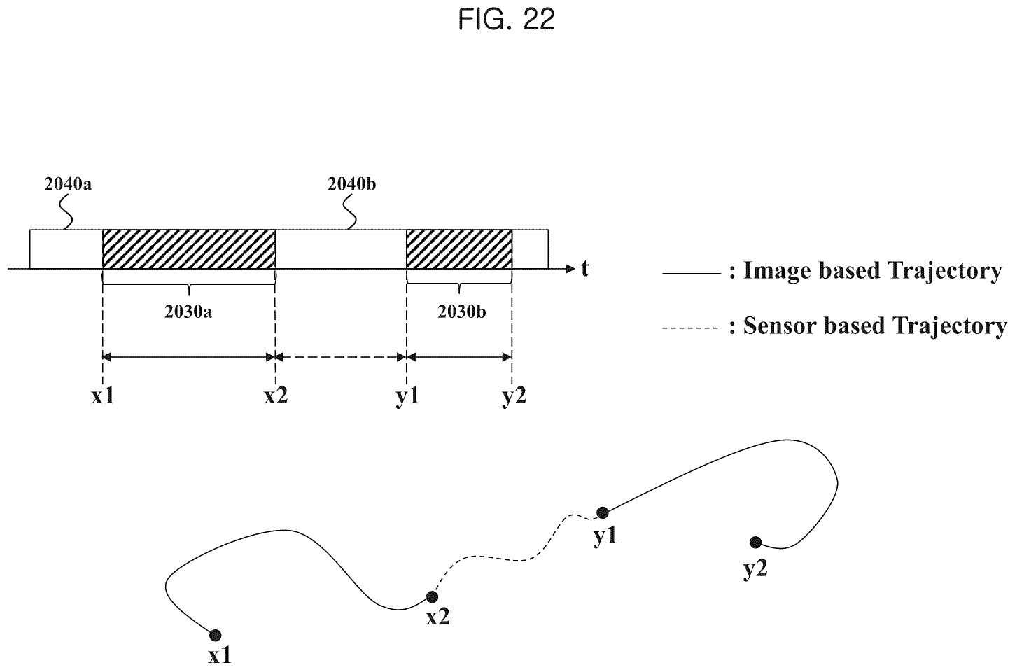

FIG. 21 is a conceptual diagram of a procedure for tracking the object by using the image based locational information or the sensor based locational information, based on whether the confidence interval is present, and FIG. 22 shows an example of the trajectory of the determined object according to the procedure in FIG. 21.

As shown in FIG. 21, the trajectory of the object may be tracked by using the image based locational information during the confidence interval (2030a, 2030b, and 2030c), and the trajectory of the object may be tracked by using the sensor based locational information during the non-confidence interval (2040a, 2040b, and 2040c).

In FIG. 22, the image based trajectory secured by using the image based locational information is shown by a solid line, and the sensor based trajectory secured by using the sensor based locational information is shown by a dotted line. From a start point x1 to a start point x2, and also from a start point y1 to a start point y2, the image based trajectory may be secured by connecting locations according to the image based locational information at the respective start points. During the non-confidence interval from the start point x2 to the start point y1, the sensor based trajectory may be secured by tracking the locations of the objects according to the sensor based locational information received from the sensor such as the GPS.

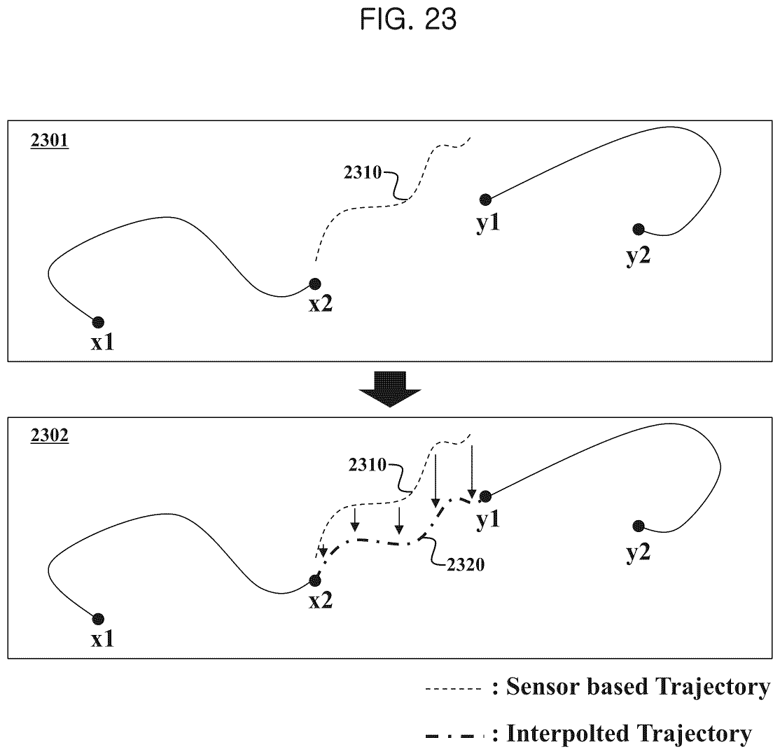

Meanwhile, FIG. 23 shows an example of an interpolation procedure using the sensor based locational information during the non-confidence interval between a plurality of confidence intervals. As shown in the trajectories 2301 before interpolation in FIG. 23, a certain error may exist in a sensor based trajectory 2310 secured based on the sensor based locational information. For example, this error may be caused by lower accuracy compared to the image based locational information, and for example, this error may be caused by a bias generally existing in the trajectory of the sensor such as the GPS.

However, the GPS may accurately track the movement or the displacement of the object, although the GPS has a location bias that varies with the lapse of time. In other words, although the GPS bias for each frame may significantly exist, the GPS bias slowly varies along the time axis. That is, in a case of the sensor based trajectories such as the GPS, the displacement shape of the trajectories may more satisfactorily reflect the actual displacement shape even when some errors exist in the location.

According to one aspect of the present disclosure, when tracking the trajectory of the object during the non-confidence interval located between the confidence intervals, the computing device may properly fit the sensor based trajectory according to the sensor based locational information during the non-confidence interval to the image based trajectories of both anterior and posterior confidence intervals. That is, the computing device may perform rotation, position movement and/or scale transformation on the sensor based trajectory during the non-confidence interval to connect the end point of the image based trajectory during the anterior confidence interval and the start point of the image based trajectory during the posterior confidence interval.

For example, as shown in FIG. 22, the confidence interval may include a first confidence interval 2030a and a second confidence interval 2030b after the first confidence interval. According to one aspect, when tracking the trajectory of the object during a non-confidence interval 2040b between the first confidence interval 2030a and the second confidence interval 2030b, the computing device may track the trajectory of the object during the non-confidence interval, based on the object location according to the image based locational information at the end point of the first confidence interval 2030a, the object location according to the image based locational information at the start point of the second confidence interval 2030b, and the trajectory of the object 2310 according to the sensor based locational information during the non-confidence interval 2040b between the first confidence interval and the second confidence interval.

More specifically, but not exclusively, the computing device may determine the trajectory of the object during the non-confidence interval 2040b through interpolation between the object location according to the image based locational information at the end point of the first confidence interval 2030a and the object location according to the image based locational information at the start point of the second confidence interval 2030b, by using the trajectory of the object 2310 according to the sensor based locational information during the non-confidence interval 2040b between the first confidence interval and the second confidence interval.

As shown in FIG. 23, for example, an interpolated trajectory 2320 may be obtained by properly transforming the sensor based trajectory 2310 such that both ends of the sensor based trajectory 2310 are respectively connected to the object location according to the image based locational information at the end point of the first confidence interval 2030a and the object location according to the image based locational information at the start point of the second confidence interval 2030b. This transformation may be performed by at least one of the position movement, the rotation, and the scale transformation of the trajectory.

In addition, according to one aspect, the computing device may determine an interpolated trajectory by using linear interpolation. As an exemplary procedure, the computing device may vertically and/or horizontally move the sensor based trajectory 2310 such that the start point of the sensor based trajectory 2310 is joined to the object location according to the image based locational information at the end point of the first confidence interval (2030a). Thereafter, in view of a first reference point which is a horizontal location of the object according to the image based locational information at the end point of the first confidence interval 2030a, a second reference point which is a horizontal location of the object according to the image based locational information at the start point of the second confidence interval 2030b, and a horizontal position of an interpolation point, the computing device may perform the linear interpolation to determine a vertical location of the interpolated trajectory, based on the horizontal location of the interpolation point and a distance between the first reference point and the second reference point.

As described above, in determining the trajectory of the object during the non-confidence interval between the confidence intervals, the end point of the image based trajectory during the previous confidence interval and the start point of the image based trajectory during the next confidence interval may be connected by using the sensor based trajectory during the non-confidence interval. In this manner, the object tracking using more accurate image based locational information is performed during the confidence interval, and information on the displacement of highly accurate sensor based locational information is utilized during the non-confidence interval. Therefore, the object tracking with improved accuracy may be ultimately achieved during the entire target time interval.

Meanwhile, in tracking the trajectories of the plurality of objects, when the image based locational information is used during the confidence interval and the sensor based locational information is used during the non-confidence interval, it has to be determined which trajectory in the plurality of image based trajectories corresponds to any trajectory in the plurality of sensor based trajectories. For this purpose, for example, identification information may be assigned to the image based trajectory by performing matching between the image-sensor based trajectories during the confidence interval, and it is possible to correspond the trajectory during the confidence interval and the trajectory during the non-confidence interval for a specific object by using object identification information basically included in sensor based trajectories such as the GPS and the identification information assigned to the image based trajectory. For this purpose, matching procedures exemplified in the present disclosure may be at least partially applied.

Meanwhile, even when the sensor based locational information is used during the non-confidence interval according to the embodiment of the present disclosure, as a matter of course, it is possible to use the sensor based locational information corrected according to the bias removal exemplified in the present disclosure.

### Matching Between Image-Sensor Based Trajectories

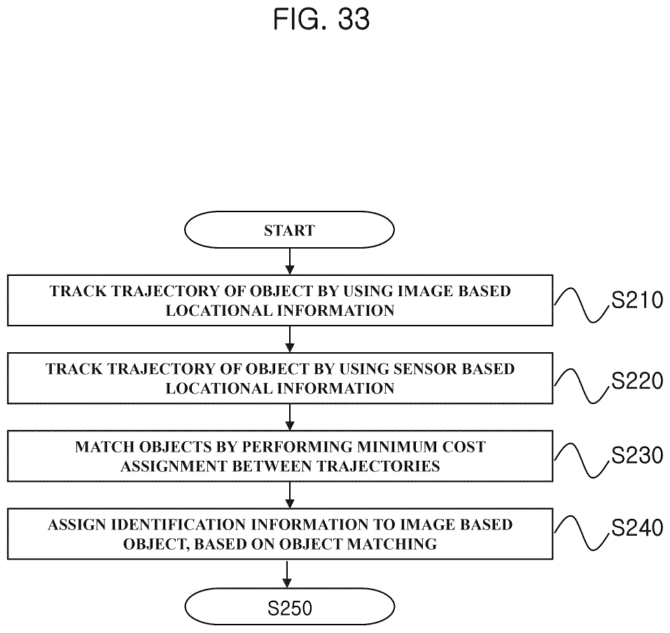

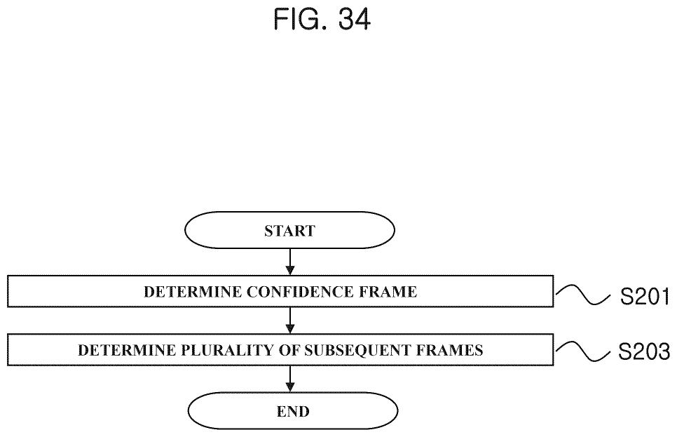

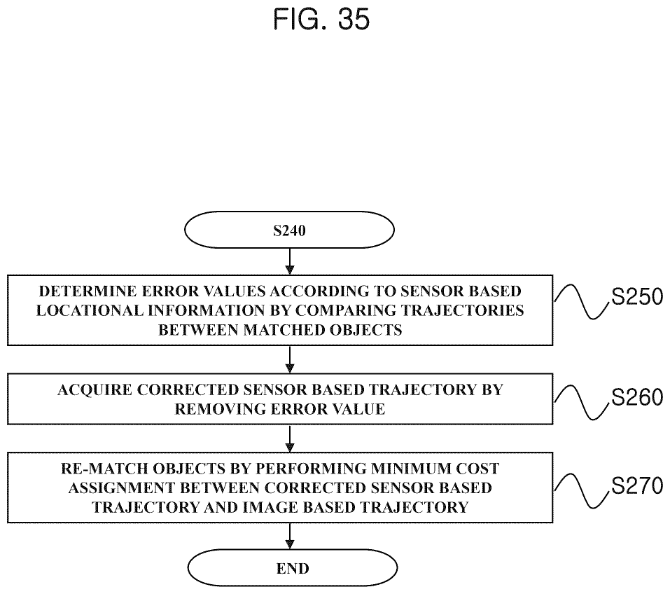

FIG. 33 is a schematic flowchart of the method for tracking the trajectory of the object, based on matching between the plurality of objects according to one embodiment of the present disclosure, FIG. 34 is a detailed flowchart of the confidence interval determination step for the method in FIG. 33, and FIG. 35 schematically shows a procedure for removing an error value and performing re-matching subsequently to the object matching in FIG. 33. Hereinafter, with reference to FIGS. 33 to 35, the method for tracking the trajectory of the object during the target time interval, based on the image based locational information and the sensor based locational information according to one embodiment of the present disclosure will be described in more detail.

The methods and/or the processes according to one embodiment of the present disclosure may be performed by the computing device. In one aspect, the computing device may be, but is not limited to, the server 1500 or the controller 1520 included in the server 1500 as described with reference to FIGS. 7 to 9. Any operable device having a processor and a memory may be used, and a combination of a plurality of physically separated devices may also be referred to as the computing device.

According to the embodiment of the present disclosure, the trajectory of the object through the sensor based locational information and the trajectory of the object through the image based locational information may be matched with each other. Therefore, the object detected by the image based locational information may be identified by using the identification information of the object corresponding to the sensor.

As described above, in the present disclosure, the image based locational information may include information on the location of at least one object determined from the captured image obtained by imaging one or more objects, and the sensor based locational information may include information on the location or the displacement of at least one determined object, based on signals from sensors corresponding to each of the one or more objects. Here, the sensor may include, but is not limited to, one of a sensor for the Global Navigation Satellite System (GNSS), a sensor for the Local Positioning System (LPS), and a sensor for the Inertial Measurement Unit (IMU).

Referring to FIG. 33, the object tracking method according to one embodiment of the present disclosure may include at least one of a step (S210) of tracking the trajectory of the object by using the image based locational information, a step (S220) of tracking the trajectory of the object by using the sensor based locational information, a step (S230) of matching the objects by performing the minimum cost assignment between the trajectories, and a step (S240) of assigning the identification information to the image based object, based on the object matching.

Hereinafter, each step of the embodiments of the object tracking method will be described.

The object tracking is generally performed by simultaneously tracking the plurality of objects rather than by tracking a single object. In a case of the sensor based locational information, it is possible to identify whether the locational information of the object acquired through the device ID assigned to the sensor device corresponds to any object without a separate procedure. However, in a case of the image based locational information, when the plurality of objects are detected from the image data, an additional procedure is needed to identify whether the object detected from the image data corresponds to any object. According to the embodiment of the present disclosure, the objects of the image based locational information are respectively matched with the objects of the sensor based locational information. In this manner, object identification information included in the sensor based locational information may be assigned to the object included in the image based locational information.

Meanwhile, the GPS for acquiring the sensor based locational information has a location bias that varies with the lapse of time, but may accurately track the movement or the displacement of the object. In other words, although the GPS bias for each frame may significantly exist, the GPS bias slowly varies along the time axis. Therefore, according to one aspect of the present disclosure, the computing device may minimize incorrect matching by performing matching between the image based trajectory and the sensor based trajectory, rather than simply executing the Hungarian algorithm independently for each frame.

As shown in FIG. 33, the computing device may track each trajectory of one or more objects during the reference time interval by using the image based locational information (S210), and may track each trajectory of one or more objects during the reference time interval by using the sensor based locational information (S220). Acquisition of the image based trajectory and the sensor based trajectory may follow any procedure in any trajectory acquisition procedures including the procedures described in the present disclosure.

Meanwhile, here, the reference time interval may be the confidence interval of the image based locational information, which is at least a partial time interval in the target time interval. The confidence interval may be determined, based on a step (S201) of determining at least one confidence frame in the plurality of frames forming the video corresponding to the target time interval as shown in FIG. 34, and a step (S203) of determining the plurality of subsequent frames subsequent to the confidence frame, based on a relationship with the confidence frame. The confidence interval may correspond to the confidence frame and the plurality of subsequent frames. Determination of the confidence interval according to the present embodiment may follow at least a partial procedure of the confidence interval determination procedures described in the present disclosure.

Referring again to FIG. 33, the computing device may match each object from the image based locational information with each object from the sensor based locational information by performing the minimum cost assignment between the plurality of trajectories according to the image based locational information and the plurality of trajectories according to the sensor based locational information (S230). Accordingly, the computing device may determine which object in the plurality of objects detected from the image based locational information corresponds to any one of the locational information of each object acquired from the sensor based locational information.

Here, for example, performing the minimum cost assignment may be performed based on the Hungarian algorithm, but is not limited thereto. Any one of the algorithms for any minimum cost assignment may be selected. However, in order to perform the minimum cost assignment, it is necessary to define the assignment cost that serves as the reference.

According to one aspect, the assignment cost for the minimum cost assignment may include a mean distance determined, based on the distance between the plurality of trajectories according to the image based locational information and the plurality of trajectories according to the sensor based locational information. That is, in the plurality of image based trajectories and the plurality of sensor based trajectories, the closest image based trajectory and the closest sensor based trajectory may be matched with each other.

Here, the mean distance may be determined, based on distance values between the location of the trajectory according to the image based locational information and the location of the trajectory according to the sensor based locational information at each start point included in the reference time interval. The distance values between the location of the trajectory according to the image based locational information and the location of the trajectory according to the sensor based locational information at each start point included in the reference time interval may be calculated, and the mean distance may be secured by averaging the distance values.

Meanwhile, according to one aspect, the assignment cost for the minimum cost assignment may include a shape distance determined, based on shape similarity between the plurality of trajectories according to the image based locational information and the plurality of trajectories according to the sensor based locational information. Accordingly, the image based trajectory and the sensor based trajectory which mutually have the most similar shapes in the plurality of image based trajectories and the plurality of sensor based trajectories may be matched with each other.

Here, the shape distance may be determined based on the difference values between the location distance and the mean distance at each start point included in the reference time interval. That is, the shape distance may be secured by calculating the difference values between the location distance and the mean distance at each start point included in the reference time interval for each start point, adding up the difference values, dividing the sum by the number of frames belonging to the reference time interval, and averaging the difference values.

Here, the location distance is a distance between the location of the object according to the image based locational information and the location of the object according to the sensor based locational information, and the mean distance represents a mean value of the location distances at each start point included in the reference time interval. A difference between the distance at each start point of the two corresponding trajectories and the mean distance at all start points ultimately reflects how much the trajectories deviate from the reference point in a state where the distances between the two objects are the same. In this way, when degrees of deviation from the reference point are calculated and added up for each start point included in the reference the start point, a result value between the trajectories having more similar shapes becomes smaller.

According to one aspect of the present disclosure, the computing device may use a “shape-weighted” assignment cost that matches the trajectories having similar shapes without being just located close to each other. For example, the assignment cost for the minimum cost assignment may be a shape-weighted assignment cost that assigns the weight to the shape distance while including a weighted sum of the mean distance and the shape distance between the plurality of trajectories according to the image based locational information and the plurality of trajectories according to the sensor based locational information. That is, both the mean distance and the shape distance are considered, and the weight is assigned to the shape distance. In this manner, the image based trajectory and the sensor based trajectory may be matched with each other by reflecting a shape similarity degree more than a distance similarity degree.

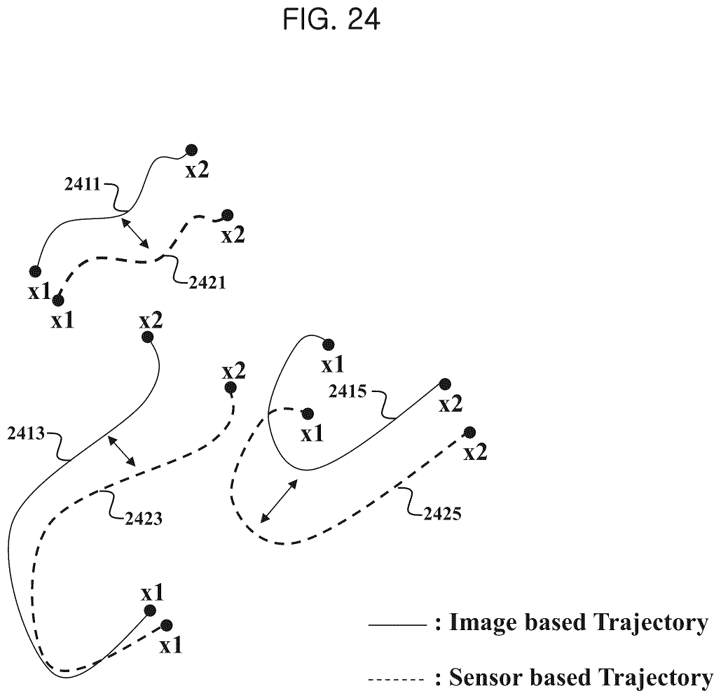

FIG. 24 shows an example of a matching procedure between the plurality of image based trajectories and the plurality of sensor based trajectories. Referring to FIG. 24, the image based trajectories are shown by solid lines, and the sensor based trajectories are shown by dotted lines. There are a plurality of image based trajectories 2411, 2413, and 2415 and a plurality sensor based trajectories 2421, 2423, and 2425. When the minimum cost assignment is performed based on the assignment cost for the shape and/or the distance, the image based trajectory 2411 and the sensor based trajectory 2421 may be matched with each other, the image based trajectory 2413 and the sensor based trajectory 2423 may be matched with each other, and the image based trajectory 2415 and the sensor based trajectory 2425 may be matched with each other.

Referring again to FIG. 33, the computing device may assign identification information to each of the one or more objects from the image based locational information, based on matching between the object from the image based locational information and the object from the sensor based locational information (S240).

For example, the sensor based locational information such as the GPS information includes identification information for each object, such as a device ID. Therefore, since the computing device identifies whether the object from the image based locational information corresponds to any object from the sensor based locational information, the computing device may assign the identification information for the corresponding object from the sensor based locational information to the identification information of the object detected from the image based locational information. Accordingly, the computing device has the identification information on whether the object detected from the image based locational information is any object.

The identification information on the object detected from the image based locational information may be utilized to provide additional information through the object tracking, and may be used to remove a bias from the sensor based locational information according to the embodiments of the present disclosure or to correspond to the trajectory according to the sensor based locational information during the non-confidence interval and the image based trajectory during the confidence interval.

Meanwhile, FIG. 35 schematically shows a procedure of removing error values and performing re-matching subsequently to the object matching in FIG. 33. According to one embodiment of the present disclosure, the error values existing in the sensor based trajectory may be removed by using the matching between the image based trajectory and the sensor based trajectory. In this case, the matching between the image based trajectory and the sensor based trajectory may be incorrectly performed due to the error existing in the sensor based trajectory. Therefore, re-matching between the image based trajectory and the sensor based trajectory may be performed based on the corrected sensor based trajectory from which the error value is removed. Therefore, potential incorrect matching may be corrected, and matching between the image based trajectory and the sensor based trajectory may be more accurately performed.

As shown in FIG. 35, the computing device may determine error values of the trajectories according to the sensor based locational information for each of the objects, based on a comparison result between the trajectories according to the image based locational information and the trajectories according to the sensor based locational information for each of the objects matched by the minimum cost assignment (S250). Here, the error value may be a mean value of distance values between the location of the object according to the image based locational information and the location of the object according to the sensor based locational information at each start point included in the reference time interval.

Referring again to FIG. 35, the computing device may acquire each corrected sensor based trajectory of the one or more objects by removing the error value for each trajectory from the trajectories of each of the one or more objects according to the sensor based locational information (S260).

When the corrected sensor based trajectory is acquired, the computing device may re-match each object from the image based locational information with each object from the sensor based locational information by performing the minimum cost assignment between the plurality of trajectories according to the image based locational information and the corrected sensor based trajectories (S270). Here, the re-matching may be performed in response to a determination that an evaluation value for the error value of each of the objects is equal to or greater than a predetermined threshold evaluation value.

Removing the error value existing in the sensor based trajectory will be described in more detail below.

### Bias Removal of Sensor Based Trajectory

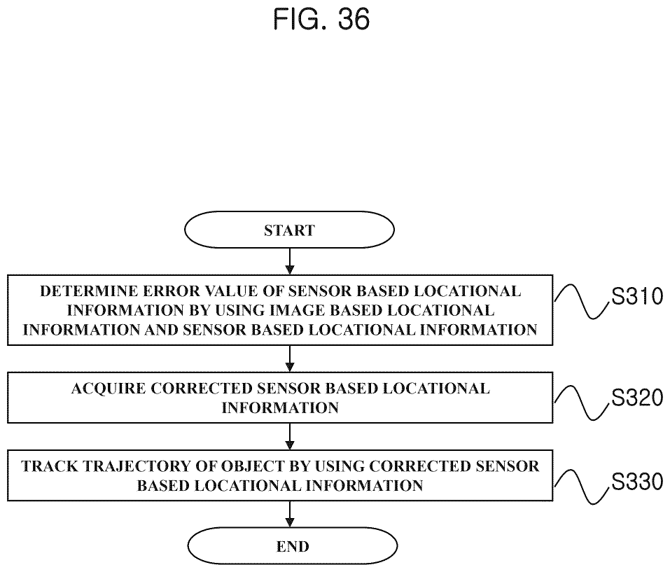

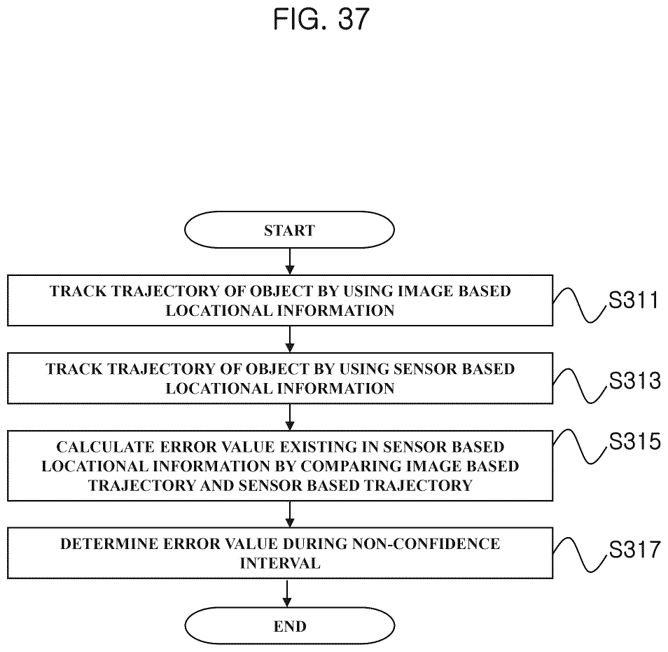

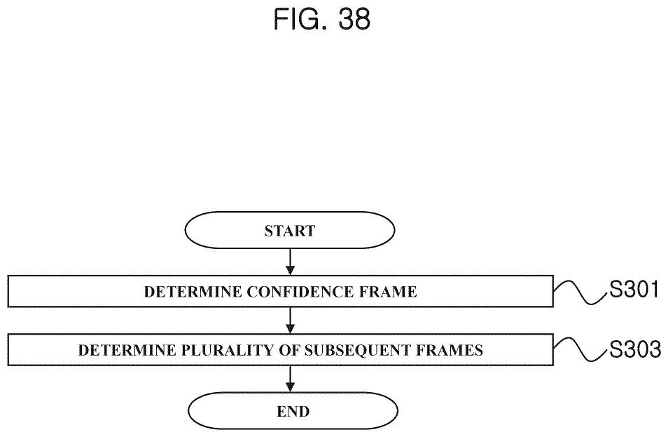

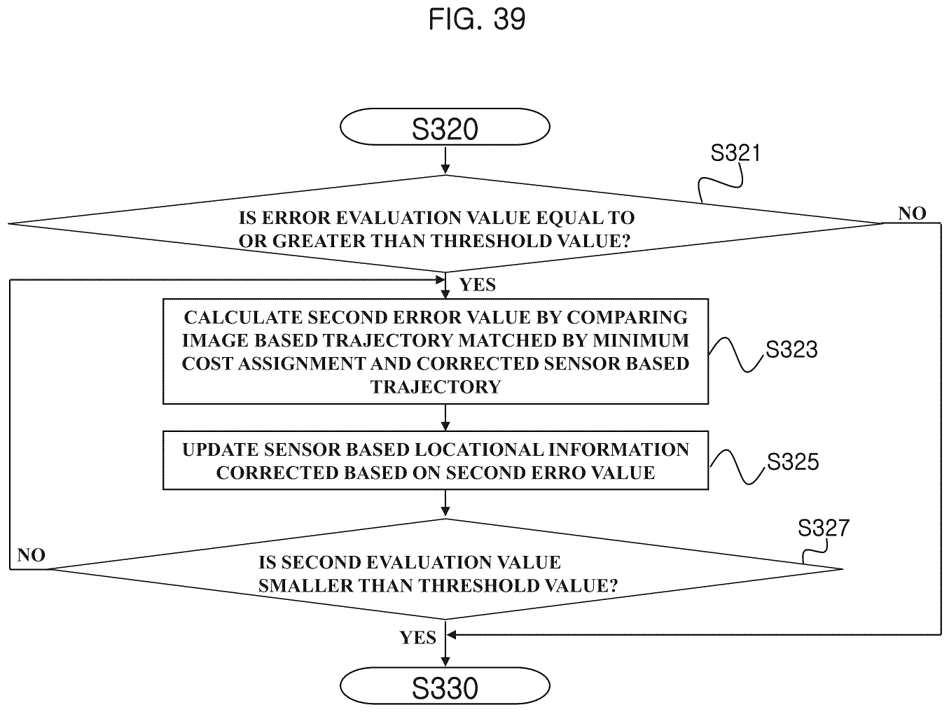

FIG. 36 is a schematic flowchart of a method for tracking the trajectory of the object by using error value removal of the sensor based locational information according to one embodiment of the present disclosure, FIG. 37 is a detailed flowchart of an error value determination step in FIG. 36, and FIG. 38 is a detailed flowchart of a confidence interval determination step for the method in FIG. 36. FIG. 39 shows an example of a procedure for performing re-matching and updating the sensor based locational information subsequently to the error value removal of the sensor based locational information in FIG. 36. Hereinafter, with reference to FIGS. 36 to 39, a method for tracking the trajectory of the object during the target time interval, based on the image based locational information and the sensor based locational information according to one embodiment of the present disclosure will be described in more detail.

The methods and/or the processes according to one embodiment of the present disclosure may be performed by the computing device. In one aspect, the computing device may be, but is not limited to, the server 1500 or the controller 1520 included in the server 1500 as described with reference to FIGS. 7 to 9. Any operable device having a processor and a memory may be used, and a combination of a plurality of physically separated devices may also be referred to as the computing device.

According to the embodiment of the present disclosure, the accuracy of the sensor based locational information may be improved by removing the bias occurring in the sensor based locational information through a comparison between the image based locational information and the sensor based locational information.

As described above, in the present disclosure, the image based locational information may include information on the location of at least one object determined from the captured image obtained by imaging one or more objects, and the sensor based locational information may include information on the location or the displacement of at least one determined object, based on signals from sensors corresponding to each of the one or more objects. Here, the sensor may include, but is not limited to, one of a sensor for the Global Navigation Satellite System (GNSS), a sensor for the Local Positioning System (LPS), and a sensor for the Inertial Measurement Unit (IMU).

Referring to FIG. 36, the object tracking method according to one embodiment of the present disclosure may include at least one of a step (S310) of determining the error value of the sensor based locational information, a step (S320) of acquiring the corrected sensor based locational information, and a step (S330) of tracking the trajectory of the object by using the corrected sensor based locational information.

Hereinafter, each step of the embodiments of the object tracking method will be described.

As shown in FIG. 36, the computing device may determine the error value existing in the sensor based locational information, based on the image based locational information and the sensor based locational information (S310).

FIG. 37 is a detailed flowchart of the error value determination step in FIG. 36. As shown in FIG. 37, the computing device may track the trajectory of the one or more objects during the reference time interval, based on the image based locational information (S311), and may track the trajectory of the one or more objects during the reference time interval, based on the sensor based locational information (S313). Subsequently, the computing device may calculate the error value existing in the sensor based locational information for the one or more objects during the reference time interval, based on a comparison result between the trajectory according to the image based locational information and the trajectory according to the sensor based locational information (S315).

Here, the error value during the reference time interval may be a mean value of the distance values between the location of the object according to the image based locational information and the location of the object according to the sensor based locational information at each start point included in the reference time interval.

In this regard, FIG. 25 shows an example of object matching between the image and the sensor and an error removal procedure of the sensor based locational information according to one embodiment of the present disclosure.

Referring to FIG. 25, first, a comparison between exemplary image based trajectories and sensor based trajectories during the reference time interval may be confirmed. In FIG. 25, a dotted curve (2530) represents the sensor based trajectory, and a bent curve (2510) represents the image based trajectory, respectively.

Here, an arrow indicating the sensor based trajectory represents an estimated error value, and a solid curve 2520 crossing the start point of the arrow may represent the corrected sensor based trajectory in which the error value is removed by removing the bias from the sensor based trajectory. As shown in FIG. 25, the corrected sensor based trajectory is located very close to the corresponding image based trajectory, but shows physically more natural movements.

According to one aspect, the computing device may estimate the sensor based locational information of the object or the bias for the sensor based trajectory by a mean distance between the image based trajectory and the sensor based trajectory. According to one aspect, the mean distance between the image based trajectory and the sensor based trajectory may be determined by determining the location of the object according to the image based locational information and the location of the object according to the sensor based locational information for each start point belonging to the reference time interval, calculating a distance difference between the locations, and operating an average of the distance difference values over the reference time interval.

Meanwhile, here, the reference time interval may be the confidence interval of the image based locational information, which is at least a partial time interval in the target time interval. The confidence interval may be determined, based on a step (S301) of determining at least one confidence frame in the plurality of frames forming the video corresponding to the target time interval as shown in FIG. 38, and a step (S303) of determining the plurality of the subsequent frames subsequent to the confidence frame, based on a relationship with the confidence frame. The confidence interval may correspond to the confidence frame and the plurality of subsequent frames. Determining the confidence interval according to the present embodiment may follow at least a partial procedure of the confidence interval determination procedures described in the present disclosure.

According to one aspect, trajectory tracking may be performed on the plurality of objects rather than a single object. In this case, the computing device may determine the error value for each sensor based trajectory belonging to each pair, based on a comparison result between the trajectory according to the image based locational information and the trajectory according to the sensor based locational information, which are matched with each other by performing the minimum cost assignment between the plurality of trajectories according to the image based locational information and the plurality of trajectories according to the sensor based locational information. Here, the minimum cost assignment may be performed based on the Hungarian algorithm.

In this regard, as described above, a dotted curve shown in FIG. 25 represents the sensor based trajectory, and a bent curve represents the image based trajectory, respectively. A circle located at an end of each curve is an end of a path, and the numbers inside the circle may be the object ID. That is, a dotted curve with the number i represents the sensor based trajectory for the i-th object, and a bent curve with the number i represents the image based trajectory for the i-th object, respectively. Referring to FIG. 25, each sensor based trajectory is satisfactorily matched with the nearby image based paths having similar shapes. Therefore, the corrected sensor based trajectory may be acquired by comparing the image-sensor based trajectories which are matched with each other, and calculating and removing the error value existing in each sensor based trajectory.

Referring again to FIG. 37, the computing device may determine the error value existing in the sensor based locational information for the one or more objects during the non-confidence interval, which is an interval other than the confidence interval in the target time interval (S317).

As described above, for example, the computing device may determine the mean distance between the trajectories as the error value existing in the sensor based trajectory by comparing the sensor based trajectory with the image based trajectory for the confidence interval in the target time interval.

According to one aspect, for example, the computing device may calculate the error value or the bias of the sensor based locational information or the sensor based trajectory during the non-confidence interval by performing linear interpolation between the adjacent confidence intervals.

For example, the computing device may use the error value of the most anterior confidence interval in the target time interval as the error value during the non-confidence interval before the most anterior confidence interval. During the non-confidence interval anterior to the first confidence interval, there may be no separate reference target other than the error value of the first confidence interval. Therefore, the computing device may borrow the error value of the first confidence interval during the non-confidence interval anterior to the first confidence interval, and may consider the borrowed error value as the error value existing in the sensor based locational information during the non-confidence interval.

Meanwhile, the computing device may use the error value of the most posterior confidence interval in the target time interval as the error value during the non-confidence interval after the most posterior confidence interval. Similarly, during the non-confidence interval existing later than the final confidence interval, there may be no separate reference target other than the error value of the final confidence interval. Therefore, the computing device may borrow the error value of the final confidence interval during the non-confidence interval existing later than the final confidence interval, and may consider the borrowed error value as the error value existing in the sensor based locational information during the non-confidence interval.

Finally, the computing device may use a linear interpolation value between the error value of the first confidence interval and the error value of the second confidence interval, for the first confidence interval and the second confidence interval which are included in the target time interval, as the error value during the non-confidence interval between the first confidence interval and the second confidence interval. That is, in a case of the non-confidence interval located between the two confidence intervals, the error value of the non-confidence interval may be relatively accurately determined by performing interpolation so that the error value of the confidence interval is more reflected depending on whether the start point is closer to any confidence interval.

As described above, the computing device may determine the error value existing in the sensor based locational information or the sensor based trajectory over the confidence interval and the non-confidence interval.

Referring again to FIG. 36, the computing device may acquire the corrected sensor based locational information by removing the error value calculated by the above-described procedure from the sensor based locational information (S320), and may track the trajectory of the object during the target time interval, based on the corrected sensor based locational information (S330). Accordingly, the trajectory of the object may be tracked with improved accuracy.

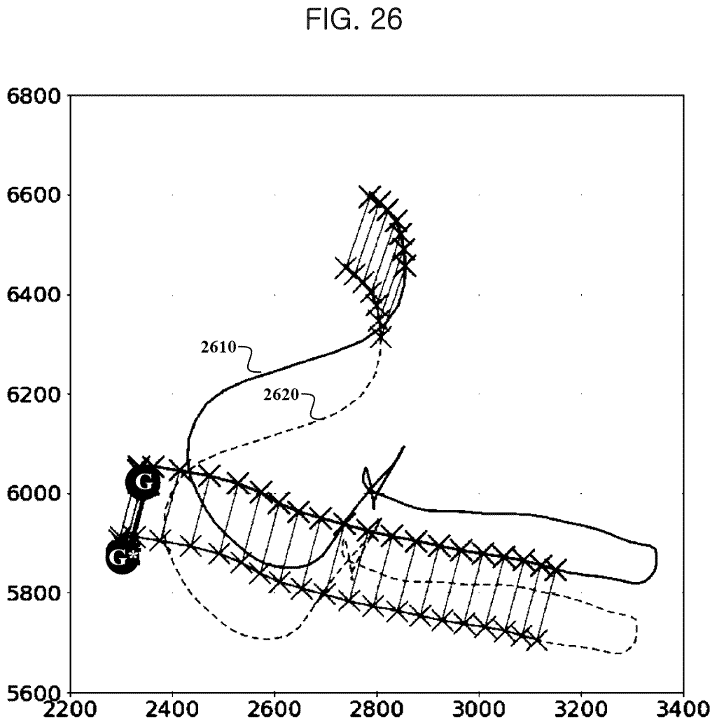

FIG. 26 shows a result of error removal according to the procedure in FIG. 25 in more detail. As shown in FIG. 26, a corrected sensor based trajectory 2620 may be secured by removing the error value or the bias existing in the sensor based trajectory 2610.

Meanwhile, FIG. 39 shows an example of a procedure for performing re-matching and updating the sensor based locational information subsequently to the error value removal of the sensor based locational information in FIG. 36.

As described above, when the error value or the bias exists in the sensor based locational information or the sensor based trajectory, a result of performing the minimum cost assignment between the plurality of image based trajectories and the plurality of sensor based trajectories may include incorrect matching. Therefore, when a corrected sensor based trajectory from which the error is removed by the above-described procedure is secured, re-matching between the corrected sensor based trajectories and the image based trajectories may be performed to secure new pairs. Based on the new pairs, the error value still existing in the corrected sensor based trajectory may be additionally calculated, and the corrected sensor based locational information or the corrected sensor based trajectory may be updated. The trajectory of the object may be tracked, based on the updated trajectory. These procedures may be repeatedly performed based on whether the evaluation value for the error value existing in the sensor based trajectory or the evaluation value for the second error value existing in the corrected sensor based trajectory exceeds a threshold value. Hereinafter, this configuration will be described in more detail with reference to FIG. 39.

As shown in FIG. 39, the computing device may determine whether the evaluation value for the error value of the sensor based locational information is equal to or greater than a predetermined threshold value (S321).

When the evaluation value for the error value is smaller than a predetermined threshold evaluation value, the trajectory of the object may be tracked by using the corrected sensor based locational information without performing any further re-assignment (S330).

In response to a determination that the evaluation value for the error value is equal to or greater than the predetermined threshold evaluation value, the computing device may calculate a second error value existing in the corrected sensor based locational information, based on a comparison result between the trajectory according to the image based locational information and the trajectory according to the corrected sensor based locational information, which are matched with each other by performing the minimum cost assignment between the plurality of trajectories according to the image based locational information and the plurality of trajectories according to the corrected sensor based locational information (S323).

That is, when the corrected sensor based locational information is secured by calculating and removing the error value existing in the sensor based locational information, whether an incorrect pair exists in the matching between the image based trajectory and the sensor based trajectory due to the previously existing error value may be determined, based on whether the evaluation value for the error value is equal to or greater than a threshold evaluation value. Here, for example, the evaluation value for the error value may be an average of the error values for each of the plurality of pairs, or may be, but is not limited to, the greatest error value in the error values for the plurality of pairs. When the evaluation value for the error value exceeds the threshold evaluation value, it may be considered that there is a high possibility of the error existing in the previous matching. The minimum cost assignment between the trajectories according to the corrected sensor based locational information and the trajectories according to the image based locational information may be performed again to secure new pairs. For the new pairs, the second error value existing in each of the corrected sensor based trajectories may be determined by comparing the image based trajectory and the corrected sensor based trajectory.

Referring again to FIG. 39, the computing device may update the sensor based locational information corrected, based on the second error value acquired based on the re-matched pairs (S325). Thereafter, it may be determined whether the evaluation value for the second error value is smaller than a predetermined threshold evaluation value (S327). When the evaluation value for the second error value is smaller than the predetermined threshold evaluation value, the trajectory of the object may be tracked by using the updated corrected sensor based locational information without performing any further re-assignment (S330).

On the other hand, when the evaluation value for the second error value exceeds the predetermined threshold evaluation value, the re-matching procedure may be repeated again until the evaluation value for the error value becomes smaller than the threshold evaluation value.

Therefore, according to one embodiment of the present disclosure, accurate sensor based locational information or trajectory may be secured by removing the error value or the bias existing in the sensor based locational information, and incorrect matching which may exist between the image based trajectory and the sensor based trajectory may be adjusted.

### Object Tracking Using Object Group Determination

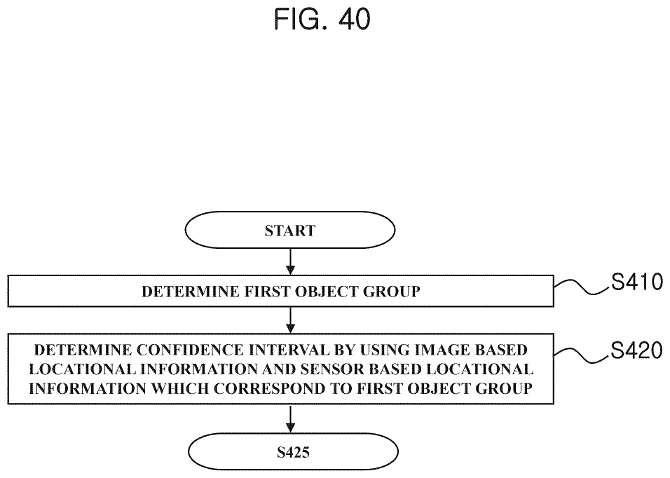

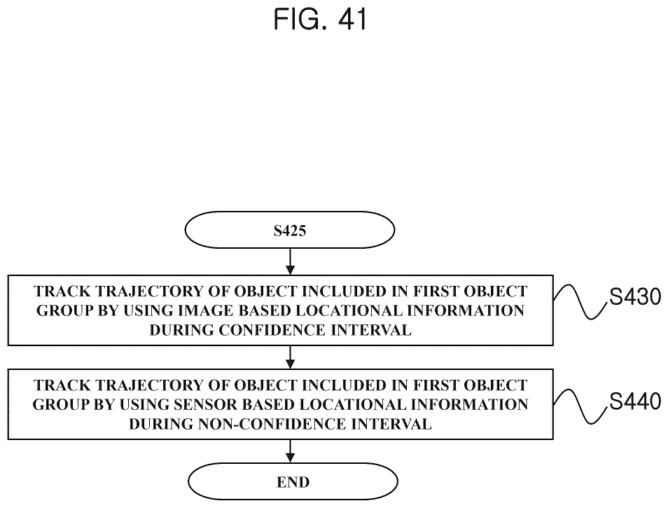

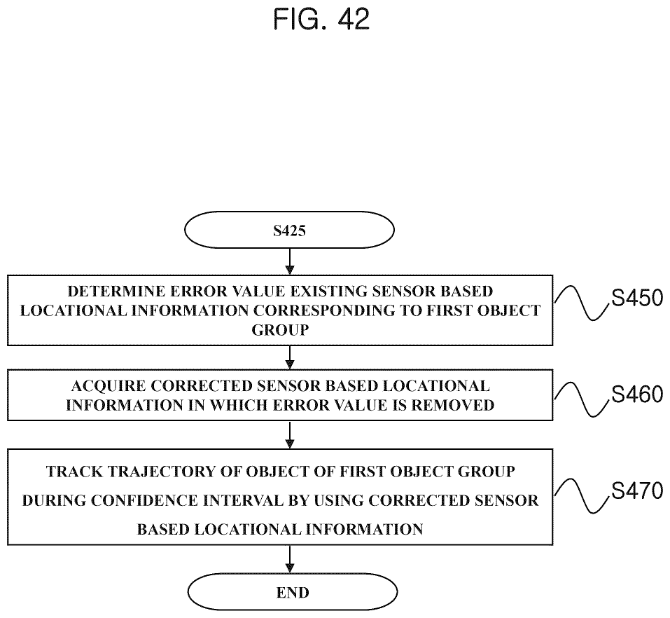

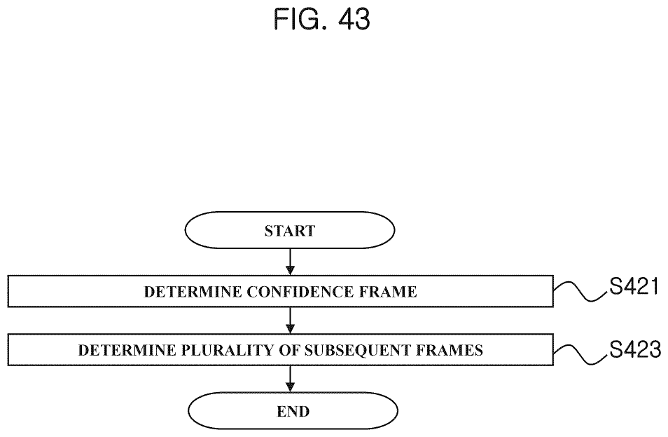

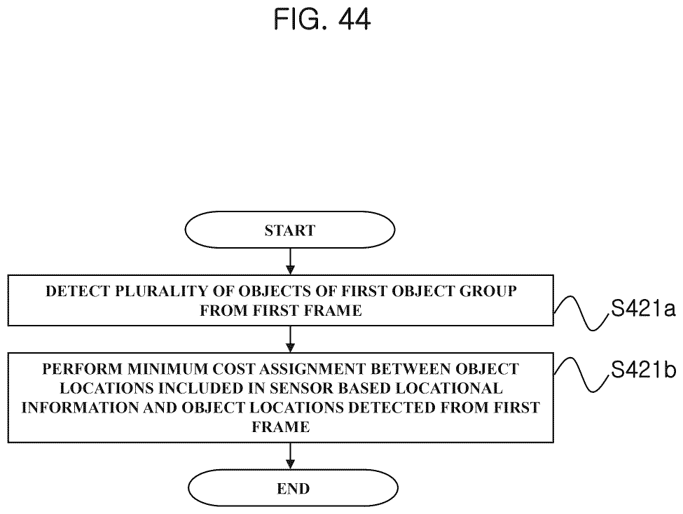

FIG. 40 is a schematic flowchart of a method for tracking the object trajectory by using object group determination according to one embodiment of the present disclosure. FIG. 41 shows a procedure for determining the object trajectory, based on the confidence interval subsequently to the object group determination in FIG. 40. FIG. 42 shows a procedure for determining the object trajectory by using error value removal of the sensor based locational information subsequently to the object group determination in FIG. 40. FIG. 43 is a detailed flowchart of the confidence interval determination step for the method in FIG. 40, and FIG. 44 is a detailed flowchart of the confidence frame determination step in FIG. 43. Hereinafter, with reference to FIGS. 40 to 44, a method for tracking the trajectory of the object during the target time interval, based on the image based locational information and the sensor based locational information according to one embodiment of the present disclosure will be described in more detail.

The methods and/or the processes according to one embodiment of the present disclosure may be performed by the computing device. In one aspect, the computing device may be, but is not limited to, the server 1500 or the controller 1520 included in the server 1500 as described with reference to FIGS. 7 to 9. Any operable device having a processor and a memory may be used, and a combination of a plurality of physically separated devices may also be referred to as the computing device.

According to the embodiment of the present disclosure, matching errors between the image based locational information and the sensor based locational information may be minimized by matching only a group including specific objects in the objects detected in the image based locational information with the sensor based locational information.

As described above, in the present disclosure, the image based locational information may include information on the location of at least one object determined from the captured image obtained by imaging one or more objects, and the sensor based locational information may include information on the location or the displacement of at least one determined object, based on signals from sensors corresponding to each of the one or more objects. Here, the sensor may include, but is not limited to, one of a sensor for the Global Navigation Satellite System (GNSS), a sensor for the Local Positioning System (LPS), and a sensor for the Inertial Measurement Unit (IMU).

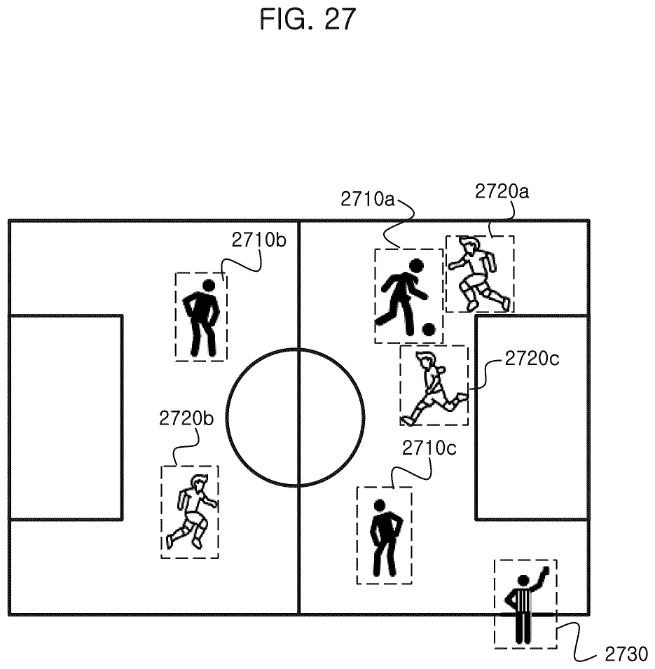

FIG. 27 shows an example of a grouping procedure for the detected objects. As shown in FIG. 27, it is common to need trajectory tracking for the plurality of objects rather than a single object. For example, in a case of trajectory tracking for each sports player in the team sport, each sports player is very dynamic and multiple players are deployed in a small space, and there is a high possibility that multiple players are crowded around the ball. Therefore, there is a high possibility of false detection in the detection step when the image based locational information is acquired, and there is also a high possibility of incorrect matching when matching between the frames for player tracking is performed.

In this regard, referring to FIG. 27, a plurality of tracking target objects may be broadly divided into, for example, three groups. For example, a first group may be a home team player group including players 2710a, 2710b, and 2710c, a second group may be an away team player group including players 2720a, 2720b, and 2720c, and a third group may be a match operation group including a referee 2730.

According to one embodiment of the present disclosure, the computing device may be configured to divide the plurality of objects detected from video data into at least two groups, and to track the trajectory of the object for each group. In this way, the number of the objects detected from the video data may be significantly reduced by performing the trajectory tracking for each group in this manner. Accordingly, a possibility of occlusion between the objects may be reduced, and a possibility of errors which may occur in the object detection step may be reduced. In addition, since the distance between the detected objects increases, a probability of including an incorrect pair may be reduced when object matching between the frames is performed to track the trajectory.

Furthermore, the methods according to the embodiments of the present disclosure estimate the trajectory of the object by using the image based locational information and the sensor based locational information together, but it is not possible to secure the sensor based locational information for all objects detected from the video data. For example, in a team sports game, the home team may acquire the image based locational information from a game video and to secure the sensor based locational information by using a sensor device such as a GPS device owned by the home team. However, the away team may acquire the image based locational information from the game video, but may not be able to secure the sensor based locational information for the home team players. Conversely, the home team may also not be able to secure the sensor based locational information for the away team players.

Accordingly, according to one embodiment of the present disclosure, the computing device may separately group the objects from which the sensor based locational information may be secured and the objects from which the sensor based locational information may not be secured in the plurality of objects detected from the video data, and may perform the object trajectory tracking using the image based locational information and the sensor based locational information for the group from which the sensor based locational information may be secured.

Referring to FIG. 40, the object tracking method according to one embodiment of the present disclosure may include at least one of a step (S410) of determining a first object group and a step (S420) of determining the confidence interval by using the image based locational information and the sensor based locational information which correspond to the first object group.

Hereinafter, each step of the embodiments of the object tracking method will be described.

As shown in FIG. 40, the computing device may determine the first object group including at least some of the plurality of objects existing in the captured image (S410). For example, as shown in FIG. 27, in the plurality of objects, a home team player group including players 2710a, 2710b, and 2710c may be determined as the first object group. The first object group may include the players 2710a, 2710b, and 2710c.

A procedure for determining which object of the plurality of objects detected in the video belongs to the first object group is required. Hereinafter, exemplary criteria for determining the object belonging to the first object group will be described.

According to one aspect, the computing device may determine whether the object inside the object detection area is included in the first object group, based on a characteristic value determined by using internal pixel values of each of the plurality of object detection areas extracted from the captured image. For example, in a case of the team sports game, since the home team and the away team wear mutually different uniforms and play the game, a characteristic value determined, based on the pixel values within the detection area for the home team player and a characteristic value determined, based on the pixel values within the detection area for the away team player may be different from each other. Therefore, the characteristic value for the pixel values within the detection area for the specific object may be determined, based on this difference, and whether the object corresponding to the detection area belongs to the first object group may be determined.

Here, the characteristic value for the pixel value inside the detection area may be a dominant value in the pixel values of the plurality of pixels inside the detection area, or may be a mean value of the pixel values inside the detection area. Alternatively, when it is considered that the uniforms of the players are mainly divided into tops and bottoms, and the colors of the bottoms may be distinguished by the colors of the tops even when the colors of the bottoms for the home team and away team are the same s each other, the detection area may be divided into two upper and lower areas, and the dominant value or the average value of the upper area may be used as the characteristic value.

According to one aspect, the computing device may determine whether the object inside the object detection area is included in the first object group, based on the dominant value in internal pixel values of each of the plurality of object detection areas extracted from the captured image. Here, when it is considered that the background in the playground mainly has a grass color, the dominant value may be determined to be the same as a green series for all detection areas. According to one aspect, the computing device may calculate the dominant value from the pixels included in the object detection area excluding the pixels corresponding to the background other than the objects, and may use the dominant value as the characteristic value.

Meanwhile, the computing device may cause the objects equipped with sensors for acquiring the sensor based locational information to be included in the first object group. For example, the characteristic values of the detection areas for the objects equipped with the sensor devices may be input in advance. In a case of team sports, for example, information on the uniforms worn by home team players equipped with sensor devices capable of acquiring the sensor based locational information may be secured in advance, and a first characteristic value of the detection area for the sports players wearing these uniforms may be calculated in advance. Accordingly, the computing device may determine whether the detected object is included in the first object group, based on whether the characteristic value of each internal pixel of the detection areas extracted from the captured image corresponds to the first characteristic value described above.

As exemplarily described, the object tracking method according to the embodiment of the present disclosure may be a method for tracking a plurality of players in the team sport game, and a plurality of objects existing in the captured image may be divided into a first object group corresponding to first team players in the team sport game, a second object group corresponding to second team players in the team sport game, and a third object group corresponding to non-participants in the team sport game. A tracking procedure for the object trajectory may be performed on each group for at least one of the first object group to the third object group.

Referring again to FIG. 40, the computing device may determine the confidence interval of the image based locational information, based on the image based locational information and the sensor based locational information which correspond to the first object group (S420). Here, the confidence interval may be at least a partial time interval in the target time interval.

According to one aspect, the confidence interval may be determined, based on a step (S421) of determining at least one confidence frame in the plurality of frames forming the video corresponding to the target time interval as shown in FIG. 43, and a step (S423) of determining the plurality of the subsequent frames subsequent to the confidence frame, based on a relationship with the confidence frame. The confidence interval may correspond to the confidence frame and the plurality of subsequent frames. Determining the confidence interval according to the present embodiment may follow at least a partial procedure of the confidence interval determination procedures described in the present disclosure.

More specifically, FIG. 43 is a detailed flowchart of the confidence interval determination step for the method in FIG. 40. The computing device may determine at least one confidence frame in the plurality of frames forming the video corresponding to the target time interval (S421), and may determine the plurality of subsequent frames subsequent to the confidence frame, based on a relationship with the confidence frame (S423). The confidence interval corresponds to the confidence frame and the plurality of subsequent frames.

FIG. 44 is a detailed flowchart of the confidence frame determination step in FIG. 43. In order to determine the confidence frame, the computing device may detect the plurality of objects included in the first object group from a first frame, which is one of the plurality of frames (S421a), and may perform the minimum cost assignment between the location of each of the plurality of objects included in the sensor based locational information corresponding to the first frame and the location of each of the plurality of objects included in the first object group detected from the first frame (S421b).

Here, the computing device may determine the first frame as the confidence frame in response to a determination that the number of the objects included in the first object group detected from the first frame is equal to a predetermined number of reference objects, and may determine the first frame as the confidence frame in response to a determination that the minimum distance between the objects included in the first object group detected from the first frame is greater than a predetermined threshold distance. Alternatively, the computing device may determine the first frame as the confidence frame in response to a determination that no occlusion occurs between the objects included in the first object group detected from the first frame.

According to one aspect, the computing device may determine the first frame as the confidence frame in response to at least one of i) a determination that the assignment cost for the location of each of the plurality of objects included in the sensor based locational information according to the minimum cost assignment and the location of each of the objects included in the plurality of first object groups detected from the first frame is equal to or smaller than a first threshold value, ii) a determination that the maximum distance between any one of the plurality of objects included in the sensor based locational information matched according to the minimum cost assignment and any one of the objects included in the plurality of first object groups detected from the first frame is equal to or smaller than a second threshold value, iii) a determination that the assignment cost for the minimum cost assignment according to the distance between the location of each of the objects included in the plurality of first object groups detected from the first frame and the location of each of the objects included in the plurality of first object groups detected from the frame adjacent to the first frame is equal to or smaller than a third threshold value, and iv) a determination that the maximum distance between any one of the objects included in the plurality of first object groups detected from the first frame and any one of the objects included in the plurality of first object groups detected from the frame adjacent to the first frame is equal to or smaller than a predetermined fourth threshold value.

Although described above, the determination of the confidence frame and the confidence interval according to the present embodiment is not limited thereto, and it should be understood that the confidence interval may be determined by at least a partial procedure of the confidence interval determination procedures according to the embodiments of the present disclosure.

When the confidence interval for the first object group is determined, the object tracking may be performed based on the sensor based locational information or the image based locational information according to the presence or absence of the confidence interval. FIG. 41 shows a procedure for determining the object trajectory, based on the presence or absence of the confidence interval subsequently to the object group determination in FIG. 40.

As shown in FIG. 41, the computing device may track the trajectory of the object included in the first object group during the confidence interval, based on the image based locational information corresponding to the first object group (S430), and may track the trajectory of the object included in the first object group during the non-confidence interval, which is an interval other than the confidence interval in the target time interval, based on the sensor based locational information (S440).

According to another embodiment, for the first object group, the object trajectory tracking with improved accuracy may be performed by removing the error value for the sensor based locational information, based on the image based locational information. FIG. 42 shows a procedure for determining the object trajectory by using the error value removal of the sensor based locational information subsequently to the object group determination in FIG. 40.

As shown in FIG. 42, the computing device may determine the error value existing in the sensor based locational information corresponding to the first object group during the confidence interval, based on the image based locational information and the sensor based locational information which correspond to the first object group (S450), may acquire the corrected sensor based locational information from in the error value is removed from the sensor based locational information corresponding to the first object group (S460). Thereafter, the computing device may track the trajectory of the object included in the first object group during the confidence interval, based on the corrected sensor based locational information (S470).

The method according to the present disclosure described above may be implemented as a computer-readable code on a computer-readable recording medium. The computer-readable recording medium includes all types of recording media which store data that may be deciphered by a computer system. For example, the computer-readable recording medium may include a Read Only Memory (ROM), a Random Access Memory (RAM), a magnetic tape, a magnetic disk, a flash memory, an optical data storage device, and the like. In addition, the computer-readable recording medium may be distributed to the computer system connected to a computer communication network, and may be stored and executed as a readable code in a distributed method.

Although the present disclosure has been described above with reference to the drawings and the embodiments, it does not mean that the scope of the present disclosure is limited by the drawings or the embodiments, and it may be understood that those skilled in the art may correct and modify the present disclosure in various ways within the scope not departing from the idea and the area of the present disclosure described in the appended claims.

Specifically, the characteristics described above may be implemented in digital electronic circuitry, in computer hardware or firmware, or combinations thereof. For example, in order to be implemented by a programmable processor, the characteristics may be implemented in a computer program product embodied inside a storage device inside a machine-readable storage device. The characteristics may be implemented by the programmable processor executing a program of instructions for performing functions of the above-described embodiments by operating on input data and generating an output. The above-described characteristics may be implemented in one or more computer programs executable on a programmable system including at least one programmable processor, at least one input device, and at least one output device which are coupled to receive data and instructions from a data storage system, and to transmit data and instructions to the data storage system. The computer program includes a set of instructions which may be directly or indirectly used within a computer to perform a specific operation on a predetermined result. The computer program may be written in any form of programming languages including compiled or interpreted languages, and may be used in any form included as a module, an element, a subroutine, or other unit suitable for use in another computer environment, or as an independently operable program.

For example, processors suitable for executing the program of instructions include both general-purpose and special-purpose microprocessors, and either a single processor or multiple processors of another type of computers. In addition, for example, storage devices suitable for implementing the computer program instructions and data for implementing the above-described characteristics include all forms of nonvolatile memory including semiconductor memory devices such as EPROM, EEPROM, and flash memory devices, magnetic devices such as internal hard disks and removable disks, magneto-optical disks, and CD-ROM and DVD-ROM disks. The processor and the memory may be integrated within application-specific integrated circuits (ASICs), or may be added by the ASICs.

Although the present disclosure described above has been described, based on a series of functional blocks, the present disclosure is not limited by the above-described embodiments and the accompanying drawings. It will be apparent to a person having ordinary skill in the art to which the present disclosure pertains that various substitutions, modifications, and changes are available within the scope not departing from the technical idea of the present disclosure.

The combination of the above-described embodiments is not limited to the above-described embodiments, and various combinations may be provided in addition to the above-described embodiments, depending on implementation and/or when necessary.

In the above-described embodiments, the methods have been described, based on a flowchart as a series of steps or blocks. However, the present disclosure is not limited to the order of the steps, and some steps may occur in a different order from other steps described above or simultaneously with other steps described above. Furthermore, those skilled in the art may understand that the steps shown in the flowchart are not exclusive, and other steps may be included, or one or more steps in the flowchart may be deleted without affecting the scope of the present disclosure.

The above-described embodiments include examples of various aspects. Although it is not possible to describe all possible combinations to represent various aspects, those skilled in the art may recognize that other combinations are available. Accordingly, the present disclosure is intended to include all other substitutions, modifications, and changes which fall within the scope of the appended claims.

What is claimed is:

1. An object tracking method for tracking a trajectory of an object during a target time interval, based on image based locational information and sensor based locational information, the method comprising:
determining a confidence interval of the image based locational information, the confidence interval being at least a partial time interval in the target time interval;
tracking the trajectory of the object during the confidence interval, based on the image based locational information; and
tracking the trajectory of the object during a non-confidence interval which is an interval other than the confidence interval in the target time interval, based on the sensor based locational information,
wherein the image based locational information includes information on a location of at least one object determined from a captured image obtained by imaging one or more objects, and the sensor based locational information includes information on a location or a displacement of at least one determined object, based on signals from sensors corresponding to each of the one or more objects.

2. The object tracking method of claim 1, wherein the determining the confidence interval includes determining at least one confidence frame in a plurality of frames forming an image corresponding to the target time interval, and determining a plurality of subsequent frames subsequent to the confidence frame, based on a relationship with the confidence frame, and the confidence interval corresponds to the confidence frame and the plurality of subsequent frames.

3. The object tracking method of claim 2, wherein the determining the confidence frame includes detecting a plurality of objects from a first frame which is one of the plurality of frames, and performing minimum cost assignment between the location of each of the plurality of objects included in the sensor based locational information corresponding to the first frame and the location of each of the plurality of objects detected from the first frame.

4. The object tracking method of claim 3, wherein in the determining the confidence frame, the first frame is determined as the confidence frame in response to a determination that the number of the objects detected from the first frame is equal to the number of predetermined reference objects.

5. The object tracking method of claim 4, wherein the number of the reference object is a sum of the number of sensors associated with the sensor based locational information and the number of predetermined dummy objects.

6. The object tracking method of claim 3, wherein in the determining the confidence frame, the first frame is determined as the confidence frame in response to a determination that a minimum distance between the objects detected from the first frame is greater than a predetermined threshold distance.

7. The object tracking method of claim 3, wherein in the determining the confidence frame, the first frame is determined as the confidence frame in response to a determination that no occlusion occurs between the objects detected from the first frame.

8. The object tracking method of claim 3, wherein in the determining the confidence frame, the first frame is determined as the confidence frame in response to a determination that an assignment cost for the location of each of the plurality of objects included in the sensor based locational information according to the minimum cost assignment and the location of each of the plurality of objects detected from the first frame is equal to or smaller than a predetermined first threshold value.

9. The object tracking method of claim 3, wherein in the determining the confidence frame, the first frame is determined as the confidence frame in response to a determination that a maximum distance between any one of the plurality of objects included in the sensor based locational information matched according to the minimum cost assignment and any one of the plurality of objects detected from the first frame is equal to or smaller than a predetermined second threshold value.

10. The object tracking method of claim 3, wherein in the determining the confidence frame, the first frame is determined as the confidence frame in response to a determination that the assignment cost for the minimum cost assignment according to a distance between the location of each of the plurality of objects detected from the first frame and the location of each of the plurality of objects detected from a frame adjacent to the first frame is equal to or smaller than a predetermined third threshold value.

11. The object tracking method of claim 3, wherein in the determining the confidence frame, the first frame is determined as the confidence frame in response to a determination that a maximum distance between any one of the plurality of objects detected from the first frame matched by the minimum cost assignment and any one of the plurality of objects detected from a frame adjacent to the first frame is equal to or smaller than a predetermined fourth threshold value.

12. The object tracking method of claim 2, wherein the determining the subsequent frames includes determining a second frame as one of the subsequent frames in response to a determination that the assignment cost for the minimum cost assignment according to a distance between the location of each of the plurality of objects detected from the confidence frame and the location of each of the plurality of objects detected from the second frame subsequent to the confidence frame is equal to or smaller than a predetermined fifth threshold value, and determining a third frame as one of the subsequent frames in response to a determination that the assignment cost for the minimum cost assignment according to a distance between the location of each of the plurality of objects detected from the second frame and the location of each of the plurality of objects detected from the third frame subsequent to the second frame is equal to or smaller than a predetermined fifth threshold value.

13. The object tracking method of claim 2, wherein the determining the subsequent frames includes determining a second frame as one of the subsequent frames in response to a determination that a maximum distance between any one of the plurality of objects detected from the confidence frame and any one of the plurality of objects detected from the second frame subsequent to the confidence frame is equal to or smaller than a predetermined sixth threshold, and determining a third frame as one of the subsequent frames in response to a determination that a maximum distance between any one of the plurality of objects detected from the second frame and any one of the plurality of objects detected from the third frame subsequent to the second frame is equal to or smaller than the predetermined sixth threshold value.

14. The object tracking method of claim 2, wherein in the determining the subsequent frames, a second frame is determined as one of the subsequent frames in response to a determination that the number of the objects detected from the confidence frame is equal to the number of the objects detected from the second frame subsequent to the confidence frame.

15. The object tracking method of claim 2, wherein in the determining the confidence interval, determining the confidence interval is confirmed in response to a determination that a time length corresponding to the confidence frame and the plurality of subsequent frames is equal to or greater than a predetermined threshold time length.

16. The object tracking method of claim 1, wherein the confidence interval includes a first confidence interval and a second confidence interval after the first confidence interval, and the tracking the trajectory of the object during the non-confidence interval is configured to track the trajectory of the object during the non-confidence interval, based on an object location according to the image based locational information at an end point of the first confidence interval, an object location according to the image based locational information at a start point of the second confidence interval, and the trajectory of the object according to the sensor based locational information during the non-confidence interval between the first confidence interval and the second confidence interval.

17. The object tracking method of claim 16, wherein the tracking the trajectory of the object during the non-confidence interval is performed through interpolation between the object location according to the image based locational information at the end point of the first confidence interval and the object location according to the image based locational information at the start point of the second confidence interval, by using the trajectory of the object according to the sensor based locational information during the non-confidence interval between the first confidence interval and the second confidence interval.

18. The object tracking method of claim 1, wherein the sensor includes any one of a sensor for a Global Navigation Satellite System (GNSS), a sensor for a Local Positioning System (LPS), and a sensor for an Inertial Measurement Unit (IMU).

19. An object tracking apparatus as an apparatus for tracking a trajectory of an object during a target time interval, based on image based locational information and sensor based locational information, the apparatus comprising:
a processor; and
a memory,
wherein the image based locational information includes information on a location of at least one object determined from a captured image obtained by imaging one or more objects, the sensor based locational information includes information on a location or a displacement of at least one determined object, based on signals from sensors corresponding to each of the one or more objects, and the processor is configured to determine a confidence interval of the image based locational information, the confidence interval being at least a partial time interval in the target time interval, to track the trajectory of the object during the confidence interval, based on the image based locational information, and to track the trajectory of the object during a non-confidence interval which is an interval other than the confidence interval in the target time interval, based on the sensor based locational information.

20. A non-transitory computer-readable storage medium storing instructions executable by a processor, wherein the instructions are provided to track a trajectory of an object during a target time interval, based on image based locational information and sensor based locational information, the image based locational information includes information on a location of at least one object determined from a captured image obtained by imaging one or more objects, the sensor based locational information includes information on a location or a displacement of at least one determined object, based on signals from sensors corresponding to each of the one or more objects, the instructions are executed by the processor to cause the processor to determine a confidence interval of the image based locational information, the confidence interval being at least a partial time interval in the target time interval, to track the trajectory of the object during the confidence interval, based on the image based locational information, and to track the trajectory of the object during a non-confidence interval which is an interval other than the confidence interval in the target time interval, based on the sensor based locational information.
